(19) United States
(12) Patent Application Publication
(10) Pub. No.: US 2015/0154317 A1
(43) Pub. Date: Jun. 4, 2015

(54) MEMORY PROVIDED WITH SET OPERATION FUNCTION, AND METHOD FOR PROCESSING SET OPERATION PROCESSING USING SAME

(71) Applicant: Katsumi INOUE, Kashiwa-shi, Chiba (JP)

(72) Inventor: Katsumi Inoue, Chiba (JP)

(21) Appl. No.: 14/388,765

(22) PCT Filed: Mar. 28, 2013
(86) PCT No.: PCT/JP2013/059260

§ 371 Date: Jan. 26, 2015

(30) Foreign Application Priority Data
Mar. 28, 2012 (JP) 2012-073451
Mar. 31, 2012 (JP) 2012-083361
Apr. 26, 2012 (JP) 2012-101352
May 13, 2012 (JP) 2012-110145
May 28, 2012 (JP) 2012-121395

(51) Int. Cl. G06F 17/30

(52) U.S. Cl. CPC G06F 17/30982; G06F 17/30271

(57) ABSTRACT

[Problem to be solved] To provide a memory having set operating functions

[Solution] A memory is capable of recording information at each memory address and reading the information. The memory has an input section for inputting, from outside, a first input 221 for comparing with information recorded on each memory address, a second input 222 for a comparison between each memory address, and a third input 223 as a condition for performing a set operation, the third input being selectably specified one or a combination of two or more of set operation conditions which are (1) subset, (2) logical OR, (3) logical AND, (4) logical negation; a section 208, 209 for comparing and determining information recorded on each memory address based on the first input; a section 210, 211 for comparing and determining between information recorded on the memory based on the second input; a section 224 for performing, based on the third input, a logical set operation on results determined based on the first input and the second input; and a section 207 for outputting a result of the logical set operation.

### FIELD OF THE INVENTION

This invention relates to memory having set operating functions and set operation methods that utilize the same.

### BACKGROUND OF THE INVENTION

Since the birth of the von Neumann architecture for the present day computer, information processing has been completely left to the CPU. While there are many commands that the CPU can run, their purposes can be separated into three main processes—arithmetic operations, control operations and set operations.

While each information-processing step in arithmetic and control operations is meaningful, set operation on data has an extremely wide range of uses and is a frequently occurring process. At the same time, it is oftentimes an exclusive process. And, because of the von Neumann bottleneck issue, it is currently an unreasonable and taxing means of information processing for the CPU.

### (The Meaning of Logically Operating a Set of Information)

According to Wikipedia, a set in mathematics is, roughly stating, a collection of objects. The distinct objects that make up the set are called “elements.” Applying this definition to sets of information, set operations on information are currently processed on each individual element. This, of course, includes basic logical elements like logical ORs and ANDs, but even set operations by the CPU, which currently plays a central role in information processing, are based on the “elements” of information sets.

Specifically stating, set operations by programs that use the CPU are processes that search for specific information from a set of information data recorded on the memory. Such operations adopt a method of individually accessing the information (elements) on the memory and comparing them and seeking the answer to the set operation.

While various software algorithms have been developed to minimize this problem, there has been no fundamental solution to the issue. Even parallel operations using a number of CPUs is, like the Japanese saying, “even a dog, if it walks about, will run into a pole (good luck comes unexpectedly)” for the CPU, which has to go through the unreasonable and rigorous process of running through a huge amount of data one by one to find just one specific data. With such a process, speeding up inevitably means heating up the CPU and expanding device size accordingly.

If a processor that can conduct arithmetic operations collectively (at once) on a set of information (the entire memory) can be developed, as with the concept of Euler and Venn diagrams, the idea of information processing will be completely transformed. This is because a device that can logically process a set of information collectively will have an incomparably high speed as opposed to information processing on each individual element.

While there are an infinite number of processes for finding specific information, some representative processes can be expressed by words like search, verify and recognize. And, these information processes are inevitably set operations that generally use program languages for databases.

Accordingly, if a processor that can collectively conduct arithmetic operations on a set of data can be realized, it will be a huge benefit for these information processes, which have been a weakness for the current computer.

### (“Recognition” in Information Processing)

The following will describe the most difficult process of “recognition,” or finding specific information from a set of information recorded on the memory.

Recognition in information processing is a technology for finding various characteristics in a certain set of information and applying concepts that we can understand, in other words nouns and/or adjectives, to such characteristics. A number of these characteristics generally have to be found individually, and information searches must be conducted over and over.

At the same time, because the positional relationship between these characteristics is oftentimes the key in such operations, there is a need to conduct positional operations, making this an extremely complex kind of information processing. For such recognition processes, pattern matching is a basic technology that constitutes the framework or central pillar of pattern recognition—one of the most important kinds of knowledge processing—and is indispensable to all fields of recognition including image, voice and text.

While the abovementioned pattern matching is a typical example of set operations, because there is currently no processor specifically for such set operations, it is an extremely inefficient kind of information processing for the CPU.

If pattern matching technology can be defined and realized for generic and common usage with all kinds of information and furthermore, if this idea of pattern matching can be expanded to realize a processor specifically for set operations, a remarkable leap may be possible for information processing.

### (“Pattern Matching” in Information Processing)

The following will describe the importance and general overview of patterns in information and pattern matching.

The information that we seek, or want to recognize, is generally not just one piece of data and is, instead, a group of data (pattern array). For instance, an image that we want to recognize is a set of pixel data; and voice, a set of sound spectrum data. Generally, almost all kinds of data that human beings wish to recognize, such as the rise and fall of stock prices, temperature changes, strings of text, DNA, and viruses, are arrays of pattern data.

For instance, a single independent piece of stock price data has no meaning, and it is through comparison with the previous day's stock prices and flows in stock prices from the week before (patterns) that the data has meaning and we can recognize the data as high or low and gain an understanding on whether the economy is good or bad.

Likewise, our sensations of hot or cold come from comparison with temperatures yesterday or a few days before and if the same kind of temperature continues throughout the year, there will be no recognition of hotter or colder days.

For letters and words as well, a group of letters form a word and a group of words express a meaning, making it possible to convey certain intents to other people. In other words, what we want to recognize is a group of information, or patterns themselves, and this involves conducting set operations on information. However, patterns and pattern matching is currently an extremely diversified and vague notion that has not been standardized or generalized.

There have been very few attempts at realizing set operations on information by means other than the CPU thus far. Patent Application No. 4-298741 was for an ambiguous set operation device, a memory device and calculation system; it was not for set operations on sets of information themselves.

### PRIOR ART DOCUMENTS

### Patent Documents

### [Patent Document 1] JP-B-4588114

### [Patent Document 2] JP-A-H4-298741

### SUMMARY OF THE INVENTION

As noted above, the objective of the present invention is to provide a processor wherein the chip itself can conduct information processing as expressed by words like search, verify and recognize, without relying on the CPU, thereby avoiding the largest barrier to information processing found in the conventional von Neumann information processing method.

In order to achieve the above objective, an aspect of the present invention provides a memory having a set operating function and capable of recoding information at each memory address and reading the information, the memory characterized by comprising: an input section for inputting, from outside, a first input for comparing with information recorded on each memory address, a second input for a comparison between each memory address, and a third input as a condition for performing a set operation, said third input being selectably specified one or a combination of two or more of set operation conditions which are (1) subset, (2) logical OR, (3) logical AND, and (4) logical negation; a section for comparing and determining information recorded on each memory address based on the first input; a section for comparing and determining between information recorded on the memory based on the second input; a section for performing, based on the third input, a logical set operation on results determined based on the first input and the second input; and a section for outputting a result of the logical set operation.

According to one embodiment of the present invention, the memory further comprises a section for repeatedly performing, with respect to the result of the set operation based on the first to third inputs, a set operation based on newly input first to third inputs.

Further, according to another embodiment, the memory further comprises a section for performing parallel processing for at least one of set operations on the information based on the first to third inputs.

According to a further embodiment, the first input includes: a value representing information to be compared; and a specification of one of complete match, partial match, range match and a combination thereof, as a comparison condition.

According to a further embodiment, determination based on the first input is performed by a content addressable memory.

According to a further embodiment, the second input includes a position of information to be compared, a certain area with reference to the position, or a combination thereof. In this case, it is preferable that the position of information to be compared include a relative position, an absolute position, or a combination thereof.

According to a further embodiment, the section for determining based on the second input is performed by a section for parallel operating of the memory address.

According to a further embodiment, the input section is for further inputting a fourth input (image size and the like) for designating an array or order of information, and determination of the information is performed based on the array or order specified by the fourth input.

According to a further embodiment, the first to third inputs specify a query information pattern for pattern matching with set information recorded on the memory. In this case, it is preferable that the query information pattern be query information for edge detection. Also, it is preferable that the pattern matching be performed on either one of: one-dimensional information, an example of which is text information; two-dimensional information, an example of which is image information; three-dimensional information, an example of which is video information; and N-dimensional information, in which information array is defined. Further, it is preferable that at least one of: visual recognition; auditory recognition; gustatory recognition; olfactory recognition; and tactile recognition be performed based the query information pattern for pattern matching.

According to a further embodiment, the memory is incorporated into another semiconductor, an example of which is a CPU.

According to a further embodiment, there is provided a device comprising the memory having the set operating function according to claim 1.

Using this configuration, a “memory (device) having set operating functions” able to conduct any kind of set operation can be realized, in which any set operation on information is possible, not on the information elements (information on individual memory cells) using the CPU, but by the memory itself conducting set operations on set information recorded on itself (the whole memory) collectively. It can therefore be commonly used for all search, verify and recognition functions for finding information.

Based on this configuration, the notions of pattern matching and edge detection—which are the most basic and important information recognition functions and the weakness of the current computer—can be standardized and generalized.

At the same time, because most of the information processing functions that have been the most difficult for the CPU can be resolved using this technology, the problems of overheated CPUs and the enlarged sizes of devices can be resolved to a great extent.

### BRIEF DESCRIPTION OF THE DRAWINGS

FIG. 1 depicts a Euler diagram showing the idea of set operations

FIG. 2 depicts a Euler diagram that includes the ideas of positions and areas.

FIG. 3 depicts an example of a block diagram for Content Addressable Memory (CAM)

FIG. 4 depicts an example of a data comparison circuit in Content Addressable Memory (CAM)

FIG. 5 depicts an example of a block diagram for memory having information refinement detection functions.

FIG. 6 depicts an example of a full text search using memory having information refinement detection functions.

FIG. 7 depicts a second example of a block diagram for memory having information refinement detection functions.

FIG. 8 depicts an example of image detection using memory having information refinement detection functions.

FIG. 9 depicts a second example of image detection using memory having information refinement detection functions.

FIG. 10 depicts a third example of image detection using memory having information refinement detection functions.

FIG. 11 depicts a fourth example of image detection using memory having information refinement detection functions.

FIG. 12 depicts a fifth example of image detection using memory having information refinement detection functions.

FIG. 13 depicts a sixth example of image detection using memory having information refinement detection functions.

FIG. 14 depicts a seventh example of image detection using memory having information refinement detection functions.

FIG. 15 depicts an eight example of image detection using memory having information refinement detection functions.

FIG. 16 depicts a ninth example of image detection using memory having information refinement detection functions.

FIG. 17 depicts a tenth example of image detection using memory having information refinement detection functions.

FIG. 18 depicts an eleventh example of image detection using memory having information refinement detection functions.

FIG. 19 depicts an example of a graphic user interface (GUI) for memory having information refinement detection functions.

FIG. 20 depicts an example of one-dimensional information detection.

FIG. 21 depicts an example of two-dimensional information detection.

FIG. 22 depicts an example of three-dimensional information detection.

FIG. 23 depicts an example of ambiguous detection for one-dimensional information.

FIG. 24 depicts an example of ambiguous detection for two-dimensional information.

FIG. 25 depicts an example of ambiguous detection for three-dimensional information.

FIG. 26 depicts a second example of ambiguous detection for two-dimensional information.

FIG. 27 depicts an example of coordinate transformation for two-dimensional information.

FIG. 28 depicts an example of a block diagram for memory having set operating functions.

FIG. 29 depicts an example of a detailed block diagram for memory having set operating functions.

FIG. 30 depicts an example of a graphic user interface (GUI) for a literature search.

FIG. 31 depicts step 1 of set operations using memory having set operating functions.

FIG. 32 depicts step 3 of set operations using memory having set operating functions.

FIG. 33 depicts step 3 of set operations using memory having set operating functions.

FIG. 34 depicts step 4 of set operations using memory having set operating functions.

FIG. 35 depicts an example of edge detection using memory having set operating functions.

FIG. 36 depicts an explanation diagram of image patterns and image pattern matching.

FIG. 37 depicts the principle of image pattern matching using memory having information refinement detection functions.

FIG. 38 depicts the idea of areas/edges.

FIG. 39 depicts exclusive pattern matching for images. (Embodiment Example 1-1)

FIG. 40 depicts the encoding of edge codes using the patterns of four neighboring pixels. (Embodiment Example 1-2)

FIG. 41 depicts the encoding of edge codes using the patterns of eight neighboring pixels. (Embodiment Example 1-3)

FIG. 42 depicts the arrays of image pattern match information using memory having information refinement detection functions. (Embodiment Example 1-4)

FIG. 43 depicts an example of applying object edge codes. (Embodiment Example 1-5)

FIG. 44 depicts unplanned and planned pattern matching through local pattern matching. (Embodiment Example 1-6)

FIG. 45 depicts an example of detecting changed images for objects.

FIG. 46 depicts the detection of corresponding points on an object through local pattern matching. (Embodiment Example 1-7)

FIG. 47 depicts object recognition using edge codes. (Embodiment Example 1-8)

FIG. 48 depicts human recognition using stereoscopic analysis. (Embodiment example 1-9)

FIG. 49 depicts object recognition in space. (Embodiment Example 1-10)

FIG. 50 depicts a concept diagram of object recognition using pattern matching. (Embodiment Example 1-11)

FIG. 51 depicts a reference example of phoneme wave amplitudes.

FIG. 52 depicts Reference Example A for phoneme wave frequency spectrums.

FIG. 53 depicts Reference Example B for phoneme wave frequency spectrums.

FIG. 54 depicts an example of area data for differentiating phonemes.

FIG. 55 depicts an example of phoneme recognition using memory having information refinement functions.

FIG. 56 depicts an example of vocabulary pattern matching.

FIG. 57 depicts an explanation diagram for image patterns and image pattern matching.

FIG. 58 depicts the principle of image pattern matching using memory having information refinement detection functions.

FIG. 59 depicts exclusive pattern matching.

FIG. 60 depicts rows of fonts.

FIG. 61 depicts Diagram A explaining the creation of sampling points for letter patterns.

FIG. 62 depicts Diagram B explaining the creation of sampling points for letter patterns.

FIG. 63 depicts an example of creating letter pattern sampling points for a specific font.

FIG. 64 depicts an example of letter recognition for images with subtitles.

FIG. 65 depicts an example of an information processing device equipped with real-time OCR functions.

FIG. 66 depicts an example of letter recognition for text images.

FIG. 67 depicts an example of pattern matching for one-dimensional information.

FIG. 68 depicts an example of pattern matching for two-dimensional information.

FIG. 69 depicts an example of a GUI for one-dimensional information pattern matching.

FIG. 70 depicts an example of a GUI for two-dimensional information pattern matching.

FIG. 71 depicts an example of a GUI for image information pattern matching.

FIG. 72 depicts a concept diagram for pattern matching using this method.

### DETAILED DESCRIPTION OF THE INVENTION

Below is a detailed explanation, referencing the attached figures, on the best embodiment form for the present invention.

### (Purpose of the Invention)

The present invention provides a processor with set operating functions for collectively operating sets of information.

Processes for finding information, in other words, search, verification and recognition processes, can be accomplished through a common processor with the realization of this invention. Furthermore, a large-scale system can be realized for enabling high-speed pattern matching, edge detection and any kind of set operation. It will become possible to generalize technologies for high-speed hardware pattern matching and edge detection—at the core of image, voice and text recognition—without relying on an exclusive LSI, special software algorithms or supercomputers. This will make full-scale intelligent processes on the computer more familiar to our everyday lives.

(Invention on a Patent Application, on which Priority Claim is Based)
Prior to this application, the applicant has filed the following patent applications, on which priority claim is based.

Patent Application No. 2012-083361 relates to phoneme recognition, vocabulary recognition and voice recognition pattern-matching methods. Patent Application No. 2012-101352 relates to image recognition, object recognition and pattern matching methods. Patent Application No. 2012-110145 relates to an image text recognition method and an information-processing device having image text recognition functions. The above three patents all relate to the three major kinds of human recognition—voice, image and text.

At the same time, Patent Application No. 2012-12139 is a standardization method for pattern matching and pattern matching GUIs. It summarizes the common items indispensable to pattern matching related to recognition as well as the minimum contents for generalized or standardized pattern matching.

The following is a general overview of the above.

The invention described in Claim 1 of Patent Application No. 2012-083361 (phoneme recognition method, vocabulary recognition method, voice pattern matching method):

“(1) Provides spectrum or cepstrum patterns for each phoneme of the voice as an array database based on phoneme and frequency, and (2) by querying the spectrum or cepstrum pattern derived from the emitted voice to the above array database, address that matches the above requirements can be detected from the above array database.

This phoneme recognition method detects the queried phoneme from the above steps (1) and (2).”

The invention described in Claim 1 of Patent Application No. 2012-101352 (image recognition method, object recognition method, pattern matching method):

“For images where the sizes of the XY arrays are defined, it
(1) Creates image query pattern(s) by combining the pixels' image information data values, which compose the image, and the positions of the pixel data and (2) detects the pixels that match the queried pattern from the above subject images by querying the above image query pattern to the images subject to detection.
This image recognition method processes images through the above steps (1) and (2).”

The invention described in Patent Application No. 2012-110145 (image and text recognition method, information processing device with image and text recognition functions):

“(1) Creates and registers image and text query patterns composed by combining both the pixels' image information data values, which compose the font of the text in the images (image text), and the pixels' positions and (2) detects the pixels matching the queried image pattern from the above subject images by querying the above image text query pattern to the images subject to the image text recognition.
This image text recognition method processes image text using steps (1) and (2).”

The invention described in Patent Application No. 2012-121395 (pattern matching standardization method, pattern matching GUI standardization method):

“For pattern matching and detection of information with defined and recorded information arrays, it
(1) Specifies the definitions for the information arrays, (2) specifies the candidate information data values for pattern matching and sets them as the base information, (3) specifies each of multiple match information data values separately for matching against the base information from (2) and individually assigns each of the information positions, and (4) takes the base information from (1) and multiple match information from (2) as sets of query data patterns and detects the address of the above base information (2) that matches with this query pattern.
This is a pattern match standardization method that detects information pattern matches through steps (1) to (4).

Pattern matching forms the basis of each of the above prior applications. Information is processed using both the information and information position, which form the basis of pattern matching, as the input conditions and the processed information results are then output. This process applies operation conditions to set information like images, text information in images and voice, and determines the operation result.

The present invention provides a processor that can implement the above ideas.

The final purpose of the present invention is to realize a logical operations processor that will make operation time feel completely nonexistent, as with the concept of sets in mathematics.

### (Regarding “Sets” in Information Processing)

As noted above, according to a Wikipedia article, sets in mathematics are, roughly speaking, collections of objects. The article further states that the individual objects that form these sets are called “elements.”

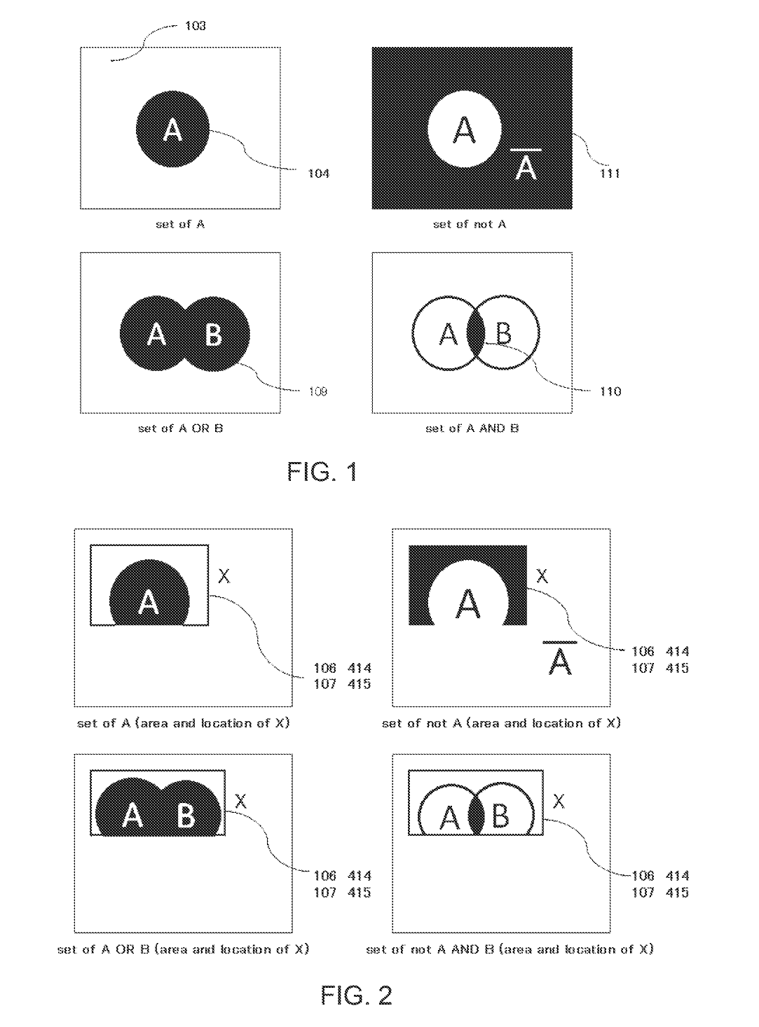

FIG. 1 is an Euler diagram that depicts the concept of set operations.

The Euler diagram is a concept diagram that makes the idea of set theory easier to understand and is frequently used in cases like finding a specific element 105 or a subset 104 out of the whole set 103.

If the figure is a set of information 102, the elements 105 that we would like to find from the whole set of information are specified, in other words the information is subset (shown as A and B in the figure), are specified. It is a known fact that all kinds of set operations 115, including logical difference and logical object, are possible by logical negation 111, logical OR 109, logical AND 110 or a combination of these on the information subset. This idea forms the fundamentals of current information processing (the computer).

While the mathematical concept as noted above is extremely simple, elements in information processing are rarely located in a single collective area and are instead generally scattered in various places.

FIG. 2 is an Euler diagram that includes the concepts of positions and areas.

The concepts of information positions 106 and areas 107 are combined onto the set operation 115 as described in FIG. 1.

### (The Meaning of Information Location in Set Operations on Information)

Because the physical structure of the memory itself (from which we want to find information) is composed of only two elements, addresses and memory cells, set operations, in other words the process of finding information, is none other than pinpointing what information recorded on the memory is at what address or, conversely, what information is at a specified address.

It thus follows that set operations determine what is where or where is what on the memory. If the “what” (data value) and “where” (address) can be collectively set operated, set operations can be realized on all information on the memory. Conversely, set operations in information processing cannot be conducted without information (information data) position 106 or its area 107.

For information processing, as in FIG. 2, information position 106 of course refers to the position 414 of the information data or the specific address of the memory, and its area 107 refers to the area of the information data 415, in other words specific addresses.

Of course, this is a wide-ranging concept that includes cases of only a single address, multiple addresses, wide-ranging address areas or discrete addresses.

The figure depicts the results of set operations 115 on X with specific position 106 and area 107.

For instance, for chronological data, a representative example of one-dimensional information, set operations 115 include specifying the position and area of the specific time and conducting operations; for image data, a representative example of two-dimensional information, it includes specifying the position and area of the image and operating; on these operation results, set operations determine which locations 114 the operation results are at.

This kind of thinking is an information processing activity that we conduct naturally on an everyday basis. It is an important concept, without which it would be meaningless to conduct set operations 115, and is absolutely indispensable to set operating information.

Set operations 115 have heretofore been conducted on elements 105. The existence of addresses 203 was an implicitly understood condition and, while no special explanation was necessary for this implicit knowledge, this idea is indispensable to collectively conducting set operations 115 on the entire memory. It is an indispensable concept for pattern matching and edge detection as will be described later.

In this patent application, these diverse and highly meaningful information (information data) positions 106 and areas 107 will be explained using the expression, information location 114.

While set operations 115 are used in various fields of databases, from large databases to small databases, a representative example of set operations 115 is the Patent Office's patent literature search system.

For instance, when searching for prior patents using a few keywords, the process of using set operations like logical OR 109, logical AND 110, logical negation 111 to find the specific patent literature is exactly this concept.

Data mining, one of the new data processing 101 industries, uses exactly such set operations 115, only changing it in name. These information processes 101 for set operation 115 are generally conducted using the CPU's information processing programs.

The Euler diagram describing set theory is expressed using mathematical interpretations and the existence of elements 105 may be difficult to understand here, however in actual information processing 101, set operations 115 are conducted on the elements 105.

When the CPU conducts set operation 115 on large amounts of information (elements) recorded on its memory, because it does not know where or what information (element) is recorded on the memory, it verifies each memory address like turning over a set of playing cards one by one. This process (search) must be conducted until the result in question is found.

When we search for lost things, most of this search time is wasted time. For the CPU, searches within its memory space are much like our searches for lost things, where most of the searching is conducted in meaningless places. And the bulk of this time becomes wasted information processing time.

It thus follows that set operations 115 are extremely harsh and unreasonable information processes for the CPU.

### (The Concept of the Present Invention)

In the present invention,

Information is recorded at each memory address and the memory can read this information.
This memory is further equipped with: Input 221, or Input 1, for comparing information assigned from outside sources and recorded on each memory address; Input 222, or Input 2, for comparing between each memory address; and Input 223, or Input 3, for allowing the selection of (1) subset, (2) logical OR, (3) logical AND, (4) logical negation, or a combination of two or more of these as set operation conditions.
It is further equipped with a method 208, 209 for comparing and judging information recorded at each memory address, based on Input 1; a method 210 and 211 for comparing and judging between information recorded on this memory, based on Input 2; a method 224 for logically operating the results from the above Inputs 1 and 2 based on Input 3; and a method 207 for outputting the results of the set operation.

Below is an explanation of the constituting elements of this invention as well as an explanation of the idea behind a processor based on a new way of thinking in which the memory can process information on itself for the above set operation 115 without relying on the CPU.

### (Content-Addressable Memory)

The memory here invented is a processor that takes hints from CAM, which has an extremely high potential that is not sufficiently used. Thus, here is first an explanation on CAM.

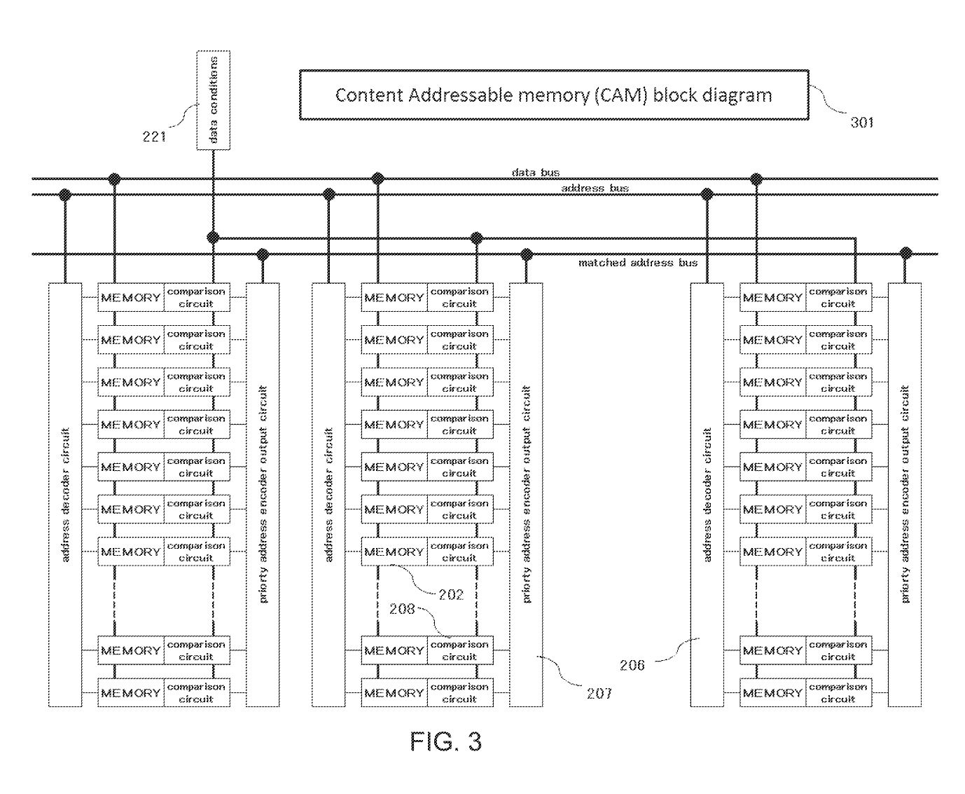

FIG. 3 depicts a block diagram for Content-Addressable Memory (CAM).

Content-Addressable Memory (CAM) 301 is known as a conventional memory-based architecture device, in other words, a device in which the memory itself processes information independently. This Content-Addressable Memory (CAM) 301 has a structure in which memory cells 202 are arranged based on memory address 203, and like the conventional memory, it is a device in which memory cell 202 can read and write information while data comparison circuit 208 can conduct parallel comparisons based on data conditions 221 input from the outside and output the results of this operation.

As this block diagram shows, the structure allows the address specified by the address bus to be decoded by the address decoder circuit 206, an address to be selected, and data written and retrieved from the memory. At the same time, memory cell 202 that matches data condition 221 input from outside is detected in parallel through data comparison circuit 208 parallel arrayed for each memory address. In this example, the detected result is then output to the matched address bus through priority address encoder 207.

Content-Addressable Memory (CAM) 301 having the above contents generally are for complete matches, and because there is a limit to the range of information it can use in practice, it is currently only used to the extent of detecting IP addresses for internet communication devices.

Next is an explanation of an example of Content-Addressable Memory equipped with a data comparison method, one of the components of the present invention.

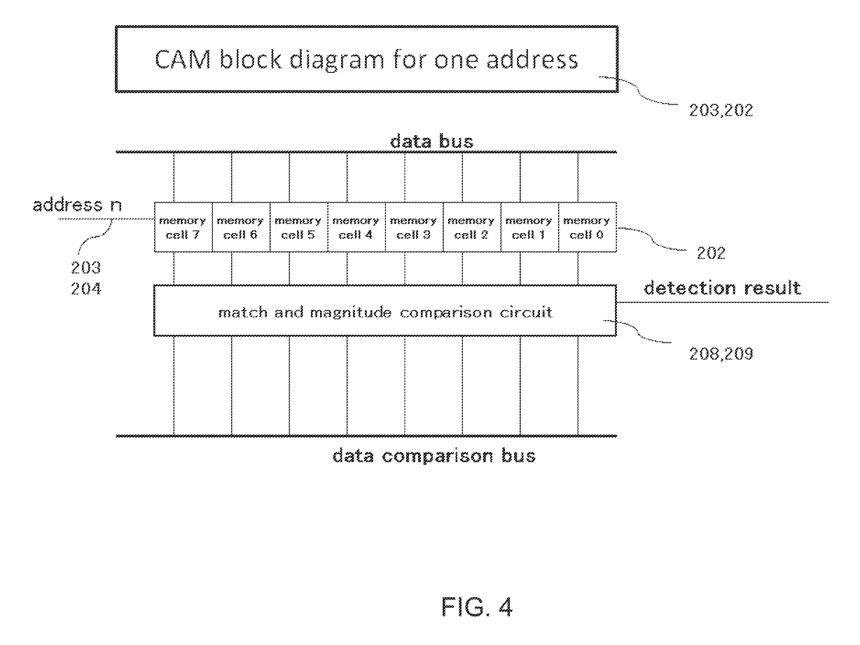

FIG. 4 is an example of a data comparison circuit for this Content-Addressable Memory (CAM).

Each address in the Content-Addressable Memory (CAM) 301 depicted in this figure has a data width of 1 byte; in other words, the CAM has an 8-bit structure. However, for general purposes, the data width at each address can be freely set and can be assigned a width appropriate to the subject information.

In order to make up for the weaknesses of the above Content-Addressable Memory (CAM) 301 for complete matches, the types of usable information can be largely broadened by enabling data magnitude and match comparisons using data comparison circuits 208 and data range comparison circuits 209, as shown in the figure.

Image information 405 are continuous analog data converted to digital data. In order to handle such data, complete matches are insufficient and comparisons with range(s) is indispensable.

At the same time, partial matches are also important. The color information 402 in image information 405 is composed of pixels 406, made from a combination of three colors, R (red), G (green) and B (blue). Image information 405 is composed of matches in data related to R, matches in data related to G and matches in data related to B.

In the present invention, the matching of such various data conditions is expressed as the coincidence 116 of information data values 117.

Based on the above structure, a data coincidence is found in parallel and basic set operations 115, such as subsetting 104 a data condition 221 or logical OR 109/logical AND for multiple data conditions 221, are made possible.

Next is set operations 115 that include data locations 114 as an important element.

While parallel operations are indispensable to subsetting partial matches multiple times and set operating 115 at high speeds on the information data location 114, it is not realistic to set individual parallel arithmetic units for each address of the Content-Addressable Memory 301. There was thus no other way but to rely on serial information processing devices like the CPU or GPU. In other words, while set operations 115 using information data conditions 221 were heretofore realizable with Content-Addressable Memory (CAM) 301, the technology for conducting parallel set operations 115 including data location 114 was nonexistent. In other words, because Content-Addressable Memory (CAM) 301 could not set operate 115 on data location 114, it had become just a seldom used, incomplete device.

Below is an explanation on the basic principle for finding the whole set space through parallel processing and set operations 115 conducted in an extremely simple way on the data locations 114 of multiple data conditions 221.

### (On Methods for Set Operating Information Data Values (Data Comparison Circuit) and Methods for Set Operating Information Data Locations (Address Comparison Circuit))

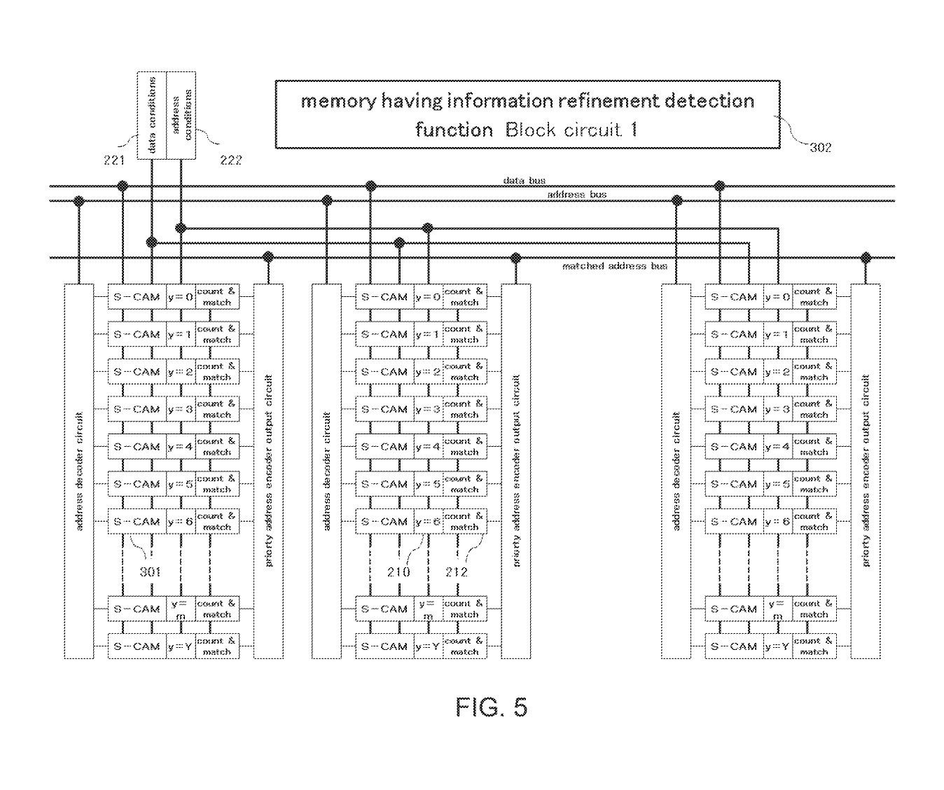

FIG. 5 depicts a block diagram for memory having information refinement detection functions.

In addition to the aforementioned Content-Addressable Memory (CAM) 301 functions, this memory having information refinement detection functions 302 is composed of: address comparison circuits 210 for detecting data locations 114 based on address conditions 222 assigned from outside sources; match counters 212 for counting the cumulative results; and priority address encoders 207 for outputting the matched address 213, in other words the address that remains.

In other words, this memory having information refinement detection functions 302 uses address comparison circuits 201, installed in parallel to the Content-Addressable Memory (CAM) 301 output, and address area comparison circuits 211 to specify data locations 114, in other words the address positions 106 and areas 107. By refining the information, it allows for logical AND operations 110 between information.

The address comparison circuits 210 and address area comparison circuits 211 can realize parallel operations of memory addresses 216, like changing the positions of the Content-Addressable Memory (CAM) 301's output flags. And this structure resolves the Content-Addressable Memory (CAM) 301's incomplete set operations 115 for information locations 114.

The memory having information refinement detection functions as shown in this example consists of a structure that can be simply realized by one-dimensional (linear array) shift registers and is a structure that is best fit for one-dimensional information arrays.

Below is a general overview of the operations of this memory having information refinement detection functions 302.

### (An Example of One-Dimensional Pattern Matching)

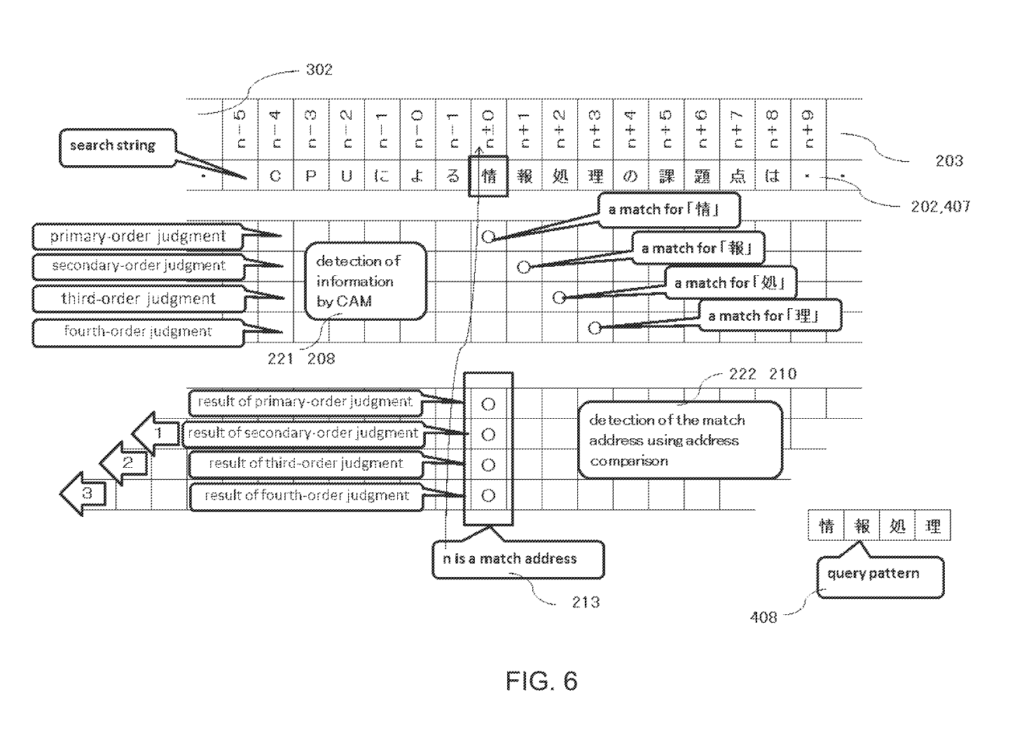

FIG. 6 depicts an example of a full text search.

As shown in FIG. 6, text arrays, which are sets of text data 102, are recorded onto the memory having information refinement detection functions 302 as a database 407.

An example of detecting a query pattern 408, the text array [symbol] “jyo”, [symbol] “ho”, [symbol] “syo”, [symbol] “ri” (information processing) from the database 407 is depicted below.

As the primary judgment, the memory having information refinement detection functions detects the character [symbol] “jyo from data conditions 221 assigned through outside sources using Content-Addressable Memory (CAM) 301 functions. The results then form the base information 421 for later text detection.

As the secondary judgment, the letter [symbol] “ho” is detected in the above way while these secondary judgment results as a whole are shifted one address to the left of the diagram.

As the tertiary judgment, the letter [symbol] “sho” is detected in the above way while these tertiary judgment results as a whole are shifted two addresses to the left of the diagram.

As the quaternary judgment, the letter [symbol] “ri” is detected in the above way while these quaternary judgment results as a whole are shifted two addresses to the left of the diagram.

The address where the above four judgment results coincide, in other words, the address where the match counter 212 becomes “4” is where the logical AND 110 is true, in other words, it is the matched address 213 as shown in the figure. From the whole area of the subject database, in this example, the address n±0 from absolute address 204 becomes the starting address for the text array [symbol] , [symbol] , [symbol] , [symbol] “jyo”, [symbol] “ho”, [symbol] “syo”, [symbol] “ri” (information processing).

In other words, this is the same as saying that the match counter 212 has recorded the cumulative logical AND operations 110 in this case.

At the same time, [symbol] , [symbol] , [symbol] , [symbol] need not necessarily be in this order, and in the case of the order [symbol] , [symbol] , [symbol] , [symbol] the shift direction of address 203 reverses so that [symbol] becomes the base information 421 and matched address 213.

Furthermore, even if some words in between are skipped, as with [symbol] , [symbol] , [symbol] , [symbol] as long as the direction and corresponding position when shifting and comparing address 203 are accurate, it is possible with any kind of array.

It goes without saying that there may be cases where no matched address 213 exists in the entire database 407 or cases where there are multiple matched addresses 213.

What is important is that the information specified first becomes the base information 421 and the base information 421 are successively refined to detect the address that remains at the very end.

Another important thing is the amount shifted in parallel operating the memory address 216. In other words the locations of the information compared are relative positions of one another, in other words relative addresses 205, and the result detected thereof is absolute address 204.

It follows that any kind of information can be detected as long as the combination order of the element(s) 105 that we want to detect is known.
Conventionally, in conducting such high-speed searches, it was necessary to devise special algorithms like array methods that help bring up frequently searched information or index tables. But in these algorithms, it was necessary to change the table or algorithm each time the data was renewed. With this technology, such preliminary processes on information data become completely unnecessary.

While it will be described later, this is the same for two-dimensional image data.

The above text array was a representative explanation for patterns 401 defined in the background technology. And, as in the above explanation, such text arrays can be simply detected without conducting conventional searches. These Content-Addressable Memory (CAM) 301 functions and the parallel operation of memory addresses, much like shifting the positions of its output flags, instead rely on a few clocks of shift operations by the shift register.

Further high-speed parallel operations of memory addresses 216 can also be realized by appropriately combining multiplexors and barrel shifters.

It follows that, because such set operations 115 on the entire memory using fully parallel methods make scans (searches) of individual memory spaces (information elements) on the CPU completely unnecessary, full text searches at ultra-high speeds incomparable to conventional information processing 101 become possible.

At the same time, because it is fully parallel, it is not affected by information size. And the greater the size of the set 102, the more significant the difference in its operation speed will appear.

Going back to the aforementioned patent literature searches, using such high-speed detection technology will enable repeated searches of similar words (i.e. thesaurus functions) in an extremely simple way.

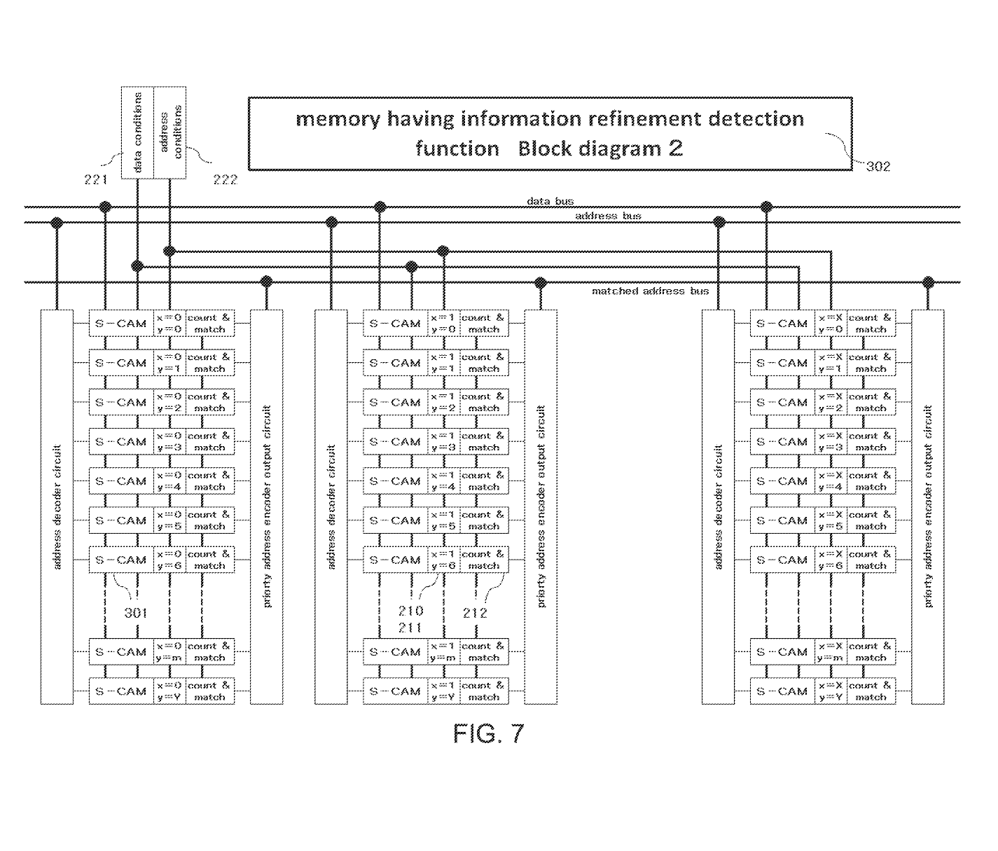

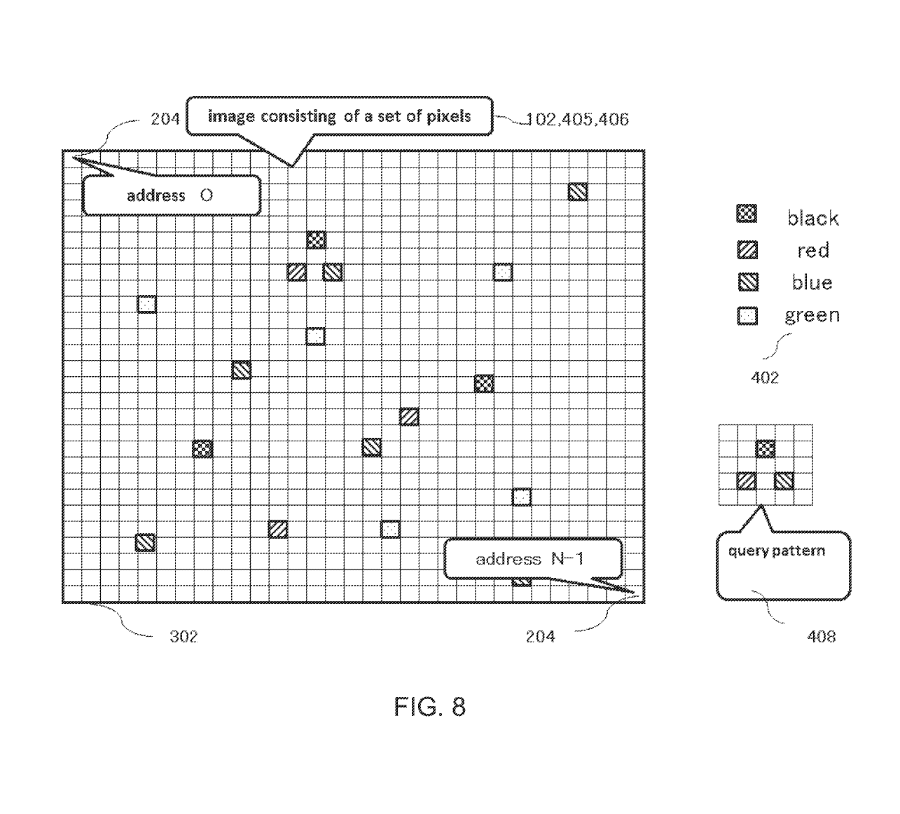

FIG. 7 depicts a second example of a block diagram for memory having information refinement detection functions.

The memory having information refinement detection functions 302, as shown in this example, is composed of address comparison circuits 210, for conducting set operations 115 on information locations 114 as shown above, and address area circuits 211 composed of two-dimensional (consisting of 2 axes, X and Y) shift registers; it is structured to best fit two-dimensional information arrays.

### (An Example of Two-Dimensional Pattern Matching)

FIGS. 8 to 18 explain the concept of image, or two-dimensional information detection using memory having information refinement detection functions 302. As depicted in FIG. 8, the image information 405, or set 102 of pixels 406, is recorded as arrays in the memory having information refinement detection functions 302.

In this figure, the color data 402 for the colors red, blue and green are recorded as arrays at each address 204 from address 0 to N−1 as shown in the figure.

Of course, the type of information data value 117 does not matter, whether color data 402, brightness 403 or any other means of information data.

This is exactly the same as recording information in conventional memory.

The query pattern 408 is a pattern that consists of three pixels of sampling points 410, represented by the black, red and blue pixels 406.

The following describes the concept, from the memory having information refinement detection functions pattern matching 409 from the set of information 102 based on the query pattern 408 to outputting the matched address 213.

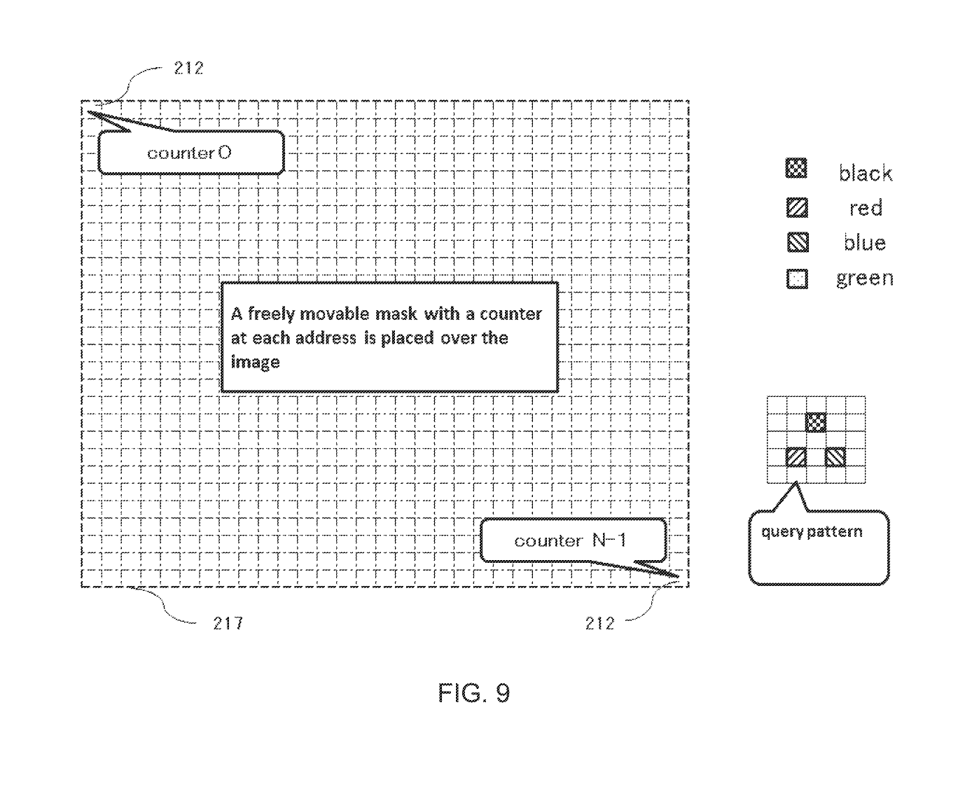

Pattern matching for the above kinds of two-dimensional information can be readily understood through concept diagrams as shown in FIG. 9.

A mask 217 is placed over the above image information 405. Match counters 212 are arrayed throughout this mask 217. In this case, the counters are arrayed at each address, from 0 to N−1, in other words at each pixel 406.

As with the previous one-dimensional text detection, pattern matching can be conducted in any order. In this example, pattern matching 409 will be conducted for pixels 406 in the order “black, red, blue.”

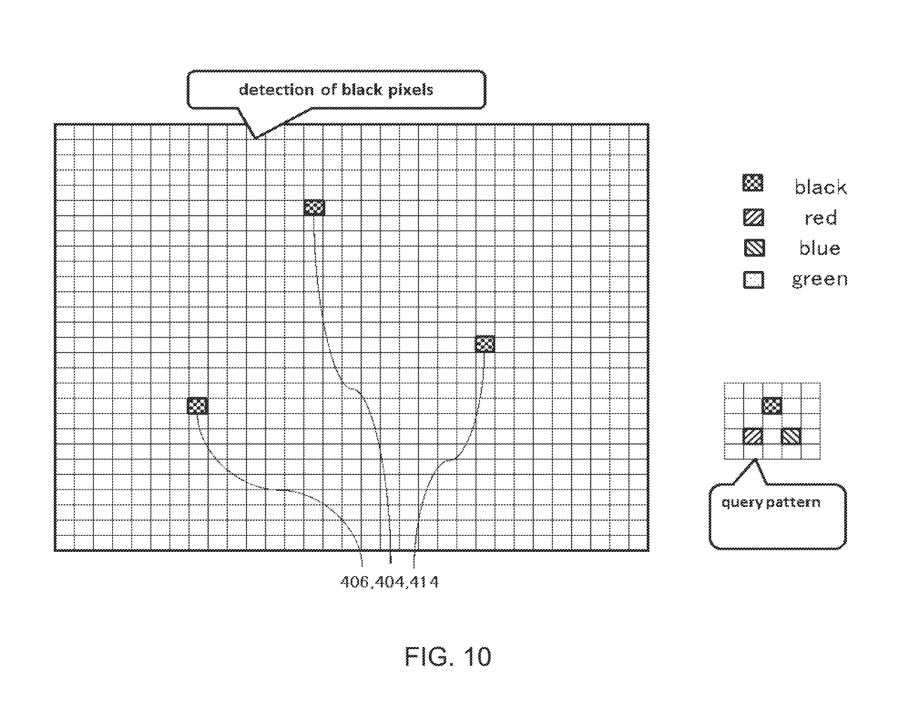

FIG. 10 depicts the parallel detection of black pixels 406 using Content-Addressable Memory (CAM) 301 functions.

Three black pixels 406 are detected as coordinates 404 and data positions 414.

It goes without saying that the information data 412 coinciding 116 with the specified information data value 107 is expressed as the information location 114, in other words data position 414 is shown as coordinates 404.

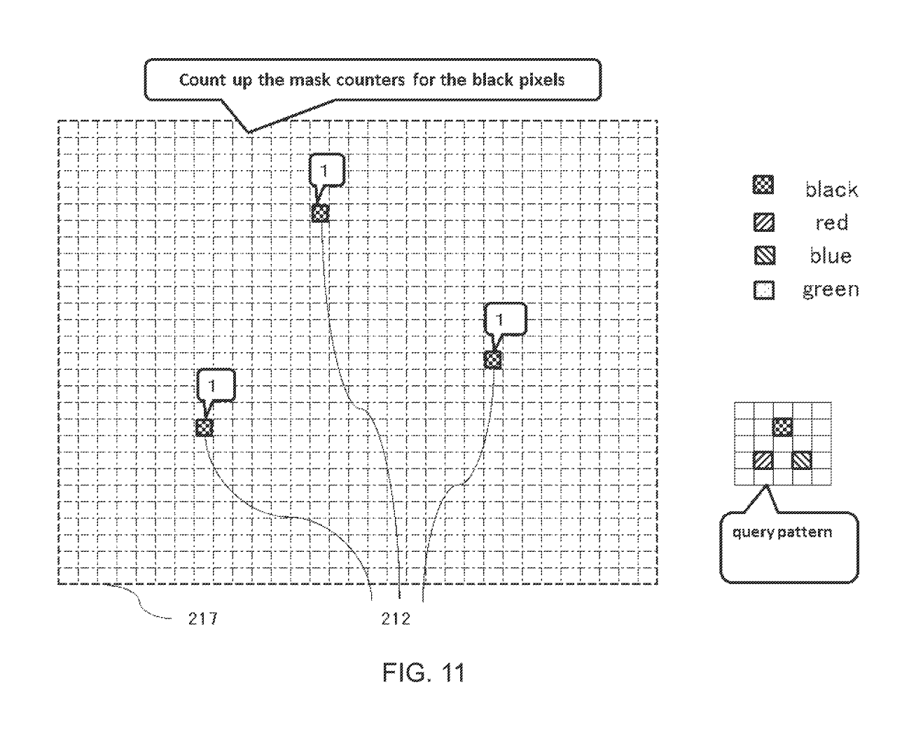

The above three pixel coordinates 404 and data positions 414 become the base information 421 for future pattern matching. As shown in FIG. 11, holes are made in the mask 217 at the positions of the base information 421, at coordinates 404 and data positions 414, so that the pixels can be seen from these holes.

After waiting for the black pixels 406 to be visible from the holes in the mask 217, the match counter 212 counts “1.”

From the above operations, three pixels 406 are counted by match counter 212 as “1.” This shows that there is a possibility that a pattern similar to the query pattern 408 may exist in the vicinity.

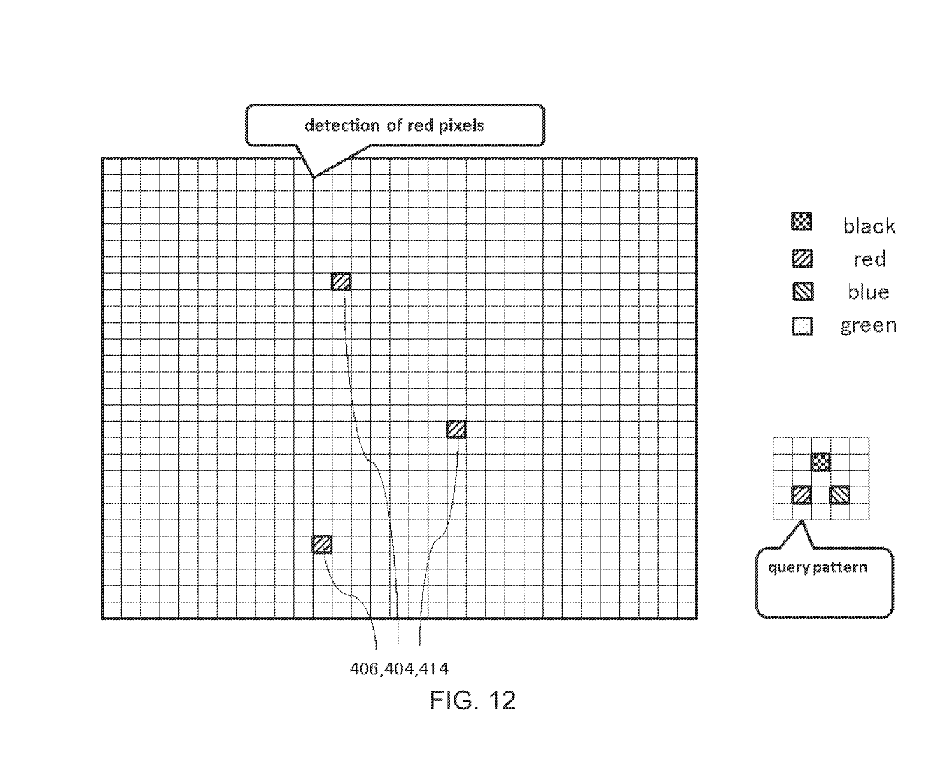

Next, the red pixels are likewise detected as shown in FIG. 12.

In this case, there are three locations with red pixels.

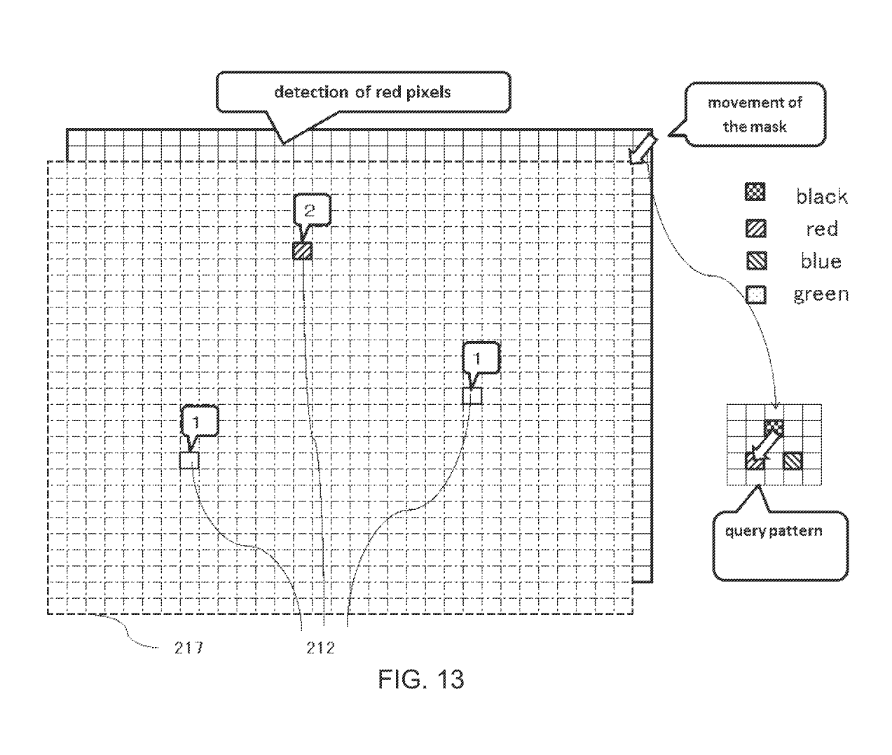

Operation of these red pixels, at coordinates 404 and data positions 414, and the black pixels detected before, at coordinates 404 and data positions 414, are conducted as shown in FIG. 13.

As shown in FIG. 12, the mask 217 marked with the base information 421 defined from black pixels 406 is shifted by the positional difference between the black and red pixels in the query pattern, in other words, the equivalent coordinates 404 and data positions 414.
At this time, there is only one location where red pixels are visible from the base information 421 positions, in other words the coordinates 404 and data positions 414 where the holes were previously made.
What this means is, the match counter 212 for this base information 421 counts “2” in this location, and this result remains (tournament). The other two match counters for the other base positions remain at “1” and fall out from the results.

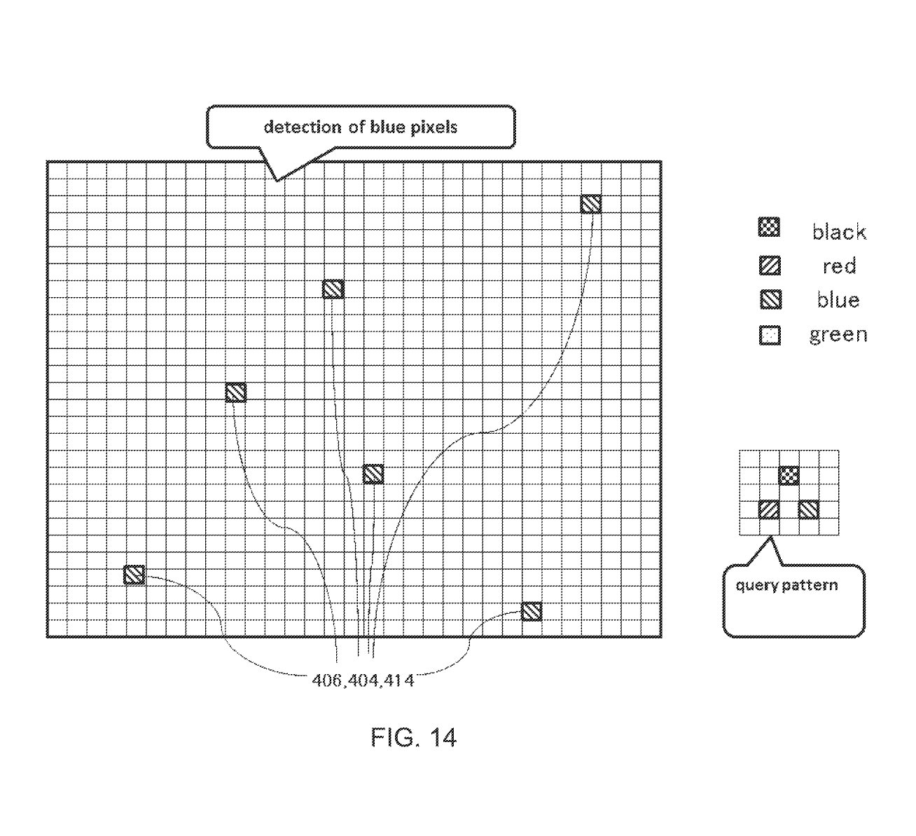

As shown in FIG. 14, the blue pixels 406 are detected next.

In this example, six pixels are detected.

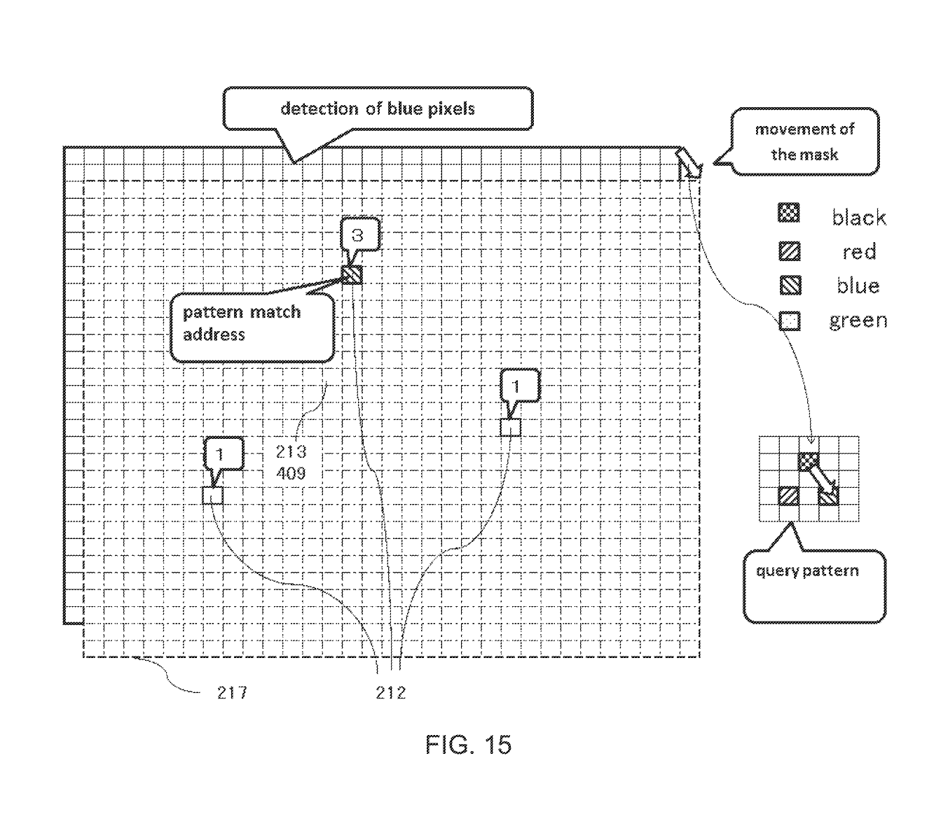

As shown in FIG. 15, the above mask is shifted by the positional difference between the black and blue pixels in query pattern 408, in other words, by the equivalent coordinates 404 and data positions 414.

At this time, only one pixel location can peek the blue pixels in the above mask 217 with holes in the positions, or the coordinates 404 and data positions 414, of the base information 421.

In other words, in this location, the match counter 212 counts “3” for this base information and this information remains, while the other two base positions show a value of only “1” in the match counter 212.

What this means is that, when the black pixel in the query pattern 408 is specified as the base information 421, the positions of the red and blue pixels 406, in other words the coordinates 404 and data positions 414, where the counter value is “3” for the match counter 212 is where there is a pattern match(es) 409. This matched address 213 remains and is detected.

The shifting of the above mask 217 is, of course, realized by parallel operation 216 of the memory addresses through the address comparison circuit 210 and address area comparison circuit 211.

In the above pattern matching, by specifying the coordinates 404 and data positions 414 of the query pattern(s) 408, assigned from outside sources with relative address(es), in other words the distance(s) 108 between the pixels, and enabling the output of the matched address 213 result(s) from the pattern match operation 409 to be absolute address(es) 204, the later processing workload can be lightened.

Because this example was made for explanation purposes, it uses an extremely small sized image and an extremely small number of sampling points 410 for pattern matching 409 using the query pattern 408. However, even if the image size is large, because of the probabilistically great effect of refining, pattern-matching 409 with sufficiently refined matched addresses 213 can generally be expected from query pattern(s) 408 ranging from images with a few pixels to tens of pixels.

As with the one-dimensional information example, the above image pattern matching is based on a few clocks of shift operations using the shift register and the functions of Content-Addressable Memory (CAM) 301. And because this renders the CPU's scans of memory spaces and subsequent location vector operations between information completely unnecessary, it allows for high-speed detection incomparable to conventional methods.

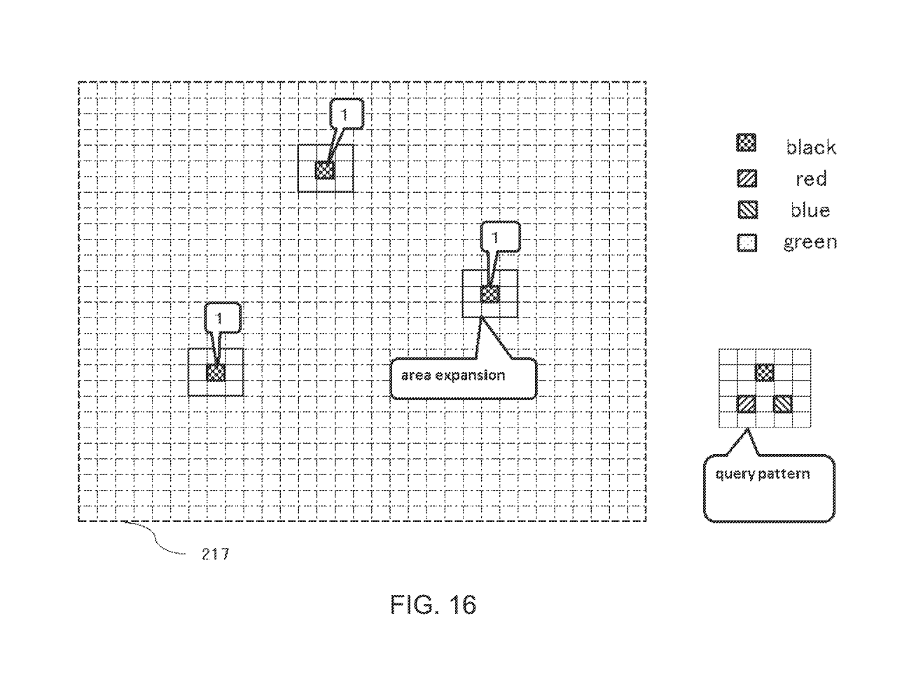

While the above explanation is an example of pattern matching 409 for complete matches, FIG. 16 extends the area of the base information 421 by ±1 in both the X and Y axes.

By thus assigning an area to the coordinates 404 and data positions 414, ambiguous pattern matching 418 becomes possible.

Pattern matching 409 based on such ambiguous patterns 417 not only sets an area for information positions but also adds a range to information data values and a mismatch tolerance 425 for the number of measurements taken by the match counter 212. This allows for ambiguous recognition 419 based on ambiguous pattern matching 418 that is extremely practical and, furthermore, along the lines of human sensibilities.

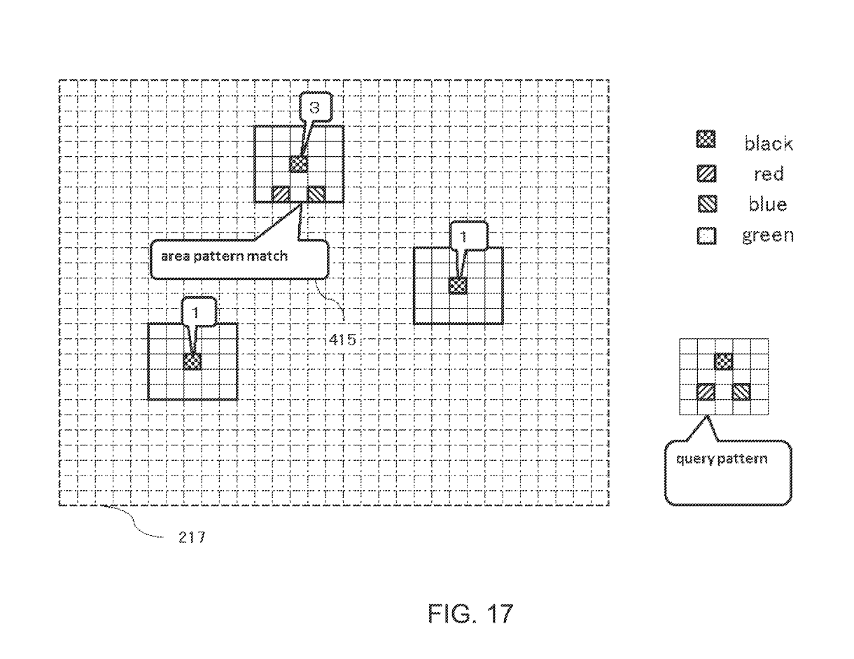

For instance, FIG. 17 depicts an example where the base information 421 is black and the area for its coordinates 404 and data positions 414 are set at ±2 for both the X-axes and Y-axes

By specifying a range as in the above, patterns can be found without moving the mask.

Pattern matching 409 heretofore was for determining the base information location 114 through a method of first specifying the information that would form this base. However, contrary to this idea, the following explanation will describe a method for specifying information locations 114, including positions 106 and areas 107, by targeting absolute addresses 204.

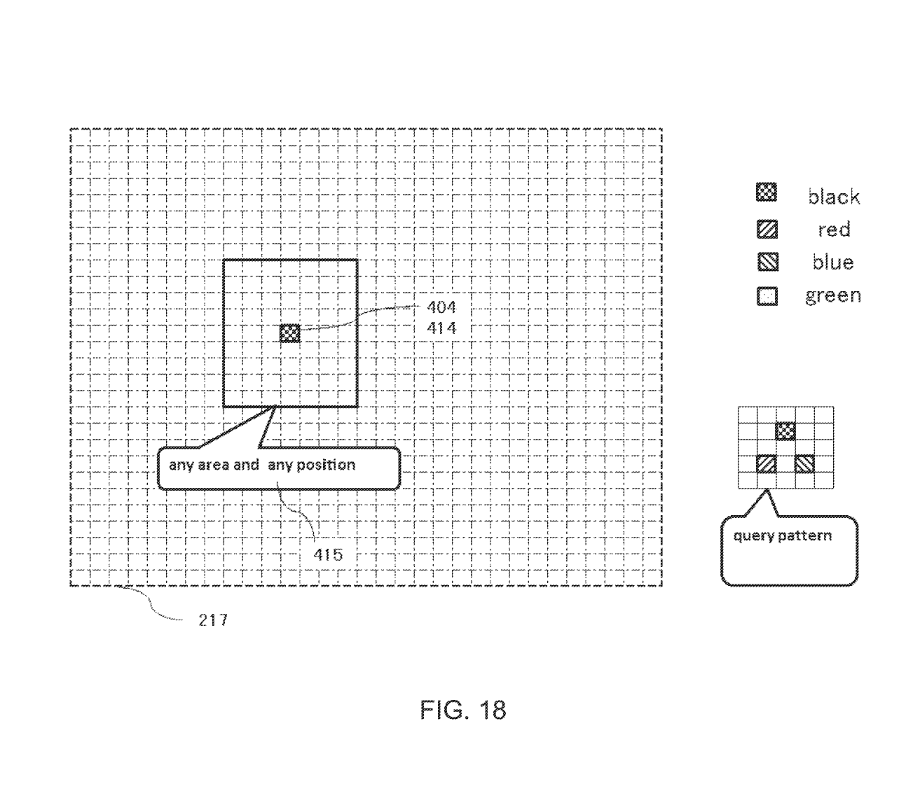

For example, the image to be recorded on the memory having information refinement detection functions 302 is completely white and, as shown in FIG. 18, a specific color—“green” in this example—is a recorded on the target coordinates 404 and data positions 414.

One pixel from the above image is detected using the functions of Content-Addressable Memory (CAM) 301 as described above. By extending the area of the detected output flag using the address comparison circuit 211, the location 114 based on the absolute position and its area, in other words the absolute address 204, can easily be specified.

This specification of absolute address spaces can also be used for detecting color histograms and concentrations in limited spaces.

The detection of absolute address area concentration is best fit for detecting color areas on the human skin, as in faces and hands, as well as the existence of objects with certain colors 402 and brightnesses 403.

Of course, if the address conditions cover the entire area, the entire memory becomes subject to the operation. And if the area is specified, the operation results will only be for the subject area.

This is an extremely important point.

This is because, when an enormous amount of information is recorded on the memory, if only the subject address area is output, the processing workload for sequentially reading the matched addresses 213 can be lightened.

The explanations above illustrate an example of pattern matching 409, the foundations of recognition technology, using methods for specifying information (data) values 117 and methods for specifying information (data) locations 114.

It goes without saying that information (data) values 117 denote various types of information and their coincidences 116 and information locations 114 not only denote both the information positions 106 and areas 107 but also express both the relative locations and absolute locations.

The concept of information data locations 114 has been explained above based on text information and image information.

While the concept of information location 114 in information processing is a highly intangible idea that is extremely wide-ranging and hard to grasp, the following is an example on the standardization of set information processing for types of information that are indispensable to our information processing activities.

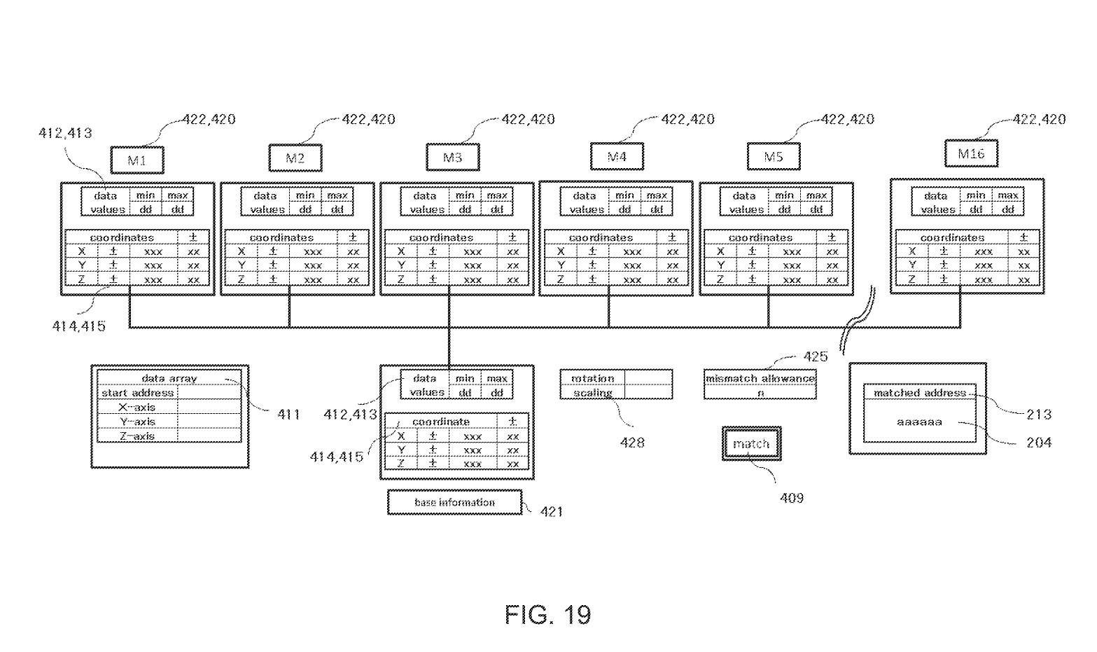

FIG. 19 depicts an example of this memory's graphic user interface (GUI).

In order to make it a generalized graphic user interface (GUI), it will be structured so that information locations 114, in other words information positions 106 and areas 107, can be appropriately specified by selecting a data array 411 that is either one-dimensional, two-dimensional or three-dimensional.

In this example, the basic structure of the graphic user interface (GUI) is composed by specifying each information to be matched 422, for the match order 420 from M1 to M16 in this example, as information data 412 and ranges 413 as well as information locations 114, in other words information data positions 414 and areas 415, based on the base information 421.

It is further composed of functions for specifying data arrays 411, transforming coordinates 428 for information locations and allowing mismatches 425 on the match counter.

By specifying these pattern match conditions and specifying pattern matching 409, the memory having information refinement detection functions 302 can be structured to conduct pattern matching based on these specifications and return matched address(es) 213 as absolute address(es) to this graphic user interface (GUI).

Below is an example of standardizing set operations of information through pattern matching 409.

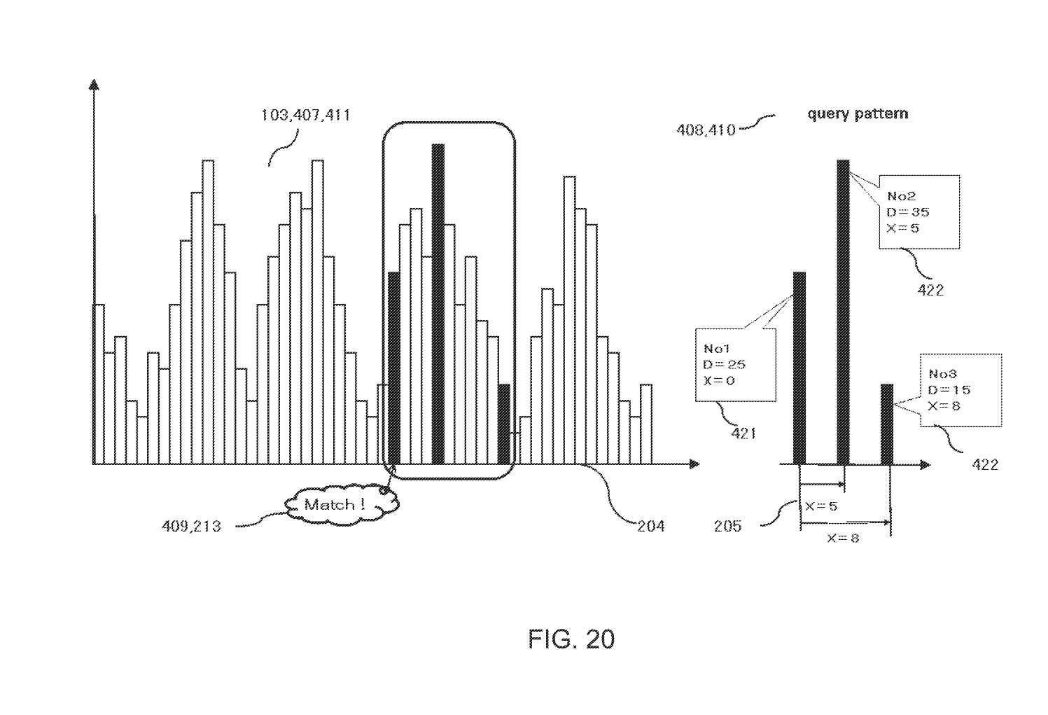

FIG. 20 depicts an example of detecting one-dimensional information.

It is a conceptual image of finding information that matches the query pattern(s) from sets of information like changes in weather or temperature, or economic trends. Standard texts are also part of this group of one-dimensional information.

The left side of the figure is the database 407, or the whole set 103. It is a set 102 of information elements 105 in which absolute addresses 204 are recorded as arrays and the data arrays 411 are defined.

On the other hand, the query pattern 408 shown on the right side of the figure is the pattern of the information that we would like to find, composed of a few sampling points 410. Each of these sampling points 401 form query pattern(s) 401 based on a set of base information 421, specifying the relationship between the data and its location, and match information 422.

While there is only one kind of base information 421, there may be as many match information 422 as needed.

As shown in the figure, the data value (the D value in the figure) and relative distance to the base information 421, in this case the absolute address 205 (the X value in the figure), are specified for each information.

Based on the above query pattern(s) 408, pattern-matching 409 is conducted using the memory having information refinement detection functions' method for finding the information that coincides 116 with the specified information (data) as well as its method for finding the location(s) 114 of the information (data). The matched address(es) 213 are output as absolute address(es) 204.

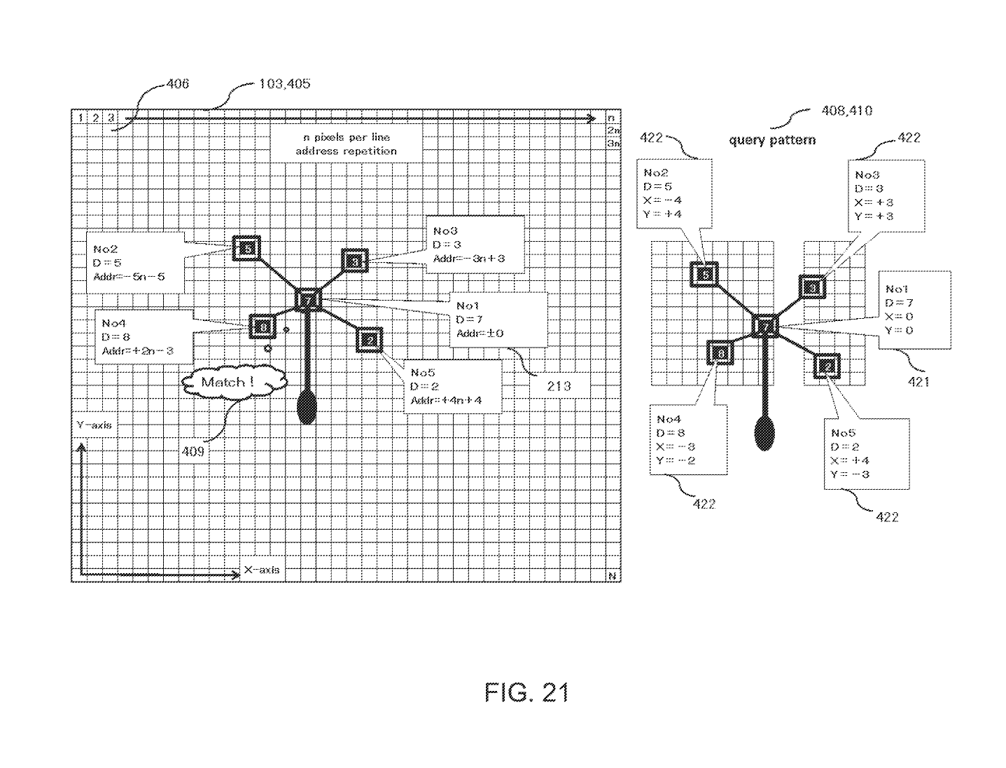

FIG. 21 depicts an example of two-dimensional information detection.

This figure is a conceptual image of finding information that coincides (matches) with the query pattern(s) from information sets like images, in other words two-dimensional information. The contents of this figure are the same as for FIG. 20.

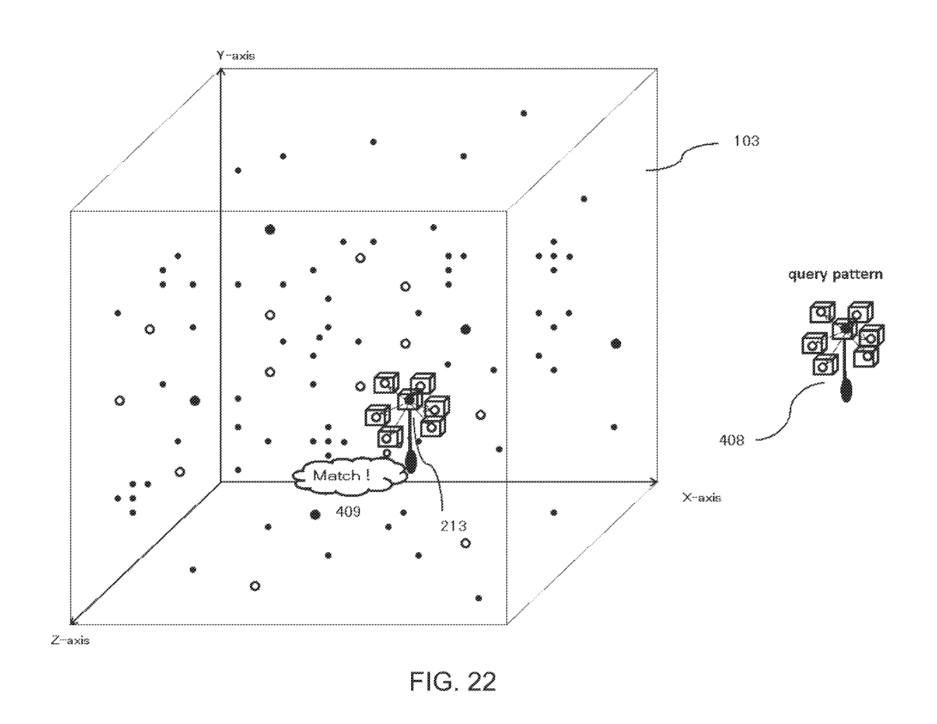

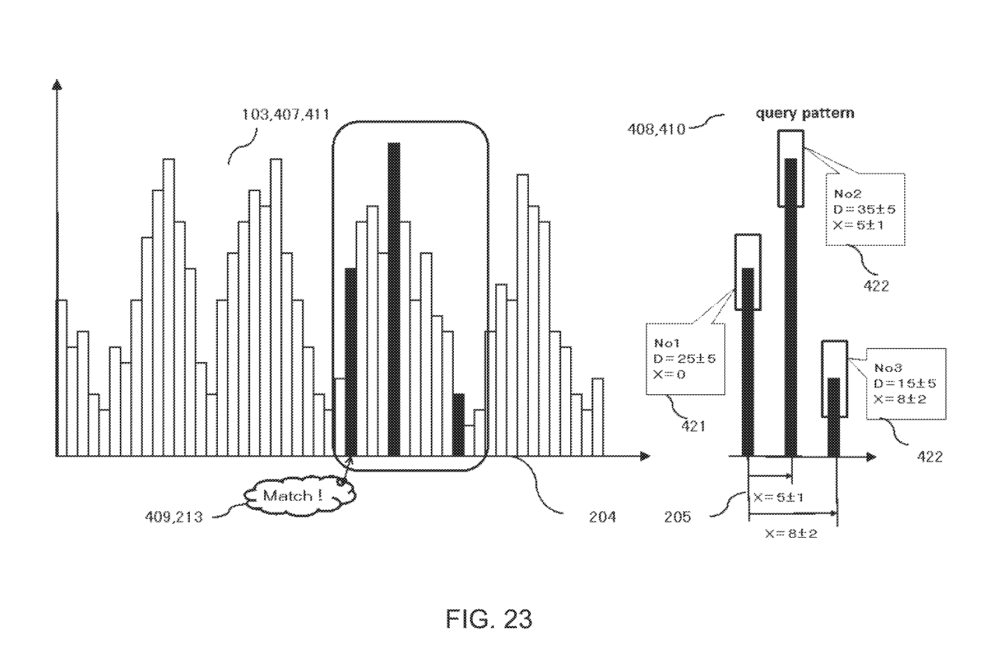

FIG. 22 depicts an example of three-dimensional information detection.
It is a conceptual image showing how information that coincides (matches) with the query pattern(s) 408 are found from sets of information like molecules or constellations, in other words, from three-dimensional information. The image description is the same as for FIG. 20. FIG. 23 depicts ambiguous detection for one-dimensional information.
It is a conceptual image for ambiguous pattern matching 418, finding matches for ambiguous query information from one-dimensional information as depicted in FIG. 20.

As shown in the figure, ranges 413 are specified for the information data and areas 107 are specified for the information locations.

Some examples for which the above pattern matching is best fit include: detecting changes in stock price patterns, temperature change patterns, or phoneme patterns in voice recognition.

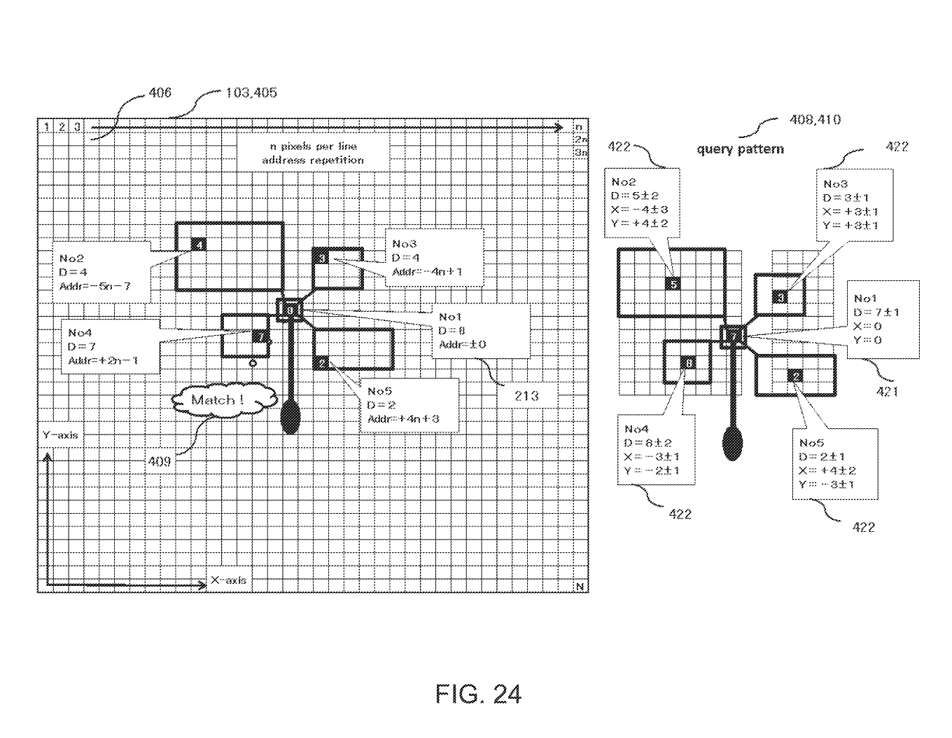

FIG. 24 depicts an example of ambiguous detection for two-dimensional information.

It is a conceptual image of ambiguous pattern matching 418 for finding coincidences (matches) for the ambiguous query pattern(s) from two-dimensional information as shown in FIG. 21.

Some examples for which the above pattern matching is best fit include: detecting the positions of human faces, detecting non-face places at high-speeds or speedily reading car license plate numbers.

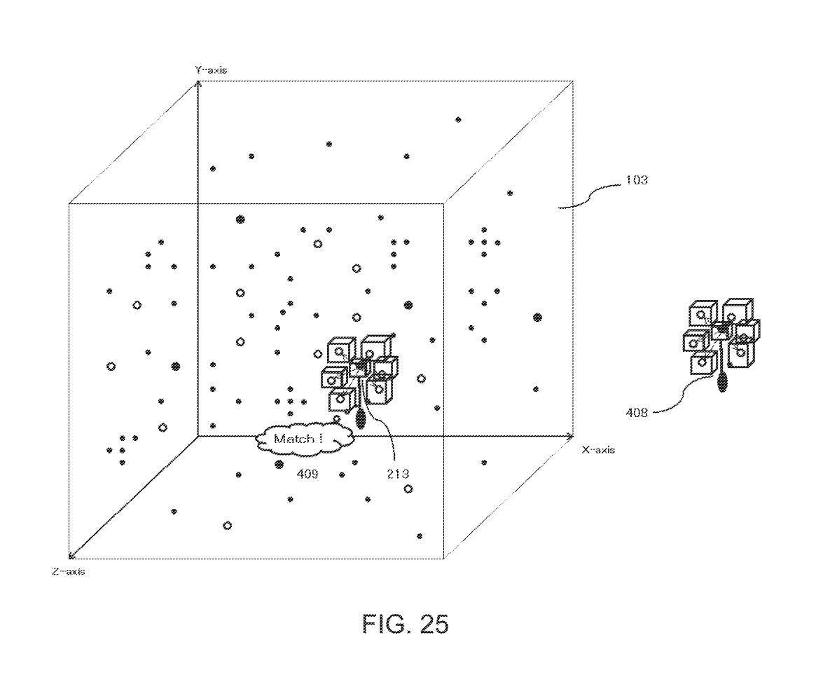

FIG. 25 depicts an example of ambiguous detection for three-dimensional data.

It is a conceptual image of ambiguous pattern matching 418 for finding coincidences (matches) for ambiguous query pattern(s) from three-dimensional information as shown in FIG. 22.

Some examples for which the above pattern matching is best fit include: the identification of molecular structures, identification of constellations in space and analysis of climate data.

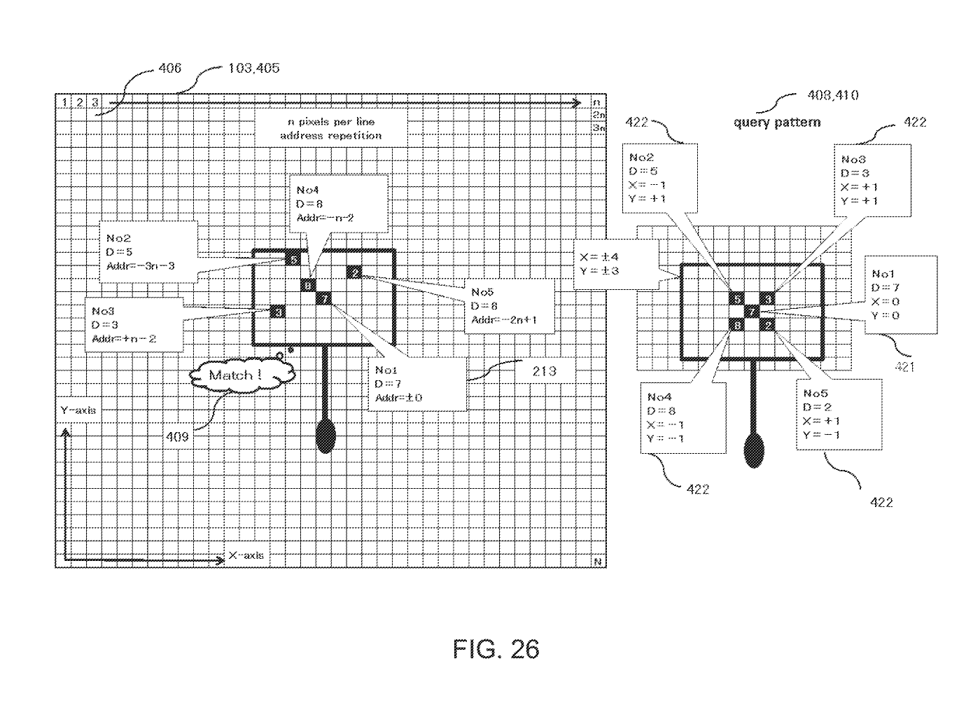

FIG. 26 depicts a second example of ambiguous pattern matching for two-dimensional information.

This figure is an extended version of the concept of ambiguous detection for two-dimensional data as shown in FIG. 24.
As shown in the figure, whether or not the subject information is at any of the locations 114 within the area is detected.

Pattern detection following such concepts largely expands upon the concept of information locations 114 in pattern matching 409, and brings to mind mathematical set operations 115.

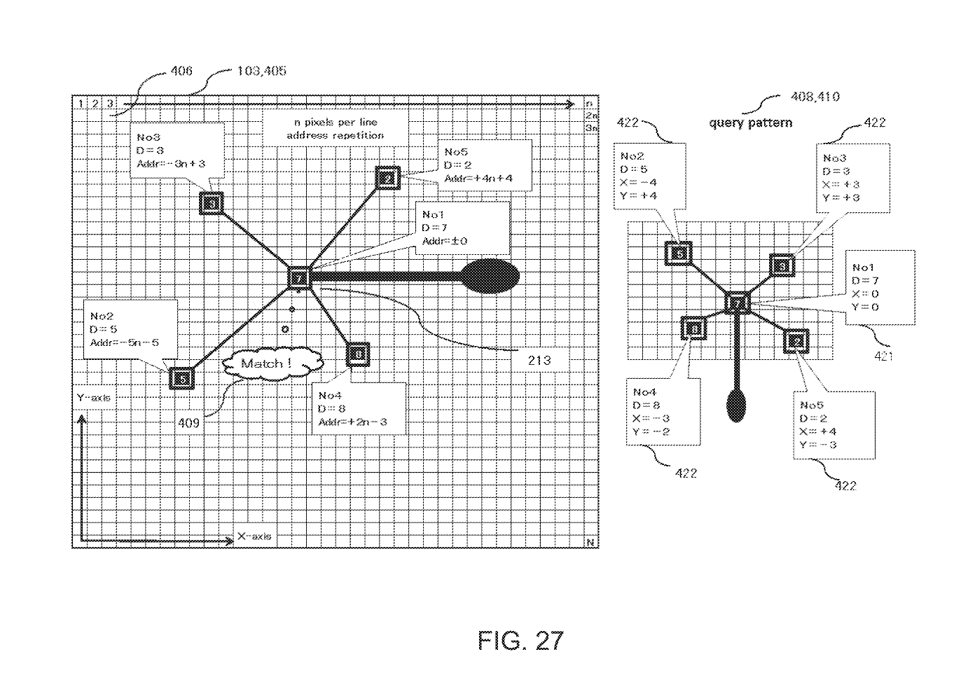

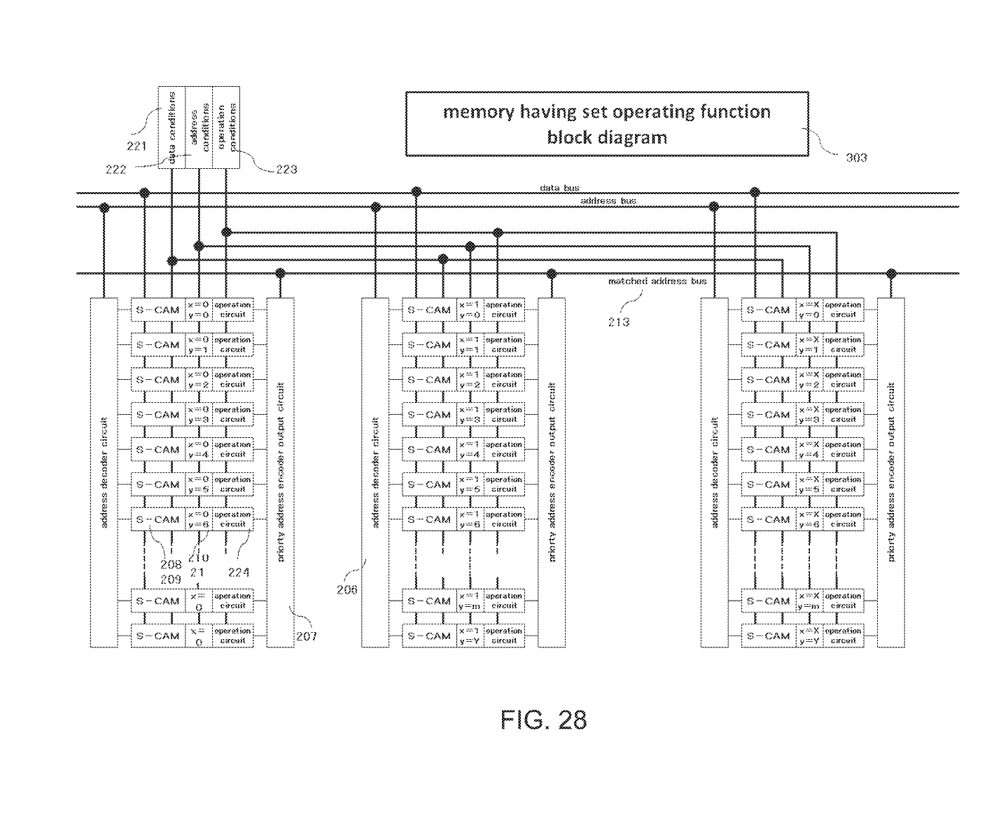

FIG. 27 depicts an example of coordinate transformation for two-dimensional information.

The figure is an example of coordinate transformation 428 on information locations 114 during pattern matching.

As shown in the figure, by enlarging, shrinking or rotating the coordinates, pattern matching 409 can be effectively conducted even if the image is rotated or its size changes.

What is especially important in the above description is that the pattern 401 is a combination of information (data) values 117 and their locations 114. Furthermore, another important point is that, probabilistically, sufficient refinement is possible even with a small number of sampling points 410, and specific addresses can be extracted. This kind of thinking can therefore be applied to various kinds of recognition technologies.

As can be understood from the above explanation, pattern matching 409 is possible for any kind of information in which all of the information arrays are defined, and all of the data arrays 411 can standardize or generalize information processing through pattern matching 409, or set operations of information.

A few tests were made regarding how much time the above pattern matching 409 would take for software-based information processing 101 using the conventional CPU.

Of course, these tests relied only on the natural power of the CPU, without using any special algorithms or hardware.

### (Time Required for Pattern Matching Using the CPU)

As one of these tests, pattern matching was conducted by a high-speed computer on a two-dimensionally arrayed 640×480 pixel image (BMP format) using one set of five sampling points 410.

114 m seconds were required for a complete match.

Furthermore, when ambiguous pattern matching was conducted for a set of five points, the processing time surpassed 11 seconds.

Ambiguous pattern matching, in other words pattern matching that includes information (data) areas 415, is a combined vector operation between information.

As is commonly understood, combined operations require an enormous amount of processing time.

When the areas of ambiguous pattern matching are further extended, the combinations explode and minutes, or even more time, will be required.

However, ambiguous pattern matching with area information is an indispensable technology for image recognition and other purposes.

The above examples illustrate that, while pattern matching is an indispensable technology for information recognition, it could not be implemented for large sizes of information such as images.

Because the highly important method of pattern matching, at the very core of recognition, could not be implemented due to the above factors, other, more complex and specialized recognition methods currently have had to be relied upon.

For instance, in most image processing, edges and areas are detected through analog processes or by converting the image space into frequency component data using Fourier transformations as one-dimensional processes for recognition processing.

For this reason, a great amount of time is required for the transformations and processing. And, while many of these recognition methods are effective under certain photography or lighting conditions, it is not rare to find that they cannot be used in other conditions.

The above is one of the greatest reasons why the current computer's recognition level, in human terms, still remains at baby level, even 66 years after its birth.

### (Time Required for Pattern Matching Using Collective (“Lump-Sum”) Operations on the Whole Set)

Even though research on memory having information refinement detection functions 302 has heretofore mainly used FPGA and pattern matching has been based on circuit compositions with insufficient resources, ambiguous pattern matching for one set of five points has been realized in under 1 m second with this memory.

Based on these results, it has further been logically confirmed that, by switching to ASIC, ambiguous pattern matching can be conducted in a few μ seconds, making even higher speeds possible.

This is over a million times faster than pattern matching using the CPU.

This is the definitive difference between the current CPU's information processing based on elements 105 in the set and the memory having information refinement detection functions' 302 collective, or “lump-sum,” pattern matching 409 on the whole set.

In general, videos consist of thirty continuous still photos per second, with each photo taking up 33 m seconds.

If we say that ambiguous pattern matching for one set of five points takes 5μ seconds each time, pattern matching 409 can be conducted 6,600 times within this 33 m seconds.

In one second, pattern matching 409 can be conducted 200,000 times.

In other words, by preparing query patterns 408 for various objects, texts and voices that we want to recognize as templates, we can instantly detect the objects, texts and voices that we want to recognize from the video.

Furthermore, by defining sampling points 410 in an unplanned fashion within localized image spaces and extracting this data, this sampling data can be set as query pattern(s) 408.

This kind of pattern matching is best suited for the recognition of moving objects or pattern matching 409 for stereoscopic views.

If an equivalent speed and performance is to be realized using the CPU, there is no other solution but to use specialized software algorithms and rely upon a large number of CPUs (in parallel).

It follows that one of the greatest challenges for the current CPU is the enlarged size of the device itself as well as the power consumed.

As one example of this, an intelligent camera contains a CPU that is several tens of watts in class.

In such cameras, the camera enclosure becomes a heat sink and the large size of the camera cannot be lightened.

Because ultra-high speed, highly precise recognition can be realized by using memory having information refinement detection functions 302, the CPU will not have to be such high performance.

The following is largely significant for portable battery devices.

### (An Example of Memory Having a Set Operation Circuit in Addition to Data Comparison and Address Comparison Circuits)

The fact that pattern matching 409 is an extremely effective method for information processing 101, as well as the fact that memory having information refinement detection functions 302 is effective for pattern matching 409 information, one of the weaknesses of the CPU's information processing, has been explained from various perspectives above.

Pattern matching, to begin with, is based on the fact that the physical structure of the memory itself is composed of only the two factors of addresses and memory cells. It is thus none other than the specification of what address(es) the pattern(s) recorded on the memory are at and, on the other hand, what pattern(s) are at the specified address(es).

By expanding the concept of pattern matching 409 and memory having information refinement detection functions 302 as noted above, the memory-based processor that can operate any set of information can be advanced in the following way.

The highest concept of pattern matching 409 is set operations 115. This must first be focused upon.

Information necessary for pattern matching was previously refined by set operating 115 based on the logical AND 110 of the subsets. By further developing this idea and adding functions necessary to set operations 115—such as logical OR 109, logical negation 111 and a function for combining these operations—set operations 115 that have hitherto relied upon the CPU and its operations based on individual information, or the elements 105 on the memory, will no longer need to rely on the CPU. As with mathematical set operations 115, this processor will be able to realize set operations of information sets 102 on the memory at high-speeds, high accuracy and low power, furthermore, through extremely simple operations.

FIG. 28 is an example of a block diagram regarding the embodiment of the present invention.

As shown in the figure, the memory having set operating functions 303 replaces the match counter 212 from the memory having information refinement detection functions 302 with operation circuits 224. It is structured so that it can realize any operation like logical OR 109, logical AND 110 and logical negation 111, based on logical operation conditions 223 assigned from outside sources, at the specified conditions.

In other words, while memory having information refinement detection functions 302 mainly conducted logical AND 110 set operations 115 using the counter and was for set operations 115 conducted by refining the target information for pattern matching 409, by further advancing this idea, memory having set operating functions 303 was able to be structured to realize any kind of set operation 115 on any kind of information.

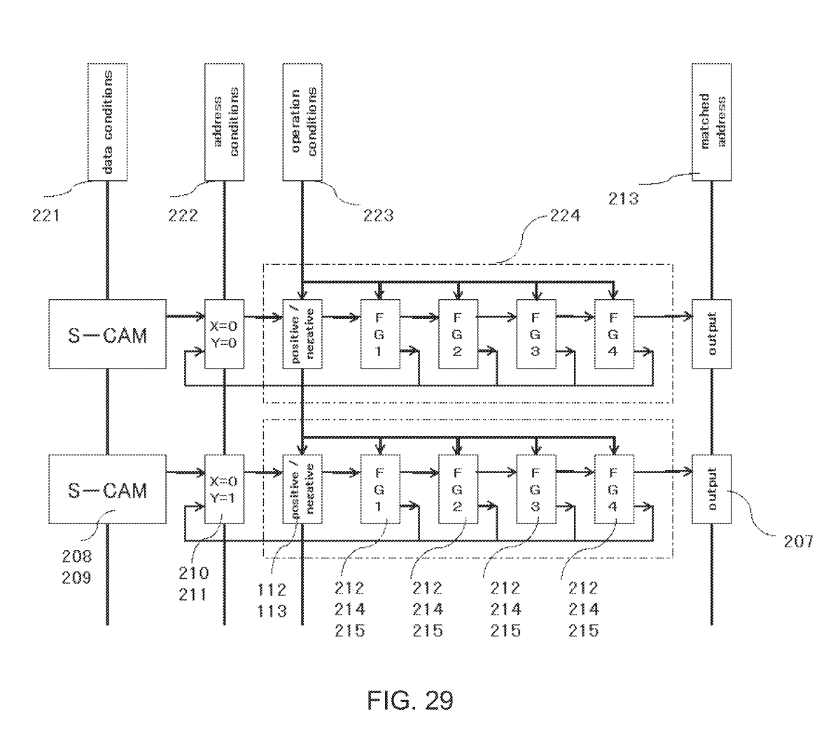

FIG. 29 is an example of a detailed block diagram for the above memory having set operating functions.

This memory is structured to output matched address(es) 213 from the operation results of: circuits 208, 209 for comparing data based on data conditions 221 assigned from outside sources (refer to above explanation for the detailed composition); circuits 210, 211 for comparing addresses based on address conditions 222 assigned from outside sources (refer to above explanation for the detailed composition); logical operation conditions 223 assigned from outside sources; circuits 224 for logical operations based on the above conditions; and priority address encoders 207.

The operation circuits 224 are composed of circuits for transforming positive logic 112 and negative logic 113 and more than one tournament flag 214 or range tournament flag 215. It is structured so that the output flag(s) from the Content-Addressable Memory (CAM) 301 are output by connecting to the priority address encoder(s) 207 through the tournament flag(s) 214 or range tournament flag(s) 215, based on conditions specified by the address conditions 222 and logical operation conditions 223.

The tournament flag(s) 214 or area tournament flag(s) 215 form a cascade connection of flags. They can be used as match counters 212, in other words, as a counter component as in the prior memory having information refinement detection functions 302.

At the same time, the output(s) from the tournament flag(s) 214 or area tournament flag(s) 215 are added on to the inputs for address comparison circuits 210 and 211 and can be logically operated again and again in parallel based on the specifications of logical operation conditions 223.

From the above composition, address(es) that coincide 116 with the conditions are detected in parallel, by working the Content-Addressable Memory (CAM) 301 functions through the data range comparison circuits 209 and data comparison circuits 208 based on data conditions 221 assigned from outside sources. At the same time, the locations 114, in other words address positions 105 and areas 107, for the relative and absolute addresses are specified in parallel using the address comparison circuits 210 and address area comparison circuits 211 based on address conditions 222 assigned from outside sources. Based on the logical operation conditions 223 and circuits 224 for operating the above results, any kind of set operation 115—for instance logical OR 109, logical AND 110, logical negation 111, or any combination of these, and furthermore set operations 115 with past operation results—can be conducted in parallel and its result(s) output as the matched address(es) 213 through the priority address encoders 207.

The above set operation 115 is for collectively (“lump-sum”) operating sets of information on the memory, instead of set operating 115 based on the elements 105 of the memory.

With such a set operation 115 method, this memory can be realized by a circuit composition that would typically be only for controlling two flags per address. And this enables the memory having set operating functions 303 to have a circuit composition that is extremely simple and a large-scale information processing capacity.

While studies on various devices applying Content-Addressable Memory (CAM) 301 have been conducted thus far, operations between memory addresses had resulted in large-scale circuits and, for parallel processing, devices with large address spaces could not be realized.

Because parallel operations of memory addresses 216 similar to changing the address positions of the Content-Addressable Memory (CAM) 301 output flags can be realized by an extremely simple circuit composition, the load based on circuit composition can be lessened to a great degree.

### (An Example of Literature Searches)

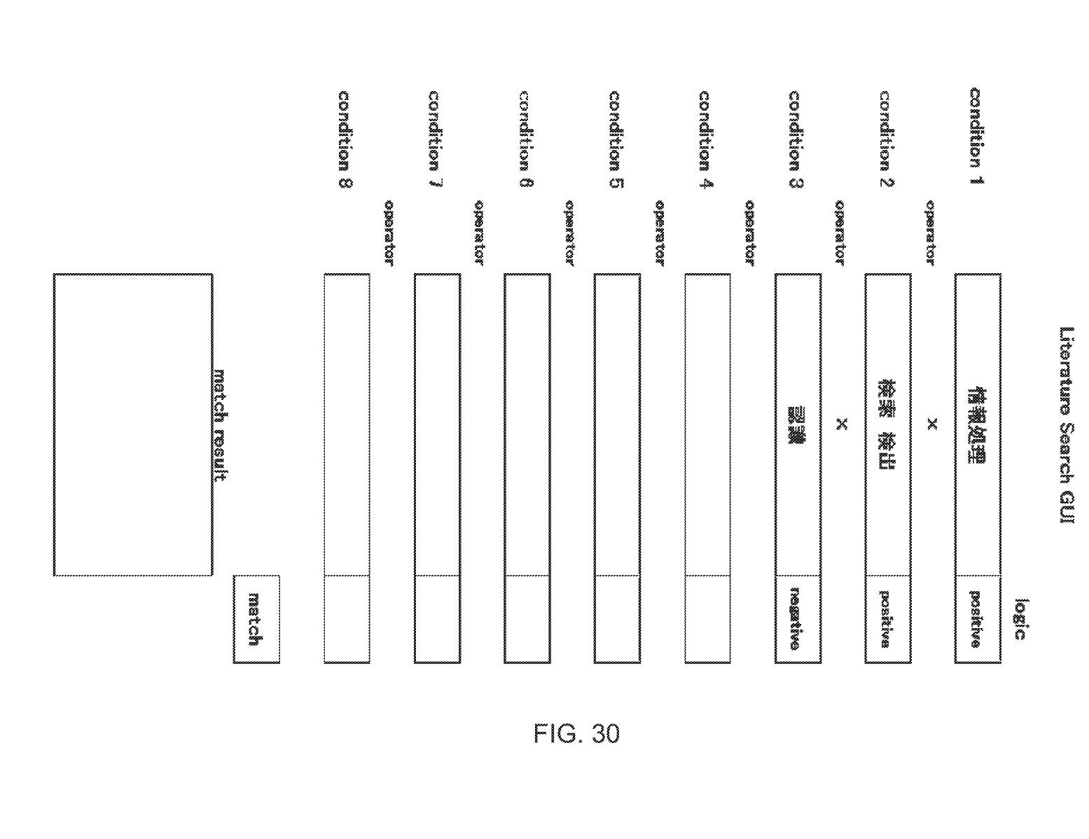

FIG. 30 depicts a sample graphic user interface for literature searches.

This figure shows an outline of a graphic user interface for conducting full text searches, such as patent information searches, using memory having set operating functions 303.

In this example there are eight operation conditions, from Condition 1 to Condition 8. Keyword characters are specified within each condition, and the operator, positive logic 112 and negative logic 113 are specified. Here, in this GUI, the operator is structured so that (1) subset, (2) logical ORs, (3) logical ANDs, (4) logical negations, or a combination of two or more of these are selectable for specification.

In this example, subsets of the text array ( [symbol] , [symbol] , [symbol] , [symbol] ) and subsets of the text array ( [symbol] “ken saku”+ [symbol] “ken syutsu”) are determined through the positive logic of logical AND and, on these operation results, the literature coinciding with the negative logic of logical OR for the text array ( [symbol] “nin shiki” (recognize)) is found.

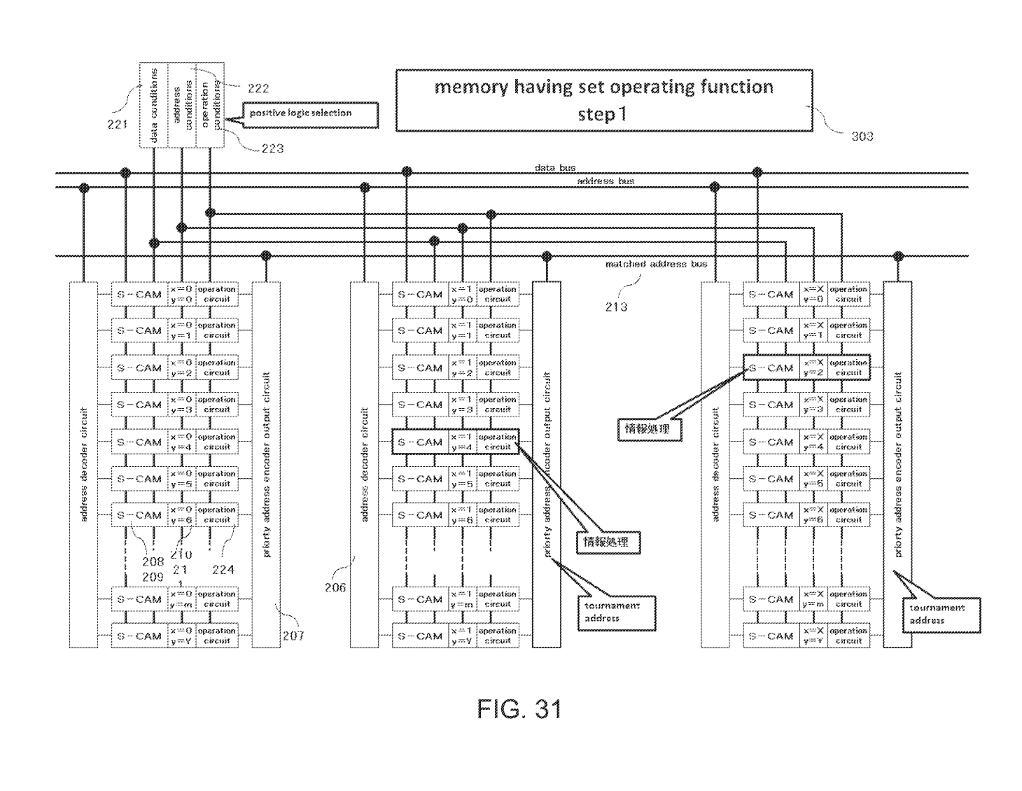

FIGS. 31 to 34 show an example of set operations using memory having set operating functions.

As an example of the above literature search, the multiple subject literature is first recorded on the memory having set operating functions 303.

While a large number of literature can actually be recorded, in order to more readily explain the functions, the literature recorded on the address group on the left of the figure, the address group in the center of the figure and the address group on the right of the figure will be expressed as left literature, center literature and right literature respectively (each of them will be one piece of literature).

FIG. 31 shows the remaining (tournament) address and the subject literature after conducting logical AND set operations on the text array ( [symbol] jyo ho syo ri (information processing)). (The logical AND 110 set operation for ( [symbol] ) has already been conducted in this description referring to FIG. 6.) Here, the “ [symbol] ”, “ [symbol] ”, “ [symbol] ” and “ [symbol] ” correspond to the invention's “Input 1,” and the positional relationship between “ [symbol] ”, “ [symbol] ”, “ [symbol] ” and “ [symbol] ” corresponds to “Input 2.” At the same time, the selection of the above operators and the specification of either positive/negative logic correspond to “Input 3.”

As explained in FIG. 6, the text array is first determined by logical AND 110 operations including information locations 114. One matched address 213 exists in each of the center and right literatures. The priority address encoders 207 for these center and right literatures remain (tournament).

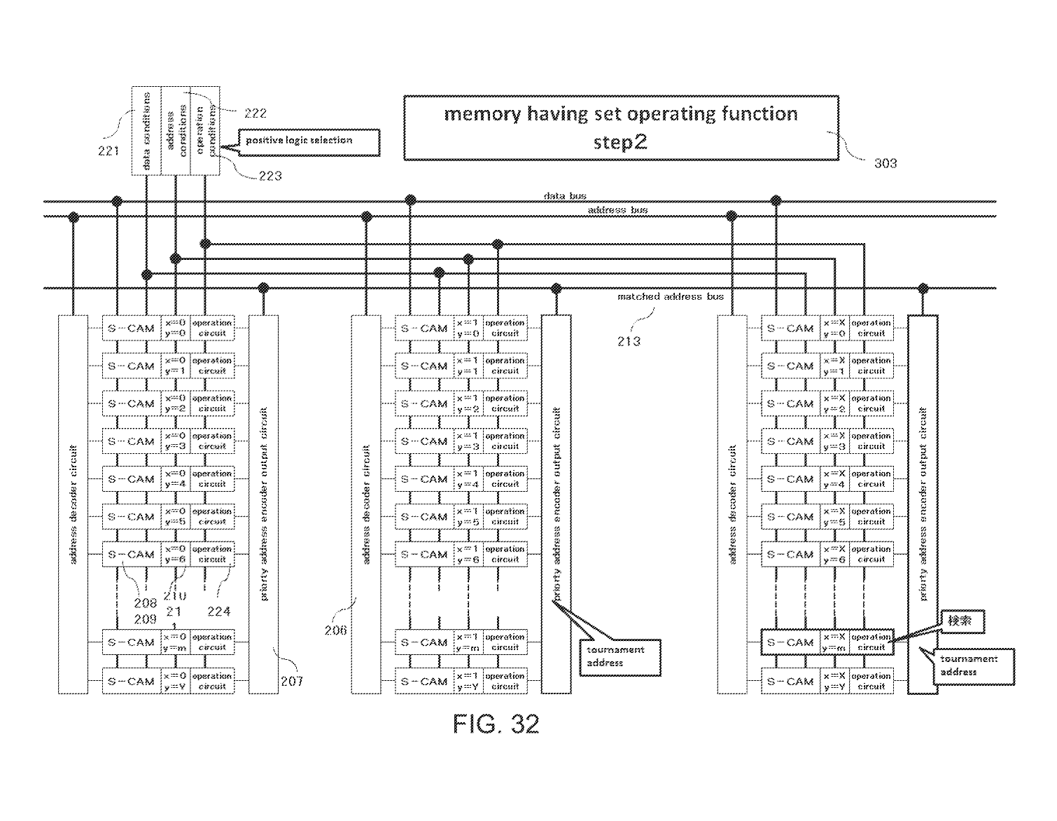

In FIG. 32 logical AND 110 set operations are conducted on the text array ( [symbol] “ken saku” (search)). One matched address 213 exists in the right literature, and the priority address encoder 207 for this right literature remains (tournament).

In this case, because logical OR 109 operations continue afterwards, the priority address encoder output 207 for the center literature also remains (tournament).

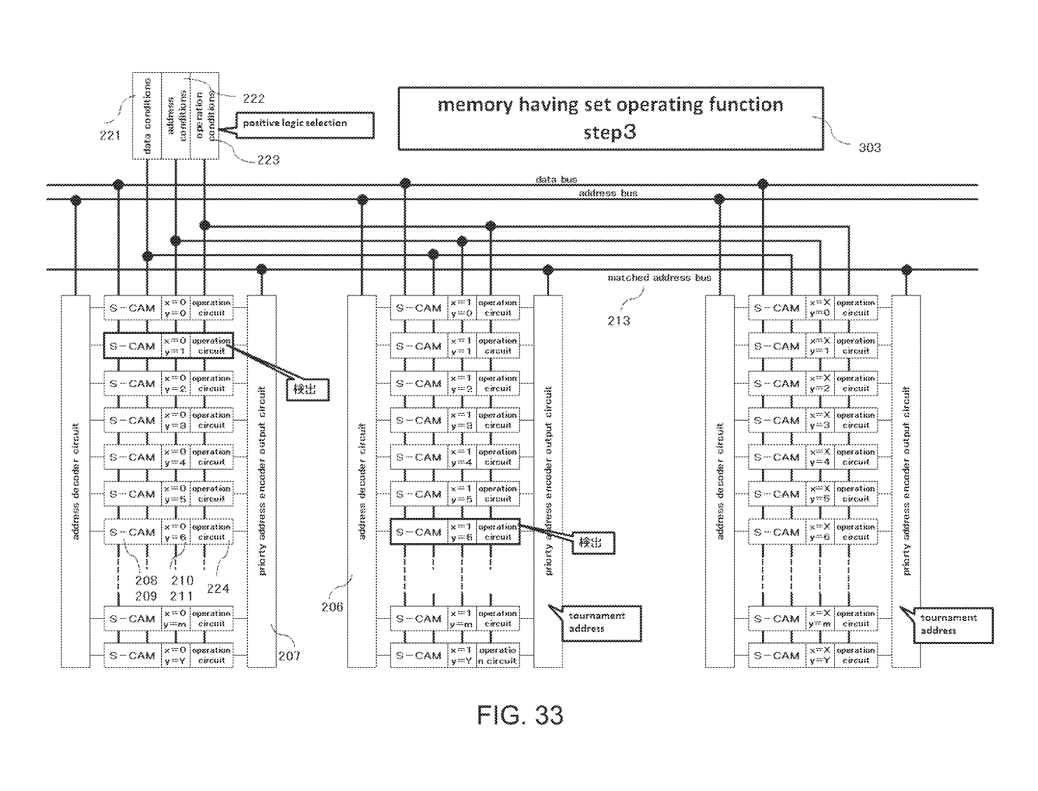

In FIG. 33 logical AND 110 set operations are conducted on the text array ( [symbol] “ken syutsu” (detect)). One matched address 213 remains in each of the left and center literatures.

At this point, because the priority address encoder 207 for the left literature has already fallen out (of the tournament), it is ignored.

The priority address encoder 207 for the center literature remains (tournament) and lives on.

Of course, the priority address encoder 207 for the right literature also continues to remain (tournament).

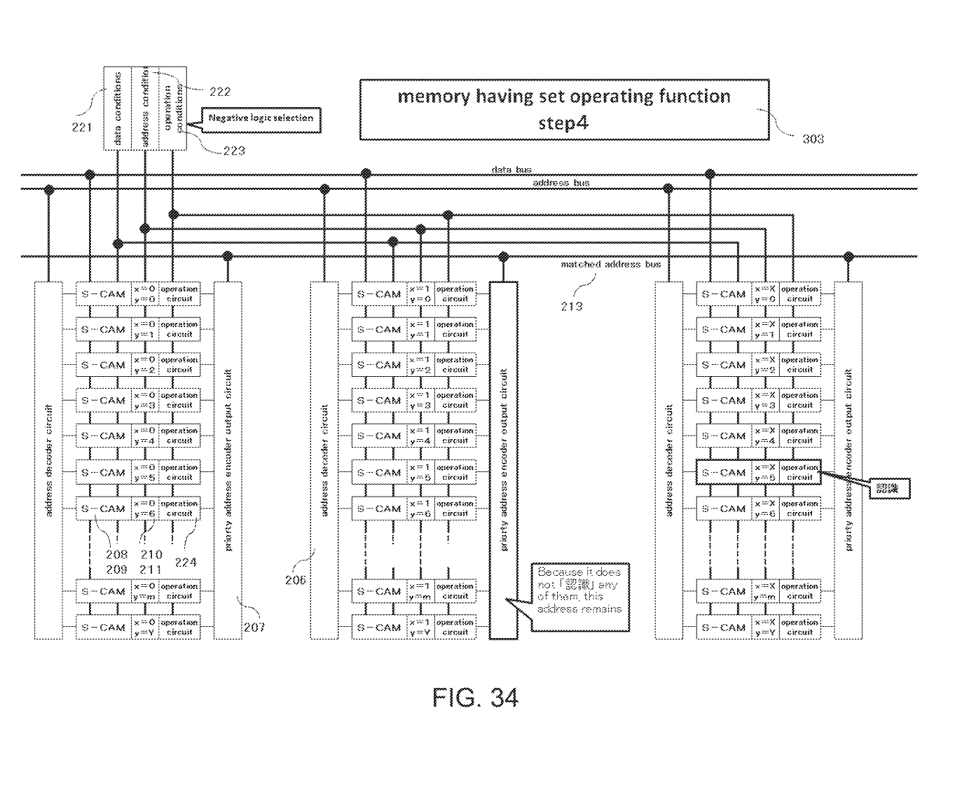

FIG. 34 depicts an example where logical AND 110 set operations for the text array ( [symbol] “nin shiki” (recognize)) are conducted, and one matched address 213 exists in the right literature.

In this case, if the specification of logical operation conditions 223 is negative logic 113, the priority address encoder 207 for the right literature falls out of the running and the center literature, in which no match address 213 exists for the logical AND 110 operations on the text array ( [symbol] “nin shiki” (recognize)), becomes the remaining literature (tournament) at the end.

The above set operations (multiple set operations) can be appropriately realized through the logical circuits 224 shown in FIG. 29, based on logical operation conditions 223 assigned from outside sources.

In this example, set operations on the entire address space of the memory having set operating functions 303 are conducted collectively (“lump-sum”). However, it goes without saying that set operations specifying a partial area can also be conducted.

For instance, if the set information consisted of 1M addresses (1 million addresses), the CPU would require several m seconds to conduct just a single scan. If there were further a vector operation including a range, in other words a combined operation, it would trigger a combined explosion. And, as explained above, an extremely great amount of time would be necessary for such information processing.

Because memory having set operating functions 303 would enable set operations for 1M addresses or 100 clocks, in set operations like the present example, the entire set operation can be completed in under 1μ seconds, even for 10 n second clocks in which heat is not a problem.

This, of course, also works to greatly reduce the power necessary for conducting this operation.

If a thesaurus-like idea could be incorporated into patent searches, the users' work would be greatly reduced, and furthermore, accurate patent searches, with nothing left unnoticed, would become possible.

While this example targets one-dimensional arrays of information, memory having set operating functions 303 can be used for two-dimensional and three-dimensional arrays as well as all types of information with defined arrays, as can be seen from the above pattern matching examples.

For this, the information data array 411 can simply be made specifiable as shown in FIG. 19 (this corresponds to “Input 4” in the present invention).

If the above kinds of set operations can be freely conducted, the abovementioned pattern matching concepts can be further extended to allow for even higher-grade, effective pattern matching.

For instance, this would allow for exclusive pattern matching 427 using exclusive data 426, based on the use of logical negation.

Another example is, if all the expected information exists within a particular address area, rather than serially outputting all the matched addresses 213, set operations can be conducted with the complement of the expected information, in other words exclusive data 426. Confirming that no matched address 213 exists in these results (reading the matched addresses), in other words conducting an exclusive pattern match 427, would reduce later process loads.

### (An Example of Edge Detection)

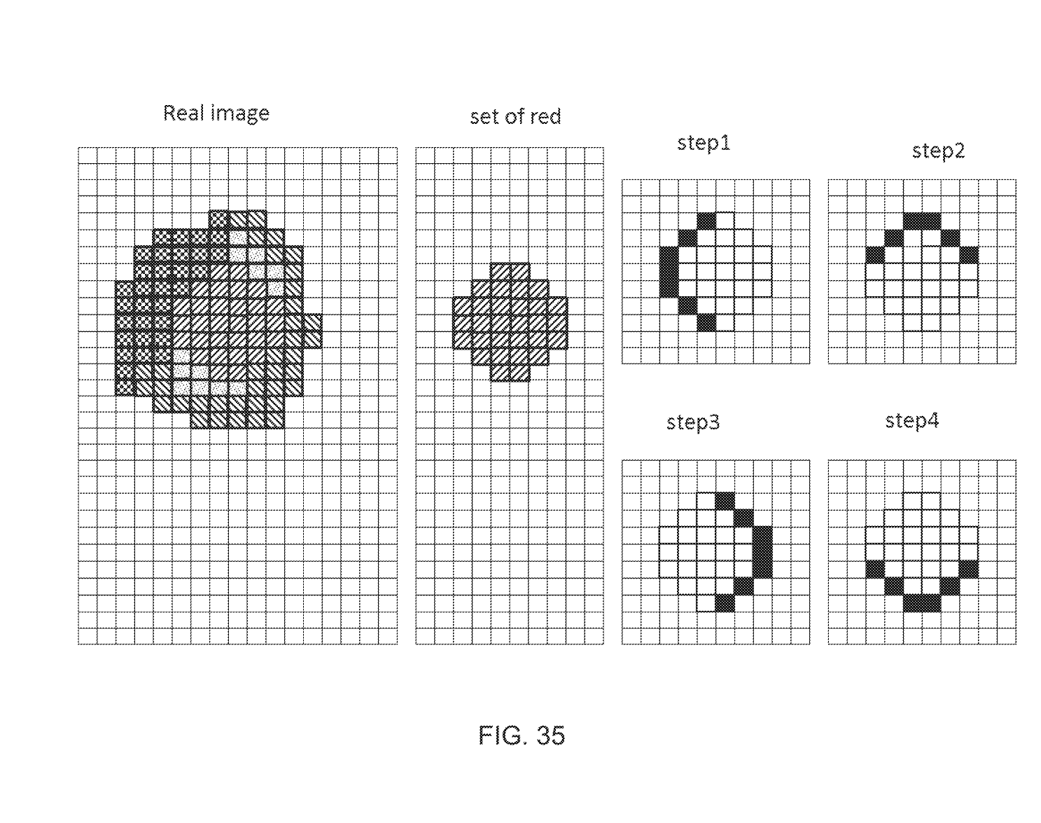

FIG. 35 depicts an example of edge detection using memory having set operating functions.

This example shows an effective use of exclusive pattern matching 427 using logical negation 111.

The actual image shown in the figure represents an image 405 set 102, in which black, blue, green, white and red pixels 406 are combined in a complex form. The set of red 102 has been determined by set operations 115 on values 117 for only the red pixels 102. In this example, the red pixels are in a spherical form and have a certain area formed by the same pixels. At the same time, it goes without saying that black, blue, green and white pixels can be found neighboring this sphere in a complex fashion. In this case, edge detection using exclusive pattern matching 427 based on the abovementioned exclusive data 426 is effective.

In Step 1, the base information 421 is set as the red pixels and the left edge of the sphere is detected as the matched addresses 213 by exclusive pattern matching 427 based on the condition that the pixels to the left of the base information 421 (X=−1, Y=0) are pixels other than red (logical negation 111 of red). Through this exclusive pattern matching, the red pixels (red pixels in the area) on the right edge are ignored.

In Step 2, the base information 421 is set as the red pixels and the right edge of the sphere is detected as the matched addresses 213 by exclusive pattern matching 427 based on the condition that the pixels to the right of the base information 421 (X=+1, Y=0) are pixels other than red (logical negation 111 of red). Through this exclusive pattern matching, the red pixels (red pixels in the area) on the left edge are ignored.

Step 3 sets base information 421 as the red pixels and detects the right edge of the sphere as the matched address 213 by exclusive pattern matching 427 based on the condition that the pixels above base information 421 (X=0, Y=+1) are pixels other than red (logical negation 111 of red). Through this exclusive pattern matching, the red pixels (red pixels within the area) at the bottom edge are ignored.

In Step 4, the base information 421 is set as the red pixels and the bottom edge of the sphere is detected as the matched addresses 213 by exclusive pattern matching 427 based on the condition that the pixels to the bottom of the base information 421 (X=0, Y=−1) are pixels other than red (logical negation 111 of red). Through this exclusive pattern matching, the red pixels (red pixels in the area) on the top edge are ignored.

By combining the above steps 1 to 4, the edge addresses for the entire image can be procured.

If there is a need to conduct an even higher-level edge detection, red can be set as the base and conditions like top left, top right, bottom left and bottom right can be input to conduct exclusive pattern matching with a few pixel gaps for ignoring noise above the image, much like using the conventional filter effect.

Of course, object specification can be made even easier by targeting not only complete matches, value ranges or single colors but also multiple colors and brightnesses. In any case, the ability of the memory to directly detect only the edge addresses without targeting all the addresses in the area not only reduces the load of edge detection but also contributes to largely reducing the load of later processes as well.

As described above, an object's shape can be recognized by the extremely simple set operation of edge detection.

It goes without saying that this edge detection can be conducted on the entire image space, and it does not matter whether the object area is wide or what form it is in.

If the edge address can be detected, the object size and center of gravity can be determined to specify the object, and the object's movements can be followed in an extremely simple way based on the edge.

As described above, because a few clocks of set operations can realize any step of the edge detection process, effective edge detection is possible with various combinations of conditions.

From this explanation, it can be understood that edge detection is, like pattern matching, an indispensable image processing step for image recognition. Complex edge detection not only in grayscale but also in color is an image-processing tool that will largely change conventional concepts.

The above examples depict only some of the uses for memory having set operating functions 303. For large databases 407 or for even higher speeds, this memory having set operating functions 303 can be connected in parallel. In this case, one of the great characteristics of this memory having set operating functions 303 is that a performance proportional to the number of devices used can be expected.

Memory cells 202 of memory having set operating functions 303 can be realized in all types of memory, including DRAM, SRAM, ROM and FLASH, and are not limited to semiconductor memory. In cases where a certain set operation is repeated, fixed use of the logical circuits 110 is possible as well as a semi-fixed use using PLD (programmable logic devices) like the FPGA.

While this example introduced set operations fully in parallel, it is also possible to use a portion of the functions as serial processing.

At the same time, when the information location 114 set is simple, it is also possible to specify locations 114 based on the idea of virtual memory space, by conventional address setting or bank switching.

Two examples of the actual use of set operations using memory having set operating functions 303 were noted above. However, it goes without saying that, from the previous explanations, it can also be used for finding information, searching, verifying and recognizing.

When incorporating the memory having set operating functions 303 into semiconductors like the CCD and CMOS sensors and the CPU, it is also possible to conversely incorporate the CPU or other semiconductors into the memory having set operating functions 303 to conduct even higher level information processing.

Below is an explanation of other kinds of pattern matching that can be implemented using memory having the above set operation functions 303.

In all examples, this memory can records information at each memory address and the memory can read this information.

This memory is further equipped with: Input 221, or Input 1, assigned from outside sources, for comparing information recorded on each memory address; Input 222, or Input 2, for comparing between each memory address; and Input 223, or Input 3, for allowing the selection of (1) subset, (2) logical OR, (3) logical AND, (4) logical negation, or a combination of two or more of these as set operation conditions.
It is further equipped with: a method 208, 209 for comparing and judging information recorded at each address of the memory, based on Input 1; a method 210, 211 for comparing and judging between information recorded on this memory, based on Input 2; a method 224 for logically operating the results from the above Inputs 1 and 2 based on Input 3; and a method 207 for outputting the results of the set operation.

### (An Example of Image Pattern Matching)

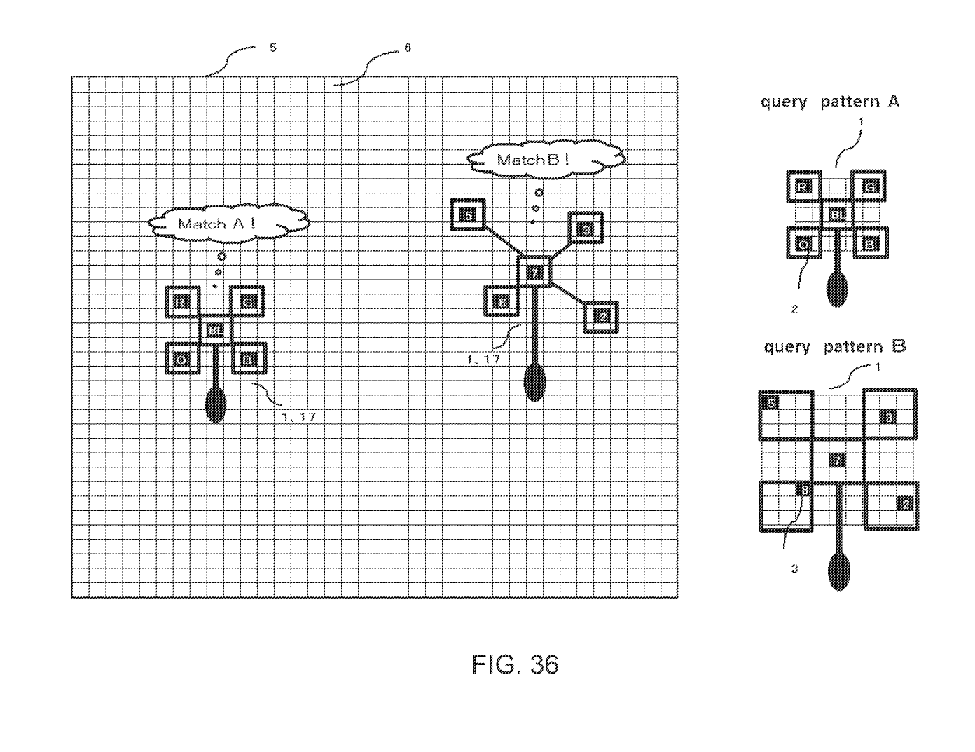

Below, an example of image pattern matching is explained referring to FIGS. 36 to 50. Please also note that, in the explanation below, the reference codes are kept as is so that its relationship to the basic application's declaration of priority can be easily understood.

FIG. 36 depicts an explanation of image patterns and image pattern matching.

The meaning of the word pattern 1 originally expressed the design of fabrics or pictures of printed materials. At the same time, this word has been widely used to express the characteristics of specific phenomena or objects. In the case of image patterns 1, these designs or pictures can be described as detailed colors and brightnesses being combined and arrayed in various positions. Temperature patterns 1 and economic patterns 1 are examples of one-dimensional information patterns, while text arrays, DNA strings and computer viruses are also examples of patterns 1. Images in general, be they still images, videos or computer graphics, are displayed/played based on image information 5 on the memory. Image information 5 and the image are like two sides of the same coin and, in this description, image information 5 is expressed simply as image 5.

The figure depicts the concept of finding the specified pattern with a dragonfly-like magnifying glass. Although abbreviated in the figure, it represents the detection of the specific pattern 1 from the entire range of image information 5 recorded on the image 5 using the dragonfly-like magnifying lens.

As shown in the figure, the pattern 1 based on the image 5 consists of a combination of color 2 information, represented by Pattern 1 A including BL (black), R (red), G (green), O (orange) and B (blue), and brightness 3 information represented by Pattern 1 B including 5, 3, 7, 8 and 2. Image pattern matching 17 works through the relative coincidences of the color and brightness data of this pattern 1 as well as the positions of its coordinates 4.

As explained above, there are three ways of composing query patterns 1: by appropriately combining colors and brightnesses as well as their positions based on human intent, by extracting specific pixels and their locations from a certain other image, or by combining these two to form the query pattern(s) 1. The details are described below.

By assigning a certain width to the color and brightness data values at this time, as in query pattern B, and by further assigning a certain range to the combination's coordinates 4 and positions, the pattern matching method 17 can be expanded from complete image pattern matching to similar (ambiguous) image pattern matching 17. The above processes, while extremely simple for a human being, are highly cumbersome for information processing centered on the current CPU and memory.

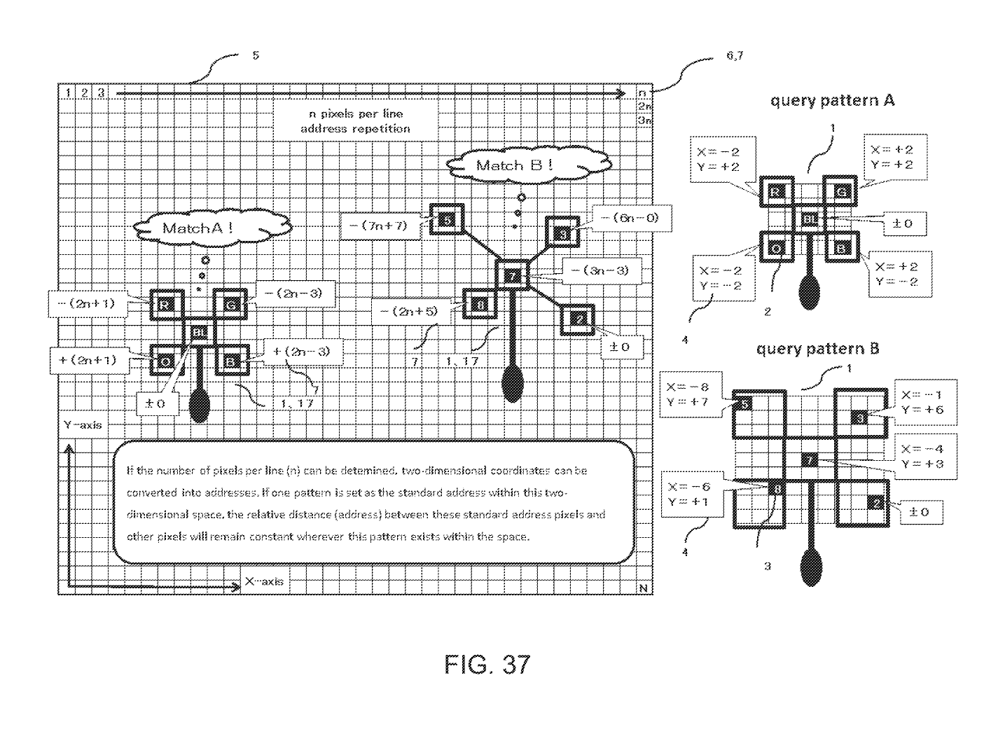

FIG. 37 explains the principle of image pattern matching using the present invention's memory having information refinement detection functions.

The image 5 is representative of two-dimensional information, handled as the two axes X and Y. In any image 5, the number of pixels 6 composing the image 5 is fixed in both the X- and Y-axes. The sum of these pixels forms the total number of pixels. In principle, the brightness 3 information and color 2 information, which consists of the three primary colors 2 that form the basis of the image 5, are retrieved in this unit of pixels 6 and recorded on the recording medium.

On the other hand, in computer memory, there are locations where the information is recorded as well as addresses 7 that specify these locations where the information is recorded. These addresses 7 are specified one-dimensionally, or in a linear array, generally in hexadecimal values from address 0 to address N. As shown in the figure, when recording two-dimensional image 5 information for each pixel 6 on the memory, lines are wrapped and repeated at the specified number of pixels (n, 2n, 3n . . . ) and written on the memory address up to address N.

Addresses are generally expressed in address 0 to address n, but in this figure it is represented as an array of pixels, from pixel 1 to pixel n, in order to give a more simplified explanation. At the same time, while this explanation assigns addresses in order from the top for the sake of explanation, there is no problem whether the addresses are assigned in order from the bottom. At the same time, while the pixels 6 composing the image 5 only record a single type of data on the memory for brightness 3 information data, for color 2 information, the three primary colors R, G and B must each be independently recorded. In general, this means there is a need to record three pixel information per pixel 6. It thus follows that, if color 2 information is recorded in three addresses per pixel 6, the actual memory would require three times as many addresses 7 as pixels 6. It goes without saying that, if we know the number of pixels 6 (n) per line, we can easily convert this to what color 2 of which pixel 6 is recorded at what location on the memory, as well as the opposite of this.

The above sequences of pixels are common not only to image frame buffer information but also to compressed image data like JPEGs and MPEGs, as well as bitmap image information, and furthermore to artificially created images like maps and animation computer graphics—in other words, it is common to all two-dimensional sequence images. It is thus a basic rule for handling general images.

The image Patterns 1 A and B shown in FIG. 37 are image patterns 1 composed of five pixels 6 and their positions, with five pattern matching conditions. Pattern 1 A has color 2 information based on BL (black), including R (red), G (green), O (orange) and B (blue), arrayed at the pixel locations shown in the figure. Pattern 1 B has brightness 3 information, based on “2,” including “5,” “3,” “7,” and “8” arrayed at the pixel locations shown in the figure. The base pixel can be any pixel within the pattern. At the same time, the number of subject pixels (pattern match conditions) can be large or small.

With technologies heretofore, it was necessary for the CPU to serially process the addresses recorded in arrays on the memory and find information based on these kinds of query patterns—in other words pattern matching using software was necessary. What this means is that, because the information process called pattern matching was largely based on the CPU's processes, it differed largely from the true nature of pattern matching.

The present invention's memory having information refinement detection functions 51 (303) is structured so that pattern matching 17 can be conducted by information processing only within the memory, achieved by directly inputting Patterns A and B as explained above. The pattern matched 17 addresses are then output, eliminating the time wasted through serial processing by the conventional CPU and memory method. Below is an introduction to these operating principles based on the above Patterns A and B.

Memory having information refinement detection functions 51 (303) is a memory that can find coincidences for the specified data and further find coincidences for the relative positions of the arrayed information. And, both the above matching processes can be conducted within the memory.

As explained heretofore, two-dimensional coordinates are converted to linear arrays of pixel 6 position information based on their positions from the base pixels 6. What should be noted here is that the relative distances between the pixels 6 of a pattern 1, composed of base pixels 6 and surrounding pixels 6, are fixed in all places within the image space. This idea forms the basis of this invention.

While the above explanation is commonly understood when handling image information, the present invention can incorporate this basic truth into hardware as a semiconductor device and proves that it can be used for pattern matching 17.

At the same time, due to the fact that each pattern 1 contains a certain number of pixels, the probability that a pattern 1, composed of multiple pixels 6 and their locations, can be located elsewhere becomes extremely low. It thus follows that not all the pixels in the pattern range have to be targeted. Rather, by selecting a suitable number of pixels 6 as samples, the specified pattern 1 can be refined and detected. Furthermore, an important characteristic of this invention is that effective pattern matching 17 can be conducted by detecting the entire pattern 1 through a combination of each part of the pattern 1.

When a subject image is enlarged or shrunken down, or furthermore, rotated, pattern matching can be conducted with a simple coordinate transformation. When the enlargement/shrinkage rates or rotation angle are unknown, the coordinate range for matching can be enlarged as in query pattern B in order to minimize the number of times pattern matching is implemented. It is first important to widen the range of coordinates to be checked and to grasp whether there is a possibility that the subject pattern exists in this range. If there is no possibility that the pattern exists, we can quit here. If the refinement is insufficient and multiple patterns 1 are matched, new pixels can be added to the sample to refine the search for finding the target pattern 1.

As can be understood from the above principles of memory having information refinement detection functions 51 (303) and its application, the greatest point of this invention is that it can realize extremely high-speed detection of the specified pattern 1 using only the hardware, without using the information processing methods of the CPU.

The speed comparison of pattern matching 17 by the conventional CPU/memory and hardware pattern matching are as described in the background technology and it is equivalent to pattern matching based on 7 conditions (in the case of images, 7 pixels) being realized in 34 nS. Even if the pattern matching time per condition for a device with address sizes and functions appropriate for images was about 1 μs, image recognition and object recognition technologies would largely advance. The details follow below.

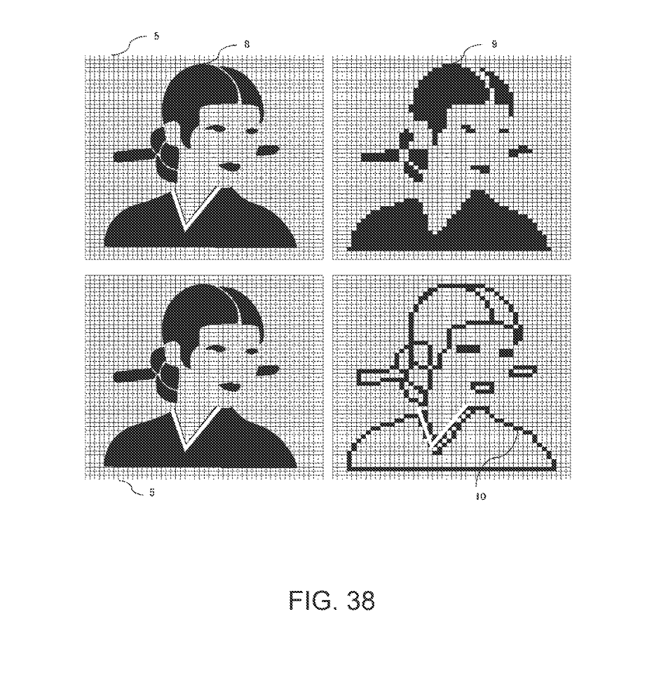

FIG. 38 depicts an explanation of areas/edges of images.

The object 8 in image 5 in the figure contains areas 9 and edges 10; and this information, extracted based on color 2 information and brightness 3 information, forms the basis of image processing.

These areas 9 and edges 10 can be processed with analog information processing and converted into high-speed digital information. However, when the CPU actually tries to find the image's characteristics based on this data, it does not know where or what kind of information, in other words edge and area information, there are. It must therefore search wherever it can and this becomes a highly burdensome kind of information processing for the CPU. Various software-processing algorithms are generally used to avoid this issue.

However, whatever software-processing algorithm it may be, it does not form a fundamental solution, and large-scale serial processing by the CPU cannot be avoided. The invented memory solves this issue.

Below is an explanation of a method to effectively pattern match the areas/edges of an image.

### Embodiment Example 1-1

An example of object recognition using the characteristics of the present invention will be explained.

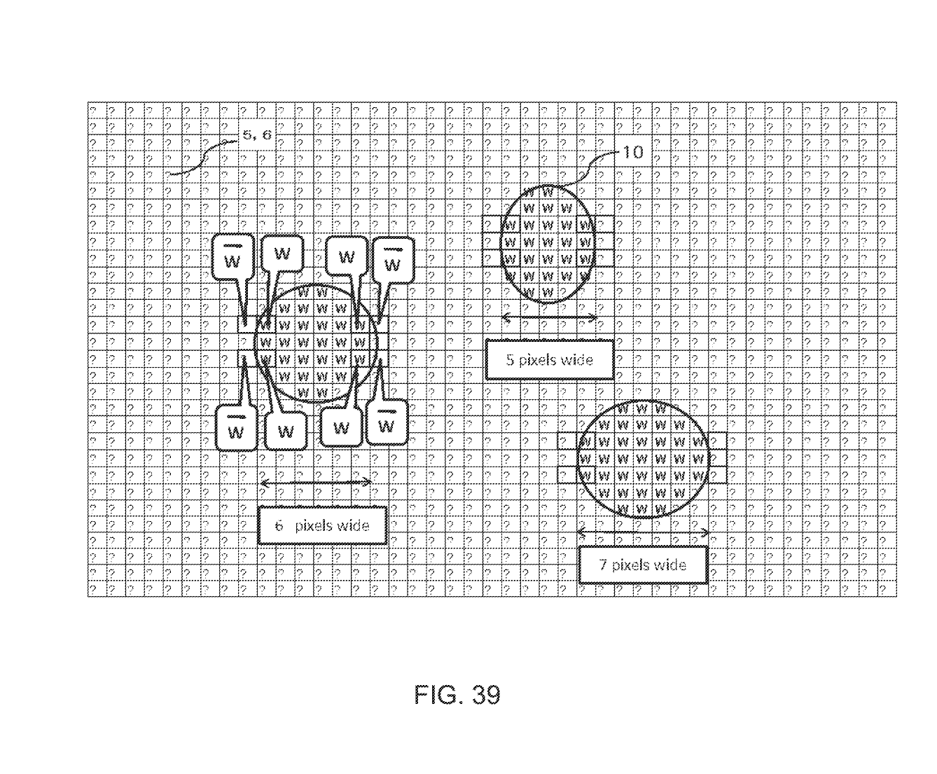

FIG. 39 is a diagram explaining exclusive pattern matching for images. It shows an example of effectively detecting an object's 8 areas and edges from the pixels 6 of the subject image information 5.

When searching for an object 8 with a specific color 2 or brightness 3 area, because there are an unlimited number to the object's possible background patterns, pattern matching 17 must be repeated the necessary amount of times for various color 2 and brightness 3 data.

What is effective in such cases is exclusive pattern matching 59 (conducting exclusive set operations as Input 3).

This example shows an image with three spherical, ball-like white (W) objects 8 in the image. The edges 10 of the four balls can be detected using the four white ranges (W) of data 54 for specifying the defined area 9 of the 6-pixel wide balls 8 and the four non-white data (W(−)) 58 externally connected to it, in other words the exclusive data for white. The edge can be detected at the boundary between (W) and (W (−)).

In other words, only the white object 8 of a specific size, in this example the white objects (balls) with 6-pixel wide areas are detected.

Because the white (W) width is excluded, be it 5-pixels wide or 7-pixels wide, an extremely precise object size detection becomes possible.

While this example conducted exclusive pattern matching 59 for six completely neighboring pixels, by leaving a defined range gap for the ranges of (W) and (W(−)), slightly different sizes of the white object 8 can also be easily detected. Because the exclusive data (W(−)) can be used for any background pixels 6 color other than white, if the eight or so pixels 6 can be pattern matched as in this example, the 6-pixel wide white ball can be found in an extremely simple way. This kind of exclusive data 58 for (W(−)) can be used on extremely simple principles in the case of memory having information refinement detection functions 51 (303) by once negating (inverting) the (W) output of the Content-Addressable Memory (CAM) function and rewriting this inverted result (W(−)) as CAM output (inverting the CAM output). This is extremely effective when there is a possibility that the background of the subject to be found is unspecified and possibly unlimited.

While this example depicts exclusive pattern matching 59 for the single color of white, complex images containing combinations of other colors can also be detected with an extremely small amount of pattern matching.

When determining an object's shape with high precision, the number of pattern matching points and their positions must simply be appropriately selected. This will allow pattern matching indispensable to recognizing a moving object and tracking it. If an object in a video gradually changes in size and shape in each frame of the video, the form of the object per frame can simply be renewed and matched with the next frame. Tracking a moving object is a technology indispensable to video devices as well as security devices.

This technology can also be widely used for handwriting recognition and fingerprints as well as pattern matching for one-dimensional information. This method of pattern matching is extremely powerful and will enable the heretofore-colossal process of image processing to become an extremely simple process.

### Embodiment Example 1-2

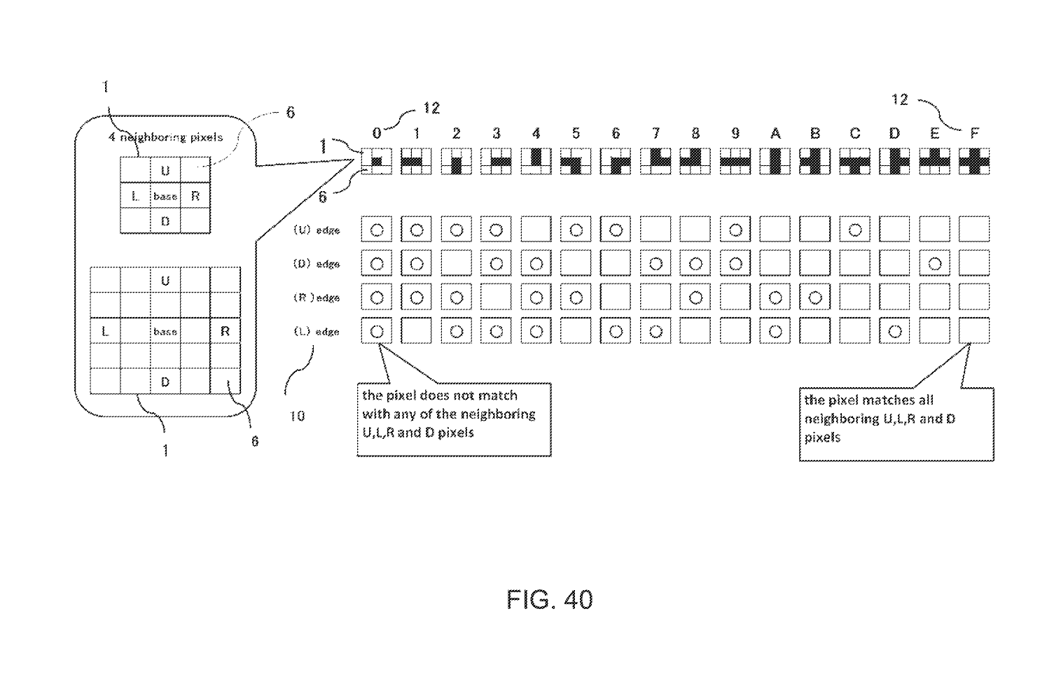

FIG. 40 depicts a diagram for encoding edge codes using the patterns of four neighboring pixels.

Image information is generally acquired and recorded for the purpose of expressing (displaying) brightness and color.

While image processing is also conducted under the assigned brightness and color information, extremely high-speed, effective image processing can be realized by using a new kind of information idea. This code was developed for such a purpose, and encodes the neighboring four pixels and their differences for any pixel within an image.

In the example shown in the figure, all of the pixels' brightness and color data are binarized. The neighboring top (U), bottom (D), right (R) and left (L) pixels are compared and judged on whether they match or not. These results are encoded into 16 kinds of codes “0” to “F” to form the edge code 12. There are 16 different kinds of codes, from pixels that are completely different from its neighboring four pixels to area pixels, in which the pixel is the same as all of its neighboring four pixels. This code shows whether an edge exists at either the top (U), bottom (D), right (R) or left (L) locations.

As shown in the figure, the neighboring four pixels do not necessarily have to be touching one another. And by comparing them with suitable neighboring pixels, the image noise can also be reduced. In any case, it is important to assign this code to pixels throughout the image area.

Even if such data existed in conventional methods, reading this information and finding the specific information was a large information-processing load. The arrival of a new kind of information processing device that does not rely on the CPU and memory will thus bring about a great effect. Details will follow later.

### Embodiment Example 1-3

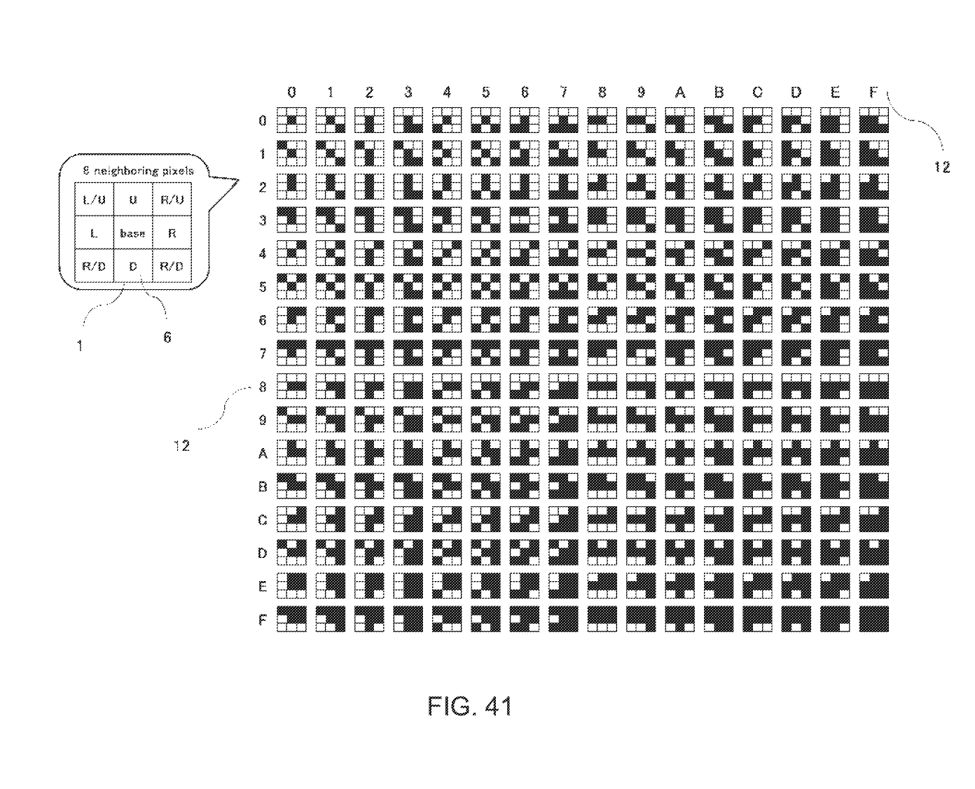

FIG. 41 depicts a diagram explaining the encoding of edge codes using neighboring eight pixel patterns.

While the previously explained FIG. 40 showed edge encoding for four neighboring top, bottom, right and left pixels, this diagram further incorporates four more corners—top left, top right, bottom left and bottom right. These eight pixels are encoded as edge codes 12. In this case, there are a total of 256 combinations of edge patterns, enabling more detailed edge detection.

Below is an application example of these edge codes 12.

### Embodiment Example 1-4

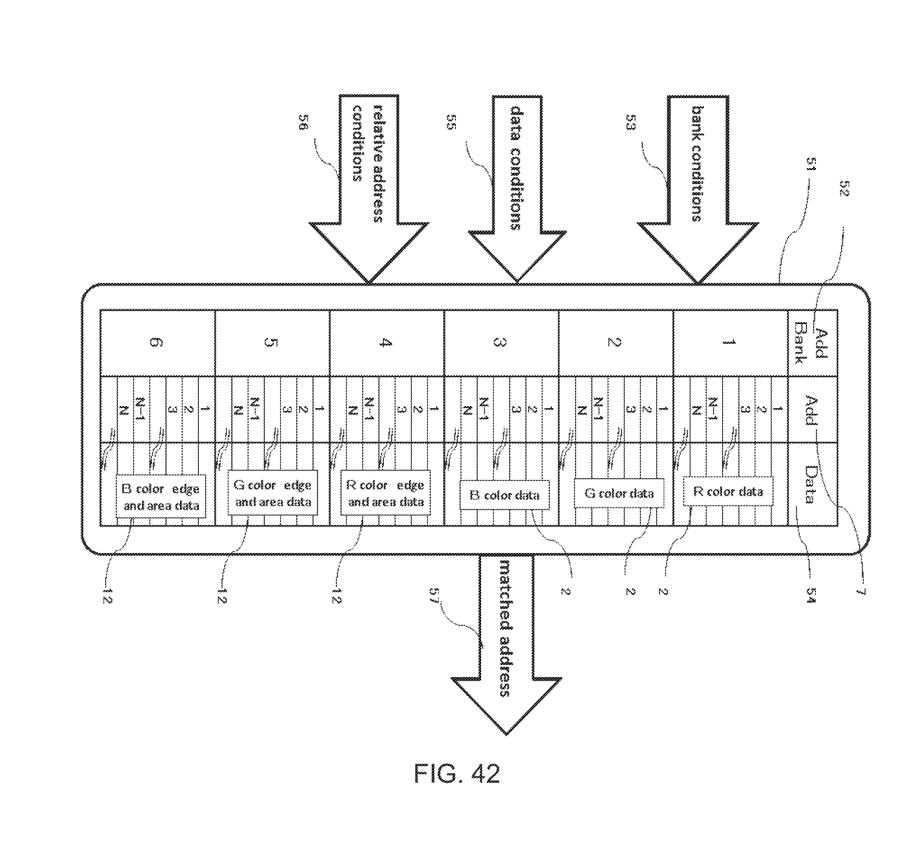

FIG. 42 depicts a diagram explaining information arrays for image pattern matching using memory having information refinement detection functions.

Detailed explanation of the memory having information refinement detection functions 51 (303) itself will be omitted. However, it is an information detection device with information processing functions that parallel operate both the data specified by outside sources and the absolute addresses through address replacement functions (swap functions) in addition to the Content-Addressable Memory (CAM)'s data match functions. The address(es) 7 that match these conditions are output as matched address(es) 57.

This is an example of refining the pixel 6 information explained above (in this case, the color 2 information for the three colors R, G, B and the total of six edge codes 12 for R, G and B) and recording this on the memory having information refinement detection functions 51 (303). While a method of recording each of these six kinds of information separately on the memory having information refinement detection functions 51 (303) can be adopted, this example describes a method for maximizing the use of the functions of this memory having information refinement detection functions 51 (303).

This example divides the entire memory having information refinement detection functions 51 (303) into six banks and records the six kinds of information in each address bank 52. The six kinds of information can simply be recorded in an identical sequence in order of pixels from addresses 1 to N.

By adopting such a structure, the same address within in each of the banks becomes the same pixel, and information can be refined by properly using color 2, area 9 and edge 10 information. In other words, this allows for effective pattern matching 17.

Bank specification 53 is the selection of what kind of information will be targeted. Data specification 55 is for detecting the matched addresses 7 for the recorded data 54 values. Relative address specification 56 is for detecting the relative addresses (relative positions) between pixels, and the matched address(es) 57 are the refined address(es) 7 (pixel 6) that match the above conditions.

The effect of this refinement is huge. This is because the probability of the data and its location matching is extremely low. One data value and one relative address can be specified or multiple pixel data values and relative addresses can be specified at once. At the same time, both data values and relative addresses can be specified as ranges. Of course, simple matching of only data values using the Content-Addressable Memory (CAM) is also possible.

By arraying image information in the above kinds of arrays on memory having information refinement detection functions 51 (303), extremely effective, good image processing becomes possible.

### Embodiment Example 1-5

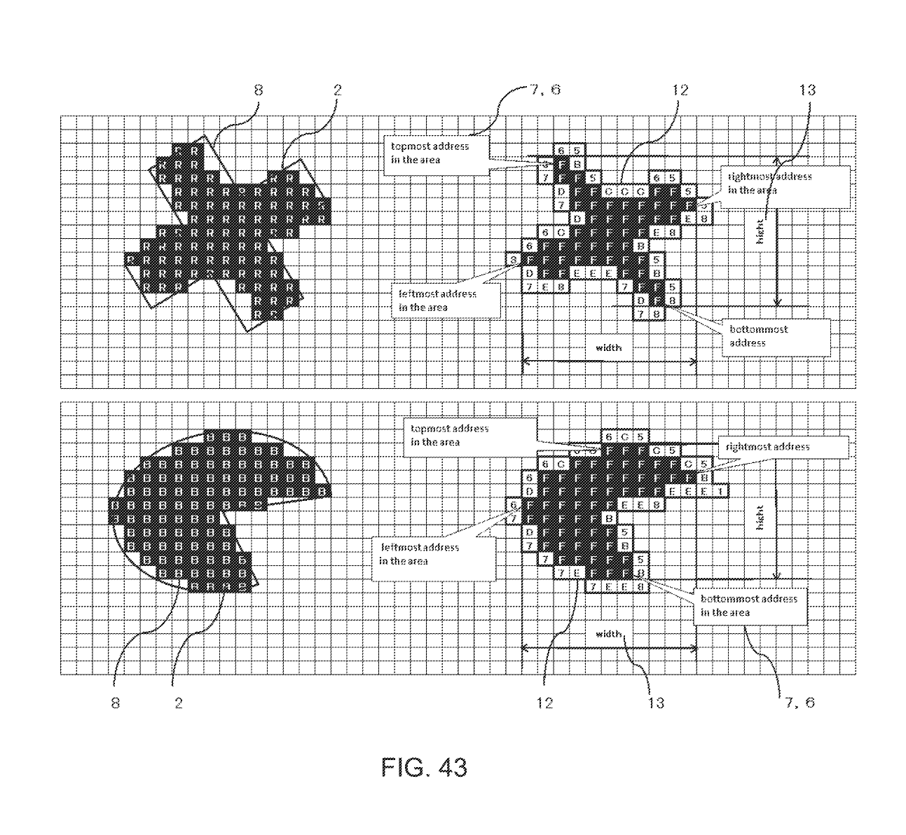

FIG. 43 depicts a diagram explaining the application of object edge codes.

The figure shows a method for effectively detecting the object size using color 2 information and edge codes 12. The color 2 information and edge codes 12 are recorded as arrays, as shown in the figure.

Object size detection can be realized by the following, extremely effective processes.

First the bank in which the corresponding information is recorded is specified and the F code is output. At this time, the minimum area address with the youngest (lowest) address value and its opposite, the maximum area address, represent the object's height. The area's rightmost address and leftmost address always exist within this range. If the object height and width are limited, it is easy to study the details. With this code, all of the surrounding area's edges, including unevenness or flatness, can be identified by matching codes “0” to “E” (excluding “F”) 15 times.

Furthermore, by combining color information, the shapes of complex and high-level image objects can also be recognized.

One example is information for effectively expressing the object shape 16, such as round edges, square edges or sharp edges. This information can be obtained or created as patterns, and by pattern matching with these created patterns, object shape recognition can be realized in an extremely effective way. Details will follow later.

From the above, it can be understood that shape recognition for image objects can be conducted in an incomparably few times of information processing that is more effective as compared to the conventional CPU and memory.

However it must be noted that when there is a depth to the object size in this method, it will not be the actual dimensions. The following is a description of measuring the actual dimensions of objects with depth.

### Embodiment Example 1-6

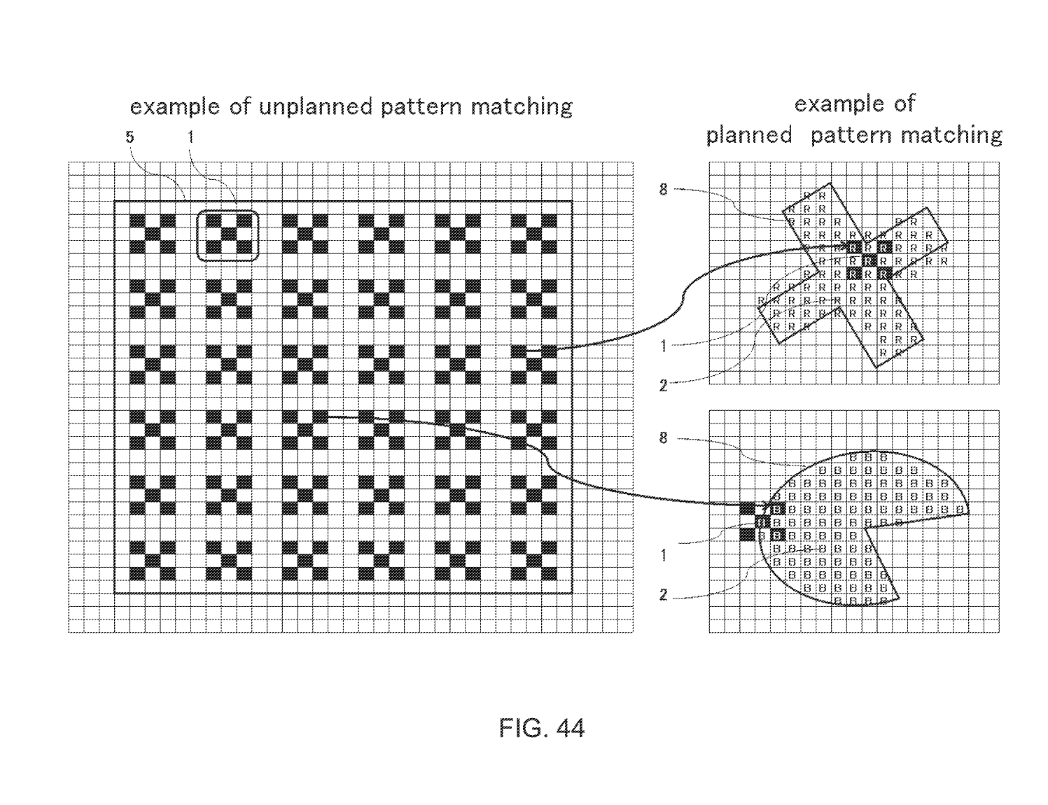

FIG. 44 depicts a diagram explaining planned and unplanned pattern matching based on local pattern matching. The following explains a logical and effective method of finding objects in an image using pattern match technology.

This example divides the image space into a number of sections, or localities, explaining a case in which information patterns are extracted for the colors and shapes of the sections.

It goes without saying that when we humans recognize objects, great importance is attached to color information. At the same time, most objects in an image are composed by combining a number of color areas. It thus follows that local patterns compose the sectional patterns and that these sectional patterns compose the entire pattern (the full image). Thus, if the local patterns or sectional patterns can be appropriately combined and pattern matched 17, object recognition will become possible.

As shown in the diagram, in this example, five pixels from a total of six X-axis and six Y-axis patterns, in other words 36 sections or localities are each extracted in an unplanned fashion as query patterns. Furthermore, the figure depicts the details of two local patterns from the above 36 local patterns.

The first object extracted in an unplanned fashion is a cross-shaped pattern with red (R) color information. The other object is a Pac-Man-like pattern (one section of a circle is missing) with blue (B) color information. As shown in the figure, the details can be determined by then conducting a planned (intentional) pattern match based on the characteristics of the five extracted sample pixels as shown in the figure.

There are unlimited applications to such pattern matching 17 using patterns 1 extracted in such an unplanned fashion.

One of these applications is detecting shaking on a digital camera.

By sectionally, or locally, pattern matching each section of the image just before the shutter is released and at the moment when the shutter is pressed, extremely simple detection is possible for whether the whole screen moved (camera shake), a section of the image moved (the photographed object moved) or a combination of the two.

A further planned detailed pattern matching 17 per locality, based on the results of pattern matching 17 for patterns 1 extracted in an unplanned manner as described above, forms the basis of typical object detection.

However, recognizing everything that comes into view would require repetitive local pattern matching, and even if each pattern matching were conducted at very high speeds, if there is a large number of them, the processing time would be great.

Humans mistakenly think that they can recognize various objects at once. However, recognition processes in our daily activities are not always this wide-ranging or precise. In other words, we do not thoroughly recognize every object that comes into view. Instead, we recognize what is necessary at each moment only to a necessary degree. This is especially important when applying image recognition by the computer to recognition by the human eye and brain. The following describes this purpose.

An example of when we concentrate and recognize objects is when we are driving.

No matter how careful we are to drive safely, we do not recognize each of the landscapes that come into view as objects. Instead our recognition is targeted towards the necessary information and objects from which we receive stimulation. And, we can only recognize about 3 to 4 kinds of objects each moment.

In order to validate the above, we need only study the number of objects that can be recognized after seeing a photo with many objects in it for just one second. While individual results may vary per person, only a few objects can be recognized after seeing a photo for only one second. Likewise, when there is an object that we want to recognize within our vision, we tend to unconsciously move our gaze towards the object. And objects other than those that receive our gaze fall out of our recognition and are simply seen as landscape. In other words, even if only three to four objects are recognized per second, these are accumulated and recorded to become the overall object recognition information that forms the high-level recognition of human beings.

As explained above, we first recognize the things that give us a great deal of stimulation, for instance, things that stand out or things that we are interested in. After this, we take time to slowly look through the entire photo, or stare fixedly at it and recognize the objects one by one.

There are also various degrees to recognition. While this is only one example, there are many levels to recognizing a car in a photo, from its color, shape, manufacturer, model or license plate number. However, when we are driving, the recognition of such details is unnecessary, and all we need is to judge that it is a car.

As can be understood from the above example, for computer-based image recognition similar to that of humans, recognition degree is determined by how many times local or sectional pattern matching is conducted with a certain intention (in a planned fashion).

Unplanned pattern matching can be compared to human recognition when looking out at the landscape from the drivers seat, while necessary and intentionally conducted planned pattern matching can be compared to recognizing the license number plate of the car in front.

In other words, object recognition by a computer similar to that of the human eye and brain can simply combine unplanned (unconscious) pattern matching and planned (intentional) pattern matching for composing query patterns by appropriately combining pixel information and their locations. After combining, the object simply has to be recognizable to the necessary precision.

The subject image does not necessary have to be a highly precise, detailed image on a large screen. Much like the human eye, the things that we want to recognize can be the predominant focus and pattern matching can be conducted by enlarging as necessary.

Compared to image recognition, which searches for individual pieces of information, hardware pattern matching, based on patterns composed of arrays of multiple pixels, is highly refined and is therefore the ultimate image recognition method.

At first, pattern matching is conducted loosening up refinement conditions to about two to three conditions. Once the existence (or nonexistence) of patterns is confirmed, pattern matching can be freely used, such as detailed pattern matching with 5 or 10 conditions.

Even if we suppose that pattern matching for one condition takes 1 μs, pattern matching can be conducted a million times in one second. This logically means that 1,000 locations on the screen can each be pattern matched 1,000 times.

Furthermore, this device can be used in parallel as necessary. And if appropriate pattern matching and knowledge processing are implemented, the number of objects that can be recognized per second can be heightened to human level or beyond.

To sum up, it simply depends on how it is used.

When thinking only about safe driving for a car, the buildings, trees, road and other cars do not have to be individually recognized. Instead, buildings and trees can be recognized collectively as fixed objects and objects that are far away can be ignored.

Additionally, when driving on the highway, recognition can simply center on objects on the road.

Apart from this, the only thing is how fast and effectively the necessary information can be detected. A representative example of this is traffic signals and traffic signs.

The sections of such signals and signs can easily be detected from images as striking colors (highlight colors) or combinations of striking colors.

The above can be realized by planned pattern matching using the characteristic of color.

Things that are close or large are some further important things that must be recognized. This will be discussed in later sections.

Recognizing pedestrians rushing out onto the street or abnormalities in the car in front are indispensable to safe driving. These sections can be easily detected as movements in the image.

The following is an example of this.

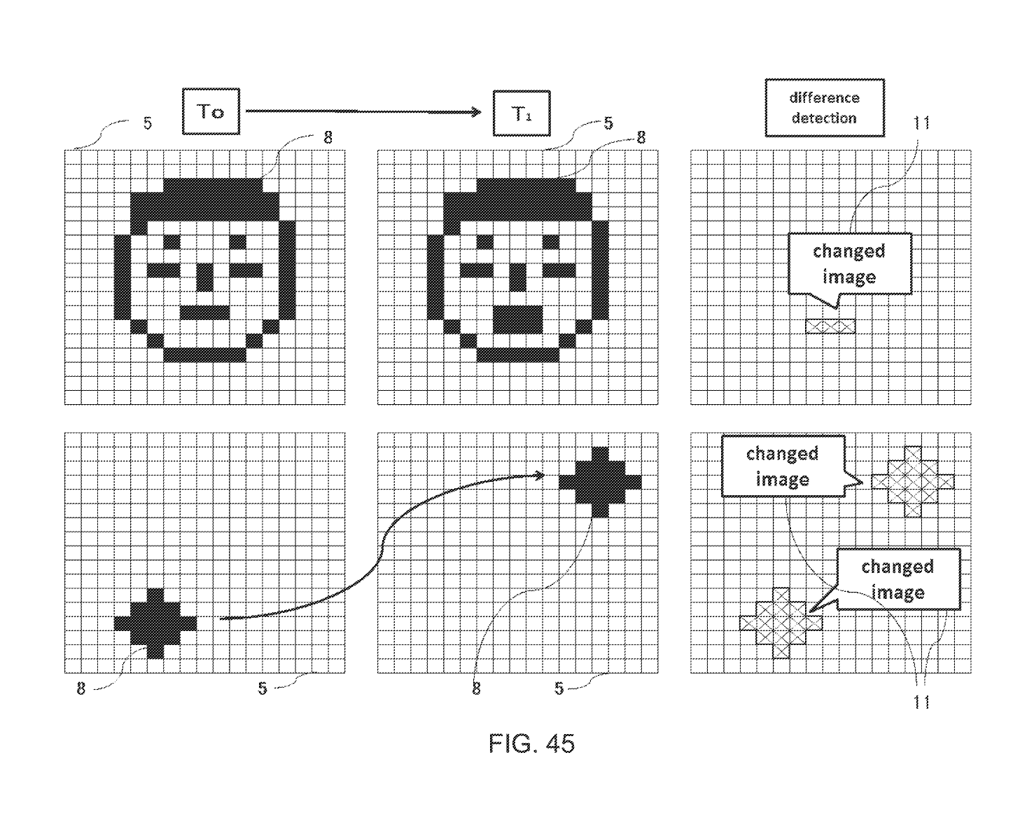

FIG. 45 depicts a diagram explaining the detection of changed images for an object.

As shown in this figure, by obtaining the difference in two images at time T0 and time T1 and deleting the pixels that have not moved, the sections of the image that have moved can be effectively detected. By setting the changed image 11 sections as patterns, the object movement in the video as well as the camera angle movement can be understood, allowing for various applications. Specific subjects can be understood as patterns and these patterns can be made to be at the center of the screen all the time, allowing for an extremely simple automatic camera angle tracking.

As shown above, because the detected image section can be specified as the subject pattern, pattern matching only on sections with movement can be realized, without relying only on the unplanned pattern matching of the entire range, as described before. The detection of image differences using this method has many different uses such as detecting misalignment through comparison with a standard image or detecting product flaws.

### Embodiment Example 1-7

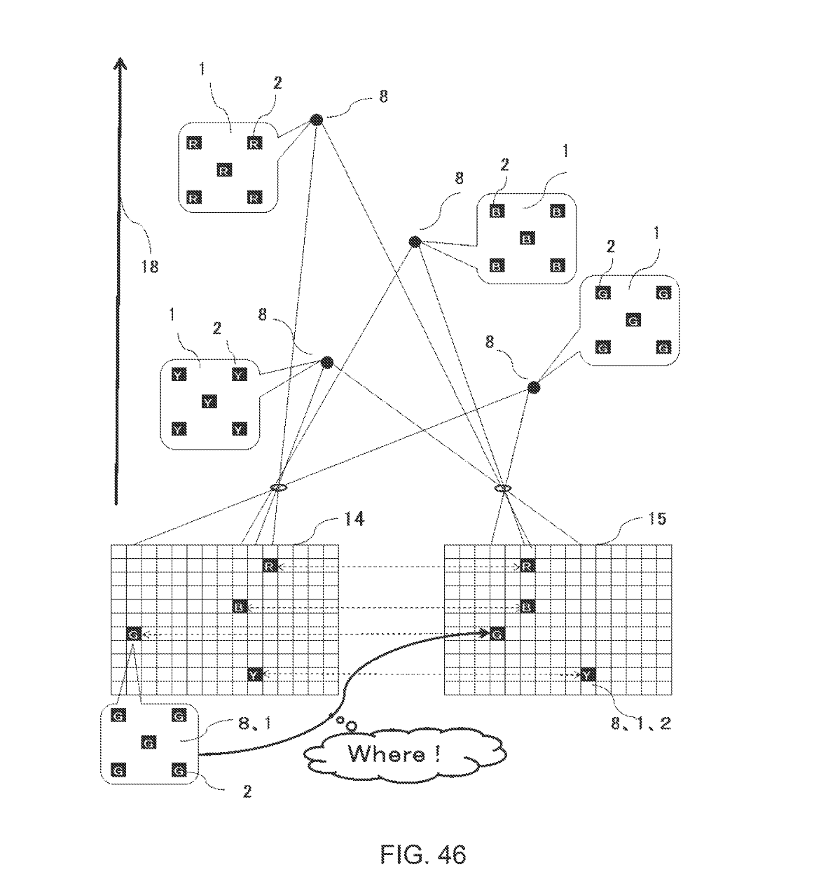

FIG. 46 depicts a diagram explaining the detection of corresponding points on an object through local pattern matching.

The figure treats the image with floating balloon-like objects 8 in four colors, red (R), blue (B), yellow (Y) and green (G) as left and right camera images. Because the binocular camera's object image and the actual object are composed of an epipolar plane, if the distance between the lenses of the binocular camera can be found, the positions of the XYZ axes, including the object depth, can be measured by triangulation.

In the figure, the Y axis (height) of the object is omitted, and the object is expressed by two axes, the X axis and Z axis. On the other hand, in the left image 14 and right image 15, the Z axis is omitted, and the images are expressed by the two axes of the X axis and Y axis. Either the left or right image can be set as the base; and sample patterns can be extracted from this base. The locations that match after querying the other image are the mutual corresponding points 21.

For explanation purposes, the image is explained as pattern matching 17 for a single color. However, local matching can also be conducted for color combinations, as opposed to single colors. Most sections of an object image must exist as both the right and left images (patterns), or as same/similar images (pattern). At the same time, because the same can be said for issues of lighting or the photography environment, which prove to be challenges to information processing, corresponding points 21 can easily be mapped on these similar (right/left) images. And once the corresponding points on the left and right images are detected, the three axes, including the depth 18 of the object, can be measured based on the pixel locations of the corresponding points 21.

From the above method, the actual dimensions of an image object can be measured at an extremely high speed. And, in terms of image processing, this creates immeasurable benefits.

### Embodiment Example 1-8

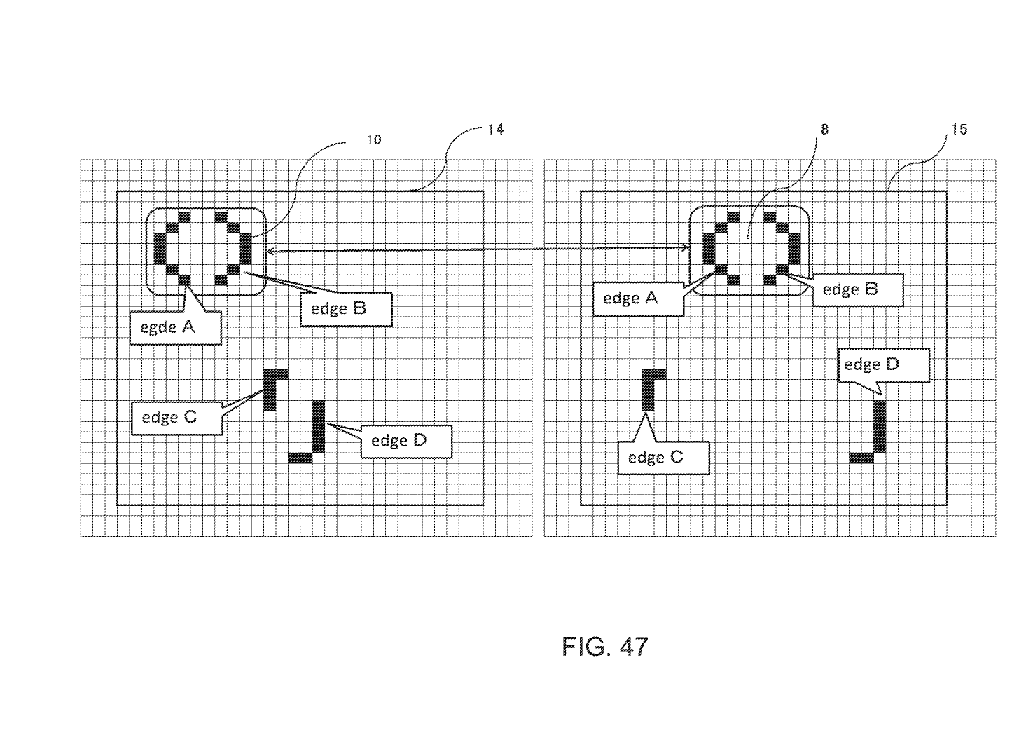

FIG. 47 depicts a diagram explaining object recognition using edge codes.

The above illustrates the pattern matching 17 principles shown in FIG. 46. If the above edge codes 12 are recorded in the left image 14 and right image 15 and pattern matching 17 is conducted between the left and right edge codes 12, the patterns of the corresponding points 21 become patterns unique to the object, with very little probability of existing anywhere else in the image space.

It thus follows that the edge pattern of either the left or the right can be extracted and set as the query pattern to detect the corresponding points 21 between the left and right images through pattern matching.

High-speed recognition is thus possible, including the judgment of whether or not two separate right and left edges are from a single object. Furthermore, the distance of the depth (Z-axis) can be determined along with the object dimensions 13 in the three X, Y and Z axes.

### Embodiment Example 1-9

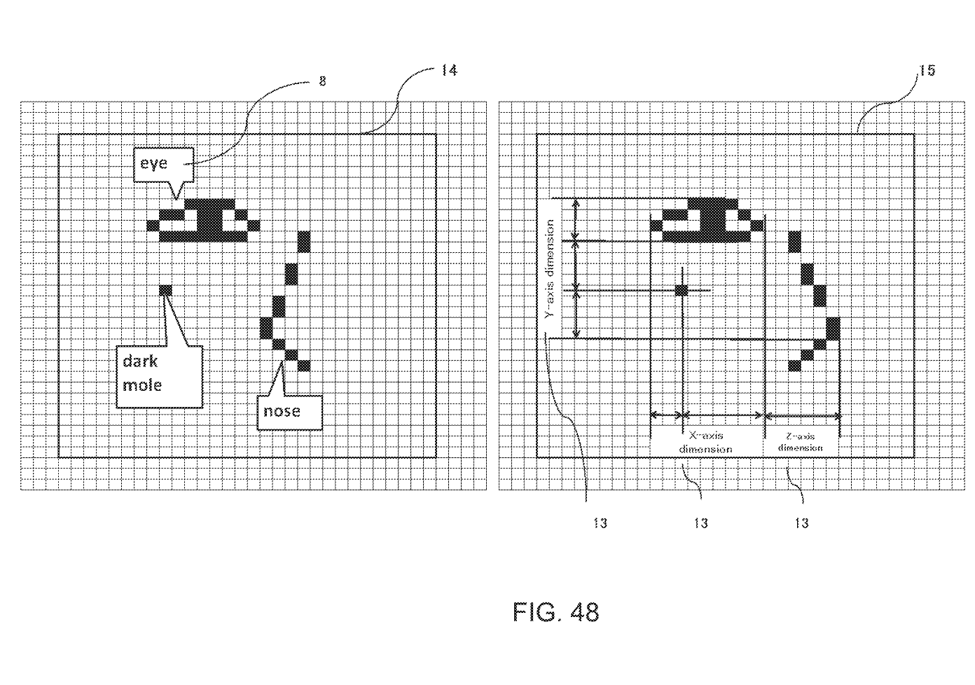

FIG. 48 is an example of human recognition (recognizing humans) using stereoscopic measurements.

While the level of face recognition technologies can be greatly advanced even by local pattern matching 17 using monocular camera images, the example presented below explains human recognition using stereoscopic measurements.

Here, human recognition is used to mean the identification of individuals by recognizing the individual's traits from within the image range.

While camera sensors and zoom functions have improved to provide highly precise, detailed images, human recognition has continued to be a difficult technology due to the fact that image processing technologies have not advanced.

Human recognition will advance greatly through pattern matching using the present invention.

In this example, facial characteristics such as the eyes, nose, mole, and scars of the face (as shown in the figure) are specified as patterns, and the corresponding points in accordance to binocular parallax are pattern matched 17. The resultant measurements for the actual dimensions of the X, Y and Z axes are the sizes of the eyes, the height of the nose, etc.

These measurement results are important characteristics unique to the person.

It goes without saying that, other than the eyes, nose, mole or scars as in this example, any characteristic unique to the person can be used such as the mouth, eyebrows, hair, hands or feet. If recognition of dimensions and shapes independent of color become possible, human recognition surpassing the bounds of race will also become possible. The only thing necessary would be a stereoscopic camera system with high enough resolution for measuring and sampling such characteristics appropriate for human identification.

If high-speed pattern matching 17 can be realized and Z-axis information used, conventional face recognition will largely advance to human recognition (identification). If combined with conventional face recognition technologies, an extremely high-speed, highly precise human recognition technology can be completed.

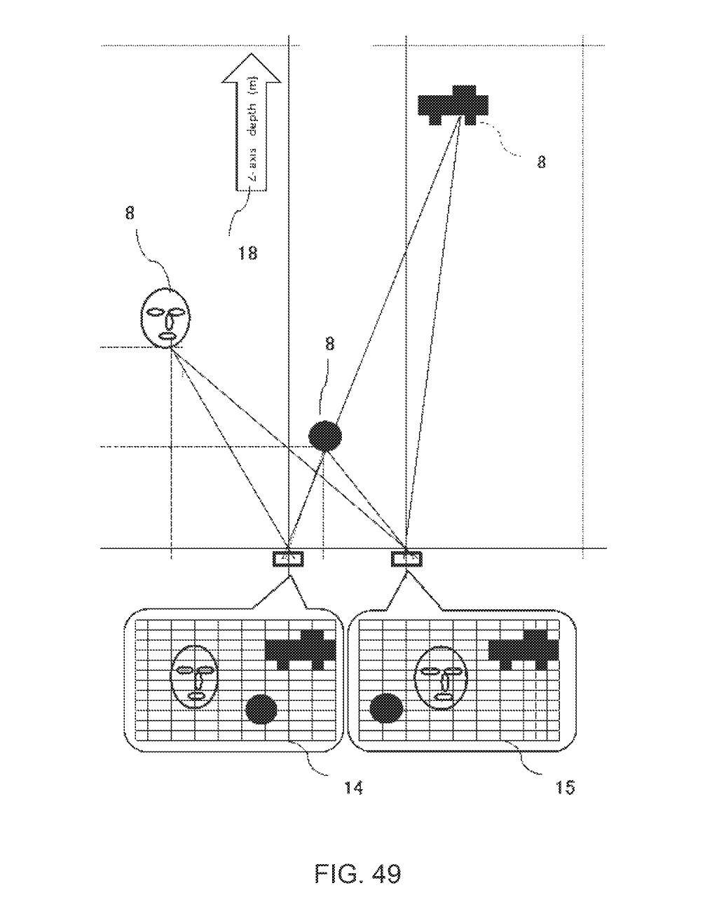

FIG. 49 depicts a diagram explaining object recognition in space.

If object dimensions and their distances can be easily determined as shown above, the actual dimensions of objects can also be found. As shown in the figure, from three object sizes, it will be become possible to narrow down the size range of the object, such as truck-sized objects, face-sized objects and apple-sized objects. Afterwards, these can be further divided into classes based on detailed information like color in order to recognize the object.

If the object is red, round and has a dimension of 13 cm, there is a high probability that it is an apple. If object dimensions can thus be known, the probability of object recognition would greatly improve.

In safe driving, an indispensable piece of information is the size and distance of the object in front. If each pixel contains such depth information, effective image detection, such as recognizing only the images within 50 m in front, will be realizable.

And by being able to accurately recognize these object sizes and distances, the computer will be able to drive a car much like a human being.

Most of the above methods can be implemented through normal pattern matching 17 using the conventional CPU and memory. However, it is extremely difficult to realize in real time. Such actual measurement of object dimensions becomes possible only with the establishment of this high-speed, effective pattern matching 17 method.

Object recognition technologies heretofore were built upon specialized hardware or software. However, the realization of this memory having information refinement detection functions 51 (303) would enable the generalization of such image recognition technologies.

While this differs from the purpose of the present invention, a method for realizing even more effective knowledge processing based on the above spatial recognition is explained below.

In object recognition for the sole purpose of safe driving, map information can effectively support this recognition technology. Object recognition for safety at a city intersection is different from that required for safety on the highway. By setting such map information and car driving conditions as input conditions, the range of objects to be recognized as images can be refined, in other words, the number of knowledge process combinations can be effectively reduced.

Because most cell phones nowadays have built-in GPS, using this information would allow the invention to be applicable to all environments in daily life.

Furthermore, human words can be recognized, and these words can help refine the object to be recognized.

To repeat the above explanation, humans can recognize a great number of objects, however, only a limited number of objects can be recognized at once. By narrowing down the objects that must be recognized, setting an order of priority for what must be recognized first and running the recognition process in order, object recognition with images similar to those of the human eye and brain will become possible.

### Embodiment Example 1-11

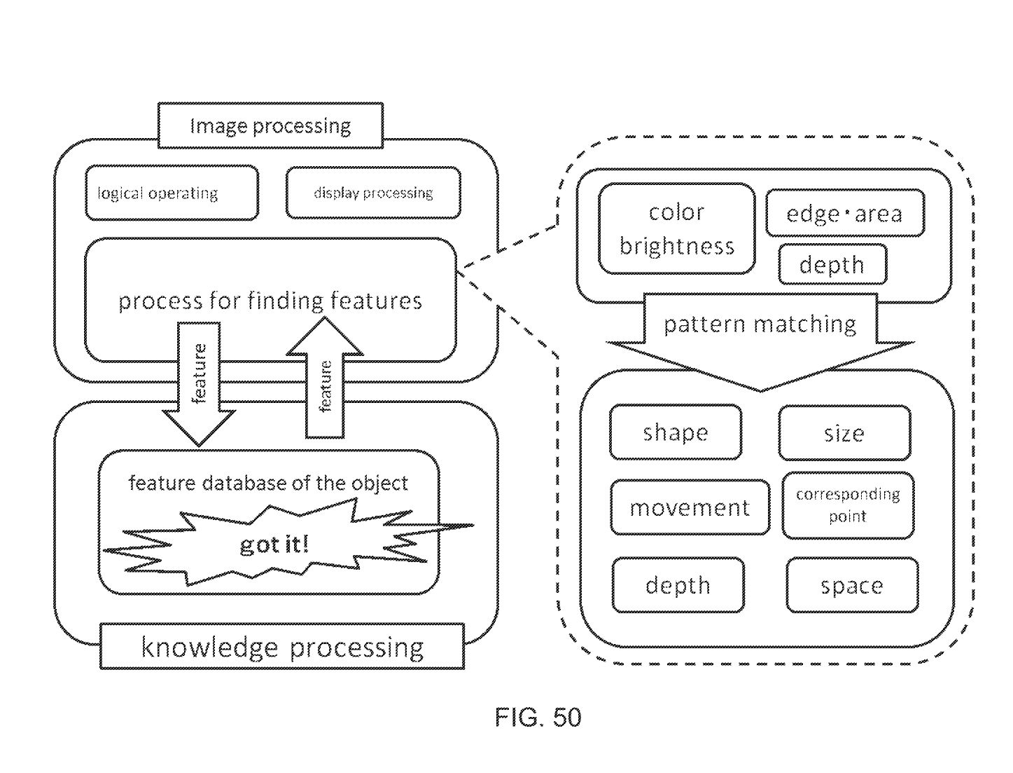

FIG. 50 depicts a conceptual diagram for object recognition using pattern matching, and is a summary of the above explanations.

Object recognition is a combination of image processing and knowledge processing.

In knowledge processing, the various characteristics of the object are divided and registered into different categories and, based on the characteristics assigned by image processing, knowledge processing finds the objects registered on the database. Conversely, knowledge processing likewise specifies characteristics while image processing searches whether there are any characteristics that match this specified characteristic.

On the other hand, image processing is divided into the process for finding characteristics (the purpose of this invention) and other processes.

Representative processes included in these “other” processes are operation and display processes. These processes can continue to be implemented through information processing centered on the CPU as in the past. In these processes, there is no wasted search time, and the CPU's functions can be used 100% with no waste. Because there will be a great decrease in operation processes when the present invention's pattern matching is used, the CPU's load for this process will be further lightened.

The process of finding characteristics, the purpose of the present invention, can be implemented using base information such as color/brightness, edge/area and depth. The object characteristics thus obtained will be important and highly wide-ranging characteristics like shape, dimensions, movement, corresponding points, depth and space. And these will effectively realize the specification of the object from a database of object characteristics. It goes without saying that, in the time required for this process of finding characteristics, wasted search time will be fundamentally resolved by using this memory having information refinement detection functions 51 (303). However, the same process can also be realized through serial processing by conventional methods using the CPU and memory.

This invention centers on object recognition, focusing on heightening the speed and precision of image processing. However, the knowledge process of finding objects in the database most similar to the specified characteristics is pattern matching itself; this technology can thus be used for pattern matching both in image processing as well as knowledge processing.

As for methods for obtaining and storing knowledge, these will be described separate from the present invention.

The claims of the present invention will now be checked with this detailed description and the main points described. While many patent applications have been filed regarding image pattern matching, there are no precedent examples that focus on the data arrays of the memory's image information itself and conduct extremely simple pattern matching based on the pixels' image information data values and their data locations.

It thus follows that,

For images in which the XY array sizes are defined,

A feature of the present invention's image recognition is its image recognition method (various combinations of pattern matching) processing images in the following steps (1) and (2):

(1) The step of creating the image query pattern(s), composed by combining both the image information data values and data locations for the pixels that compose the image, consists of the same method as used in the example of creating unplanned or planned query patterns for finding a specific pattern from images arrayed on the memory having information refinement detection functions 51 (303). (Step for detecting pattern matching data)

### Furthermore,

(2) The step for detecting the pattern-matching address(es) (pixel(s)) by querying the above image query pattern to the image subject to detection and finding the pattern matching 17 pixel(s) that match these image query pattern(s) from the above subject images denotes the detection of pattern-matched address(es) (pixel(s)) by querying the sampled pattern to the subject memory images. (step for detecting the pattern matching address)

### (An Example of Voice Pattern Matching)

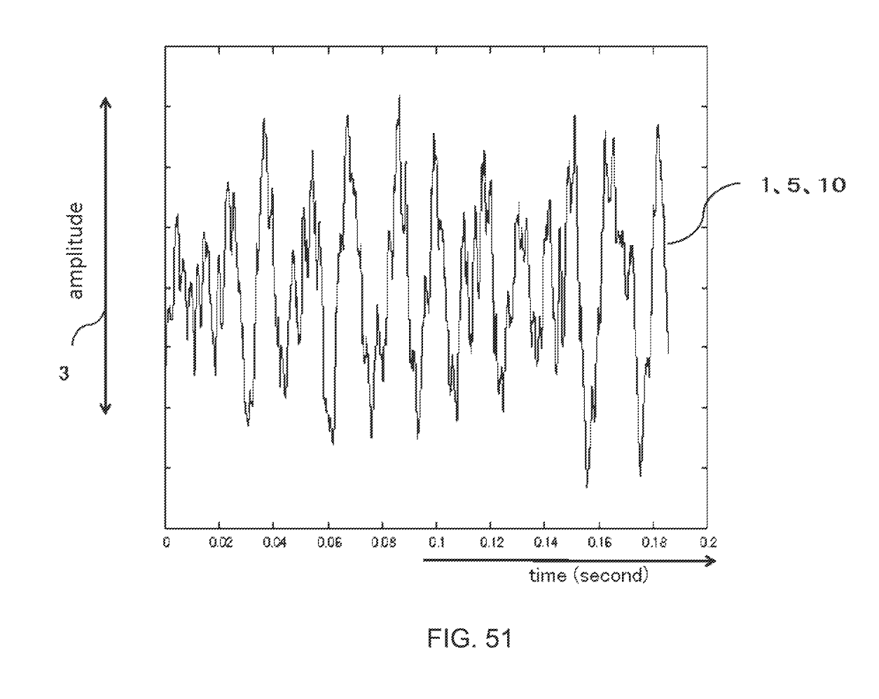

An example of voice pattern matching is depicted in FIGS. 51 to 57. In the following explanation, please note that the reference codes are left as is so that their relationship to the basic application's declaration of priority can be easily understood.

The detailed explanation of the memory having information refinement detection functions 50 (303) itself will be omitted. However, as noted above, it uses address 51 replacement functions like address 51 shift in addition to the data 52 match 19 functions of the Content-Addressable Memory (CAM) to parallel operate both the data assigned from outside sources 52 and the relative addresses 54 and, from these conditions, output the refined address(es) 51 as the pattern matched 9 matched address 56.

Voice recognition technologies include a mass of pattern matching 9 technologies, and this device is perfect for voice recognition. In recent linguistics research, it has been reported that the African languages have the greatest number of phonemes at 200, English has 46, Japanese 20 and the Hawaiian language has the least number at 13. While this number differs by researcher, voice recognition can largely advance if a maximum of about 256 phonemes can be precisely recognized.

FIG. 51 depicts a reference example for phoneme wave amplitude patterns.

This figure represents phoneme 5 wave amplitudes 3 for one moment of our language. As shown in the diagram, the phoneme 5 is a signal that includes various frequencies 2. In Japanese, about 20 different phonemes, such as vowels, consonants and semivowels, are combined to emit all the sounds of the Japanese syllabary.

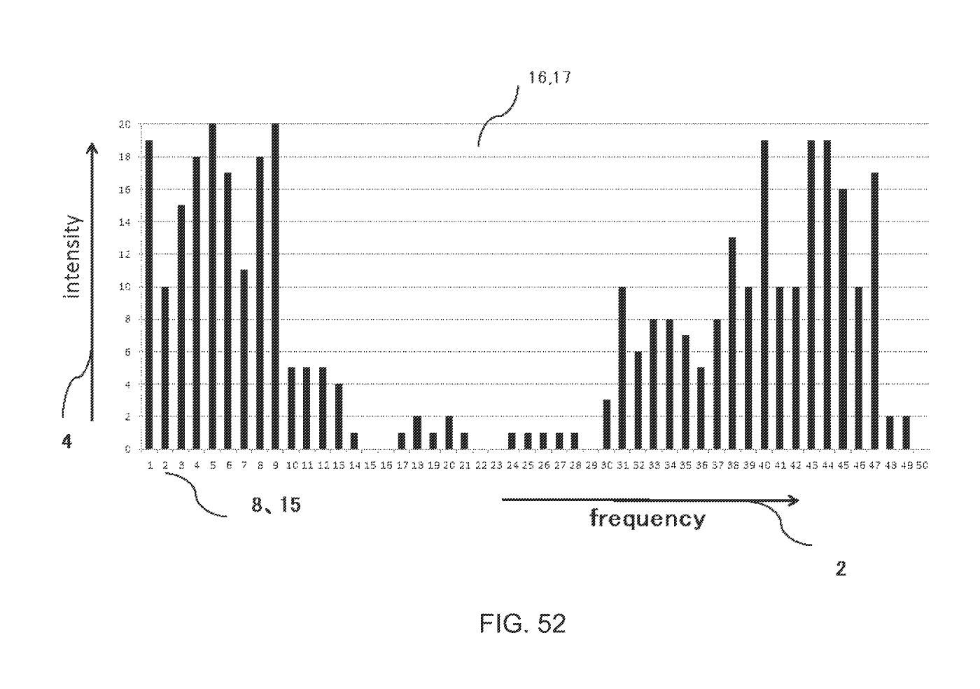

FIG. 52 depicts Reference A showing a frequency spectrum for phonemes.

In this figure, the intensity 4 distribution per frequency 2 spectrum 16 for a phoneme is measured. These intensities 4 per frequency 2 are then arrayed 8 as array numbers 15.

In this example, 50 arrays 8 from low frequency compositions to high frequency compositions are shown by intensity 4 per array number 15. The voices 1 and phonemes 5 in this figure are phoneme patterns 17 with large intensities 4 in the low sound area and high sound area.

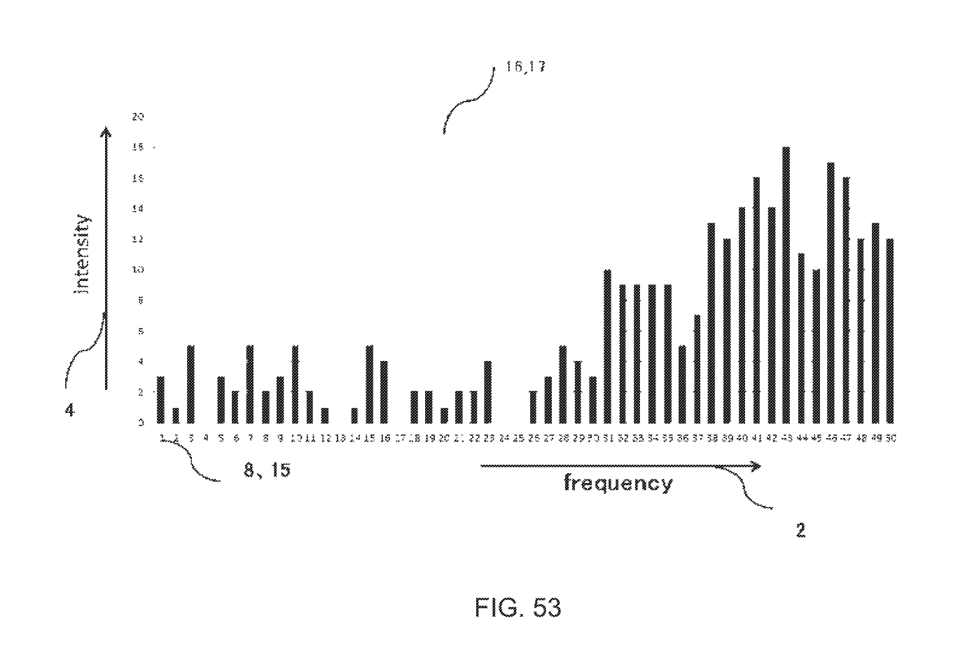

FIG. 53 is reference diagram B for a phoneme wave frequency spectrum.

On the one hand, the phoneme pattern 17 in this diagram has high intensity 4 in the high range. As shown in FIGS. 52 and 53, because the phoneme 5 wave spectrum 16 denotes the phoneme pattern 17, if this pattern can be correctly pattern matched and read, accurate phoneme 5 recognition would become possible.

In voice recognition technologies in recent years, the phoneme spectrum pattern itself has not been dealt with. Instead, these technologies mostly focus on the shape of the vocal tract when emitting sounds, logarithmically transforming the voice spectrum and using cepstrum series transformed by inverse Fourier transformations. However, because the frequency data per phoneme can be interpreted as patterns, the same methods can be applied.

What is important in phoneme recognition is that there are individual variances even for the same phoneme 5. One representative example of this is that there is a very slight difference in the low range and high range of male versus female voices. It thus follows that, in order to allow such individual differences, many people's voices must be collected and the range 18, with maximum value 10 and minimum value 11, statistically determined based on the data 52 of phoneme intensities 4 per phoneme 5 frequency 2 array 8. Pattern matching 9 with this range 18, in other words, ambiguous pattern matching 13 can then be made possible.

When conducting such ambiguous pattern matching 13, it is useless to heighten the resolution of the data. A resolution of level 10 on average and level 20 at maximum is sufficient. At level 16, 4-bit coding is possible. Two methods of conducting such range searches can be devised: one for setting range(s) 18 on the database side and the other for setting range(s) 18 on the query data.

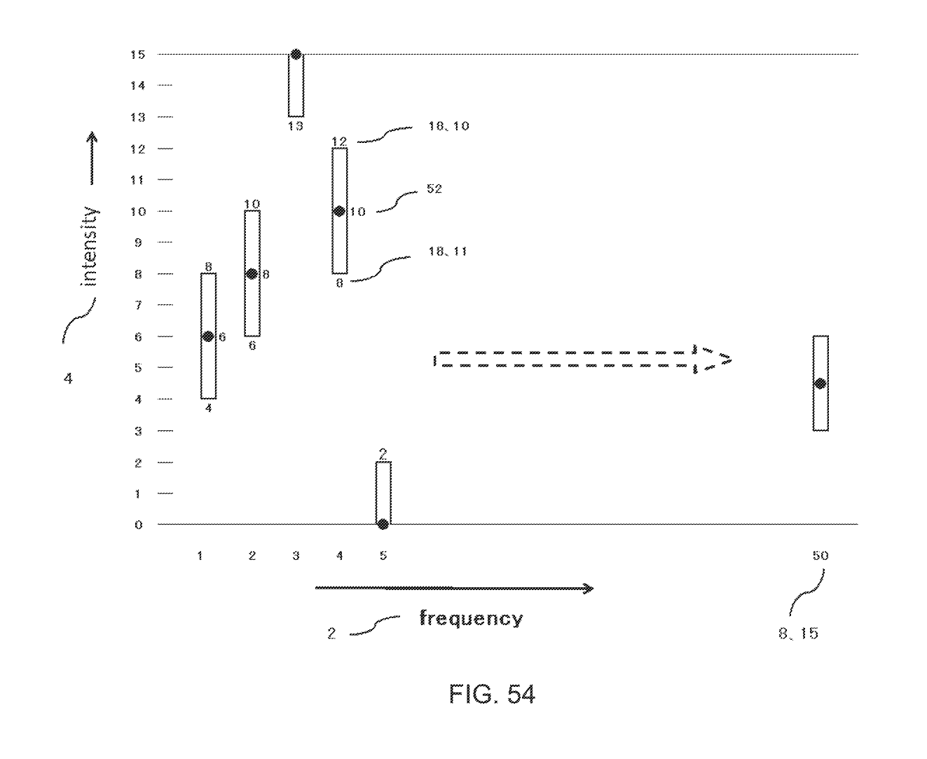

FIG. 54 depicts an example of range data for identifying phonemes.

This is an example of the method of setting ranges 18 on the query data as explained above. The intensity 4 level is level 16, and pattern matching 9, in other words ambiguous matching 13, is conducted on the specified data with a range 18 between the minimum value 10 and maximum value 11.

In this example, a uniform range 18 of ±2 is assigned to the provided data, and the data 52 shown includes six data ranges. If the provided data is near the maximum or minimum values, its range becomes smaller. Ambiguous pattern matching 13 for intensities 4 can be conducted based on the above idea.

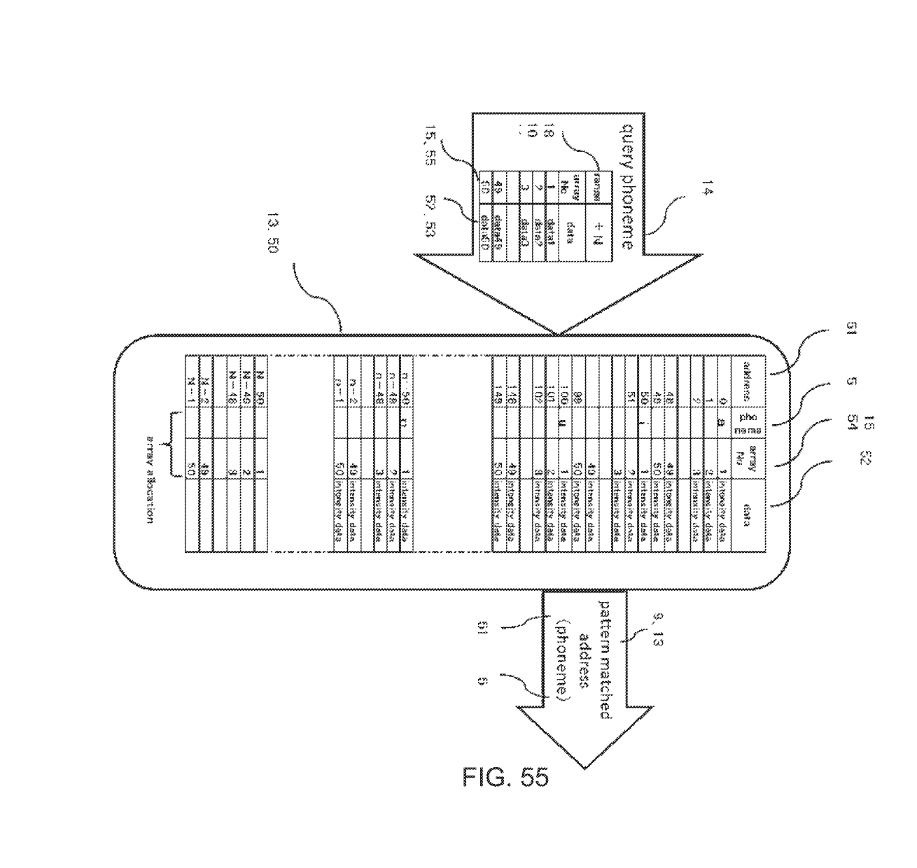

FIG. 55 depicts an example of phoneme recognition using memory having information refinement detection functions.

The array 8 explained in FIG. 54 is recorded as an array 8 on the memory having information refinement detection functions 50 (303).

As shown in the figure, one phoneme 5 pattern is allocated into 50 arrays on the absolute address 51 of the memory having information refinement detection functions 50 (303) and their intensity 4 data is recorded and registered in the data 52 portion.

When a maximum of 256 kinds of phonemes are made into 50 array 8 patterns per phoneme, the address space required is about 12K addresses.

As shown above, all of the world's language phonemes can be recognized with an extremely small database.

A phoneme spectrum 16, voiced and converted into the spectrum, is input as a condition into the memory having information detection functions 50 (303), as the query phoneme 14.

This phoneme 5 data contains intensity 4 data 52 arrayed per array number 15. This array number is a relative address specification 55 that specifies the relative address 54 that corresponds to the absolute address 51.

From both the data specified by the relative address specification 55 and data specification 53 (for specifying data 52), data is refined inside the memory having information refinement detection functions 50 (303). These refined results are output as the matched address(es) 56.

This address specifies a phoneme 5, and is recognized through pattern matching 9 the phoneme 5 itself.

Next is an explanation of ambiguous pattern matching 13 including the ambiguity of data ranges 18.

For such pattern matching 9 including this kind of range 18, it is possible to create hardware for memory having information refinement detection functions equipped with a further range detection function. However, for ambiguous pattern matching with a maximum, minimum range as shown in FIG. 54, simple range matching is possible even on a device for complete matches 50 by simply repeating the Content-Addressable Memory (CAM) function's data 52 matching 19 on the provided range 18 of data values from the minimum value 10 to the maximum value 11 a number of times equal to the number of ranges, in this example 5 times, and by taking the logical OR of the matched address each time.

The above matching repeated five times is a process conducted in parallel. It can therefore be completed at extremely high speed, and by pattern matching 9 each array five times up to 50 arrays in order, ambiguous pattern matching 13 can be realized.

Because this pattern matching is a parallel operation, it is extremely high speed and, furthermore, precise. While this example shows pattern matching 9 for all 50 arrays, in terms of statistical probability, there is no real necessity to conduct pattern matching 9,13 on all arrays 8 as in the above. It is sufficient to simply conduct pattern matching 9,13 for the necessary number of arrays, for instance, about half.

Noises with unique frequencies, like engine rotation noises or air conditioner noises, are contained in sounds emitted from cars. In this case, these foreign noises and the data 52 arrays 8 of their unique frequencies can be excluded from pattern matching 9,13 to heighten the reliability of this phoneme recognition.

This kind of mobile pattern matching is possible because of the high-speed hardware pattern matching realized with the help of this invention.

When recognizing phonemes 5, the problematic issue of phoneme intervals can be resolved and extremely practical pattern matching becomes possible by using the effectiveness of high-speed pattern matching and filtering or repeatedly implementing pattern matching at a certain time, for instance 10 milliseconds, and averaging the phoneme patterns in this time range.

Its comprehensive recognition rate can be further improved by combining it with vocabulary pattern matching as described below.

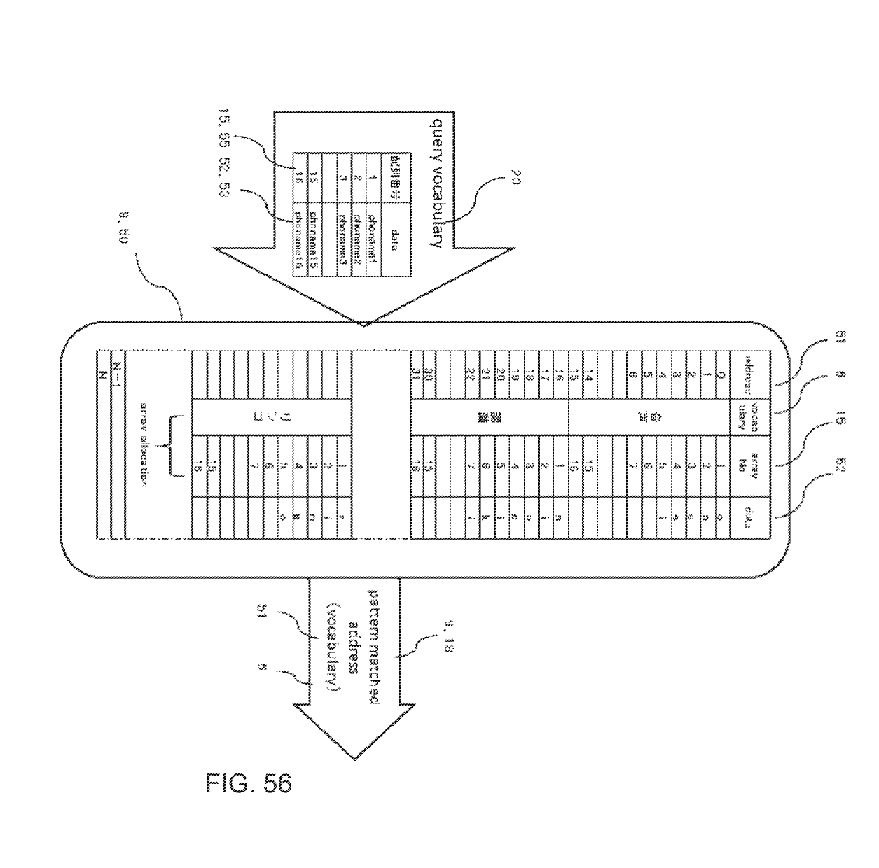

FIG. 56 depicts an example of vocabulary pattern matching.

The combination of phonemes detected in the above way form words and vocabulary. This pattern matching method can be applied for matching vocabulary 6, defined by arrays of phonemes.

To give one example, the word [symbol] “o-n-s-e-i” (voice) in Japanese is an array pattern of phonemes, “o-n-s-e-i.” Arrays of phonemes form the minimum unit of speech, or vocabulary (words).

As shown in the figure, this example allocates one vocabulary (word) as sixteen phoneme 5 arrays 8 on the memory having information refinement detection functions 50 (303), recording and registering the phoneme 5 as data 52 on absolute addresses 51.

The query vocabulary 20 is the phoneme 5 input as a data 52 condition in an array number 15. By simply reading the absolute address 51 that pattern matches 9 this query vocabulary 20, the vocabulary 6 can be detected.

In this example, the 16 array conditions are pattern matched collectively.

This is an extremely simple and high-speed vocabulary detection in which complex algorithms and other data tables, etc. are completely unnecessary.

With this method, any of the vocabulary can be recorded first; it does not matter what order the vocabulary is recorded in for the arrays. Another important characteristic is that the redoing of arrays, typically conducted each time a vocabulary is added or revised, becomes completely unnecessary.

The registration of fifty thousand basic vocabularies using this method is possible as long as there is 50K×16 arrays+80K of address space. This figure shows an example 16 arrays, however, for general purposes, the vocabulary can be divided into 8 arrays, 16 arrays or 24 arrays on appropriate devices based on vocabulary length, and addresses can be used without any waste.

In most vocabulary matching today, it is customary to conduct pattern matches on a vocabulary database based on small phoneme arrays that are typically about three phonemes. The reason for this is that, when the arrays are made longer, the combinations of tables and indexes explode and cannot be realized.

When multiple languages exist, databases per language on different recording mediums can be prepared and downloaded each time by this memory having information refinement detection functions 50 (303).

Below is an explanation on ambiguous pattern matching 13 for vocabulary recognition.

The phoneme array “o-n-s-e-i” shown above appears in the order of “o”-“n”-“s”-“e”-“i” chronologically. However, one of the characteristics of pattern matching using memory having information refinement detection functions 50 (303) is that there is no difference whether one portion is missing or if it is not in this exact order.

Specifically, the abovementioned phoneme array is an array of relative address X+0 “o”—relative address X+1 “n”—relative address X+2 “s”—relative address X+3 “e”—relative address X+4 “i.” Furthermore, from the results of refined matching, X can be recognized a relative value from 1 to 16 in this case.

It thus follows that, even if there is one piece missing, as in the array, relative address X+0 “o”—relative address X+1 “n”—relative address X+2 “s”—relative address X+4 “i,” or even if the array order was relative address X+4 “i”—relative address X+0 “o”—relative address X+1 “n”—relative address X+2 “s,” there is no problem whatsoever with the query. The query can be made as long as the phoneme array can be specified.

In other words, pattern matching including wild cards, where a portion of the array is specified as any random data, reversely refining the phoneme (reverse lookup), or refining from the middle (mid-point lookup) all become completely guaranteed. This means that, even when conducting pattern matching excluding phonemes that are recognized with uncertainty or for overall uncertain phonemes that result from outside noise, this method works extremely effectively in finding highly probable vocabulary through repeated pattern matching.

While the parallel matching time for memory having information refinement detection functions 50 (303) differs largely based on address size or various optional functions, this device with the above structure for vocabulary matching can pattern match a pair of 16 array patterns in under one microsecond. And this speed connects directly to recognition precision.

When a memory having information refinement detection functions 50 (303) equipped with a counter for measuring the number of matching times, as described above, is used for this embodiment example, the above ambiguous information pattern matching can be even more effectively realized.

As explained above, the above phoneme and vocabulary pattern matching can be conducted even faster, more precisely and more simply with this invention than any other technology devised heretofore.

If a voice is continually recorded over a certain period of time and if, suppose, no pattern match is found to its phonemes or vocabulary, there would still be sufficient time to repeatedly conduct pattern matching based on the recorded voice.

As described above, by checking the detected vocabulary with grammar, fundamental voice recognition for spoken words can be realized. Matching for grammar is also possible with this matching method, but explanations on this will be omitted.

### (An Example of Text Pattern Matching)

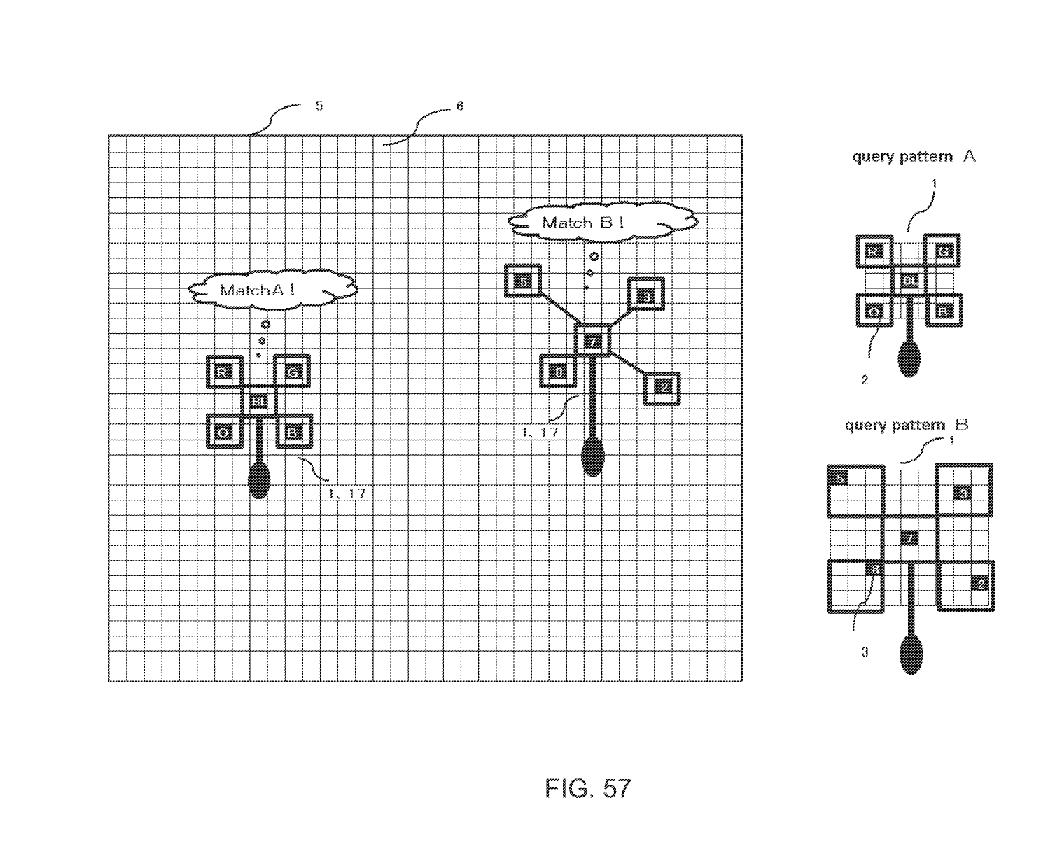

Below, an example of text image pattern matching is explained referring to FIGS. 57 to 66. Please note that, in the explanation below, the reference numbers are kept as is so that its relationship to the basic application's declaration of priority can be easily understood.

FIG. 57 is an explanation of image patterns and image pattern matching.

The original meaning of the word pattern 1 expressed the design of fabrics or pictures of printed materials. At the same time, this word has been widely used to express the characteristics of specific phenomena or objects. In the case of image patterns 1, these designs or pictures can be described as detailed colors and brightnesses being combined and arrayed in various positions. Temperature patterns 1 and economic patterns 1 are examples of one-dimensional information patterns, while characters, DNA strings and computer viruses are also examples of patterns 1.

Images in general, be they still images, videos or computer graphics, are displayed/played based on image information 5 on the memory. Thus image information 5 and the image are like two sides of the same coin and, in this description, image information 5 is expressed simply as image 5. In the figure, the concept of finding specified patterns with a dragonfly-like magnifying glass is shown. While omitted in the figure, it shows a state in which the specified pattern 1 has been found from the image information recorded across the entire range of the image 5 with the dragonfly-like magnifying glass.

As shown in the figure, the pattern 1 for this image 5 is coordinate combinations of color 2 information, represented as BL (black), R (red), G (green), O (orange) and B (blue) in Pattern 1 A, and brightness 3 information, represented by 5, 3, 7, 8, and 2 in Pattern 1 B. Image pattern matching 17 is realized when there is a relative coincidence between the color and brightness data of this pattern 1 and the position of its coordinates 4.

As explained above, there are three ways of composing query patterns 1: by appropriately combining colors and brightnesses as well as their positions based on human intent, by extracting specific pixels and their locations from a certain other images, or by combining these two to form the query pattern 1. The details are described below.

By assigning a certain width to the color and brightness data values at this time, as in query pattern B, and by further assigning a certain range to the combination's coordinates 4 and positions, the pattern matching method 17 can be expanded from complete image pattern matching to similar (ambiguous) image pattern matching 17.

Above is extremely simple and easy for human, but pattern matching information processing by the current CPU and memory is one of the information processing that consuming extremely load.

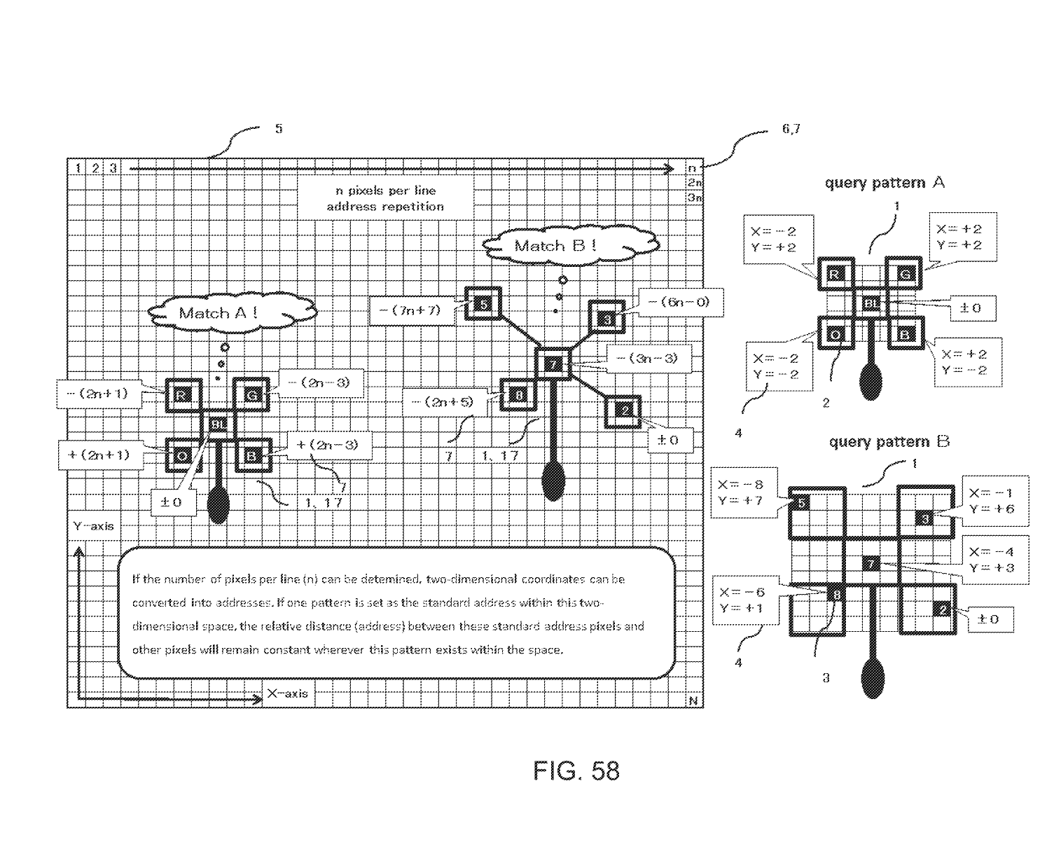

FIG. 58 explains the principle of image pattern matching using this memory having information refinement detection functions.

Images 5 are representative of two-dimensional information and are handled as the two axes X and Y. In any image 5, the number of pixels 6 composing the image 5 is fixed in both the X- and Y-axes. The sum of this forms the total number of pixels. In principle, the brightness 3 information and the color 2 information, consisting of the three primary colors 2 which form the basis of the image 5, are retrieved in this pixel 6 unit and recorded on the recording medium.

In computer memory, there are locations for recording information and absolute addresses 7 for specifying the locations of the recorded information. This absolute address 7 is specified one-dimensionally, or in a linear array, generally in hexadecimal values from address 0 to address N.

As shown in the figure, when recording two-dimensional image 5 information for each pixel 6 on the memory, lines are wrapped and repeated at the specified number of pixels (n, 2n, 3n . . . ) and written on the memory address up to address N. Addresses are generally expressed as address 0 to address n, but in this figure it is represented as an array of pixels from pixel 1 to pixel n, in order to give a more simplified explanation.

At the same time, while this explanation assigns addresses in order from the top of the figure for the sake of explanation, there is no problem whether the addresses are assigned in order from the bottom or whether it is wrapped around the Y-axis instead of the X.

At the same time, while the pixels 6 composing the image 5 only record a single type of data on the memory for brightness 3 information data, for color 2 information, the three primary colors R, G and B must each be independently recorded. Generally, this means there is a need to record three pixel information per pixel 6. It thus follows that, if color 2 information is recorded in three addresses per pixel 6, the actual memory would require three times as many addresses 7 as pixels 6. It goes without saying that if we know the number of pixels 6 (n) per line, we can easily convert this to what color 2 of which pixel 6 is recorded at what location on the memory, as well as the opposite of this.

The above sequences of pixels are common not only to image frame buffer information but also to compressed image data like JPEGs and MPEGs, as well as bitmap image information, and furthermore to artificially created images like maps and animation computer graphics—in other words, it is common to all two-dimensional sequence images. It is thus a basic rule for handling general images.

The two image patterns 1 A and B shown in FIG. 37 are image patterns 1 composed of five pixels 6 and their positions, with five pattern matching conditions. Pattern 1 A has color 2 information based on BL (black), including R (red), G (green), O (orange) and B (blue), arrayed at the pixel locations shown in the figure. Pattern 1 B has brightness 3 information, based on “2,” including “5,” “3,” “7,” and “8” arrayed at the pixel locations shown in the figure. The base pixel can be any pixel within the pattern. At the same time, the number of subject pixels (pattern match conditions) can be large or small. With technologies heretofore, it was necessary for the CPU to serially process the addresses recorded in arrays on the memory for the process of finding information based on such query patterns—in other words pattern matching using software was necessary.

What this means is that, because the information process called pattern matching was largely based on the CPU's processes, it differed largely from the true nature of pattern matching.

The present invention's memory having information refinement detection functions 51 (303) is structured so that pattern matching 17 can be conducted by information processing only within the memory, achieved by directly inputting patterns A and B as explained above. The pattern matched 17 addresses are then output, eliminating the time wasted through serial processing by the conventional CPU and memory method. Below is an introduction to these operating principles based on the above patterns A and B.

Memory having information refinement detection functions 51 (303) is a memory that can find coincidences for the specified data and further find coincidences for the relative positions of the arrayed information. And, both the above matching processes can be conducted within the memory.

As explained heretofore, two-dimensional coordinates are converted into linear arrays of pixel 6 position information based on their positions from the base pixel 6.

What should be noted here is that the relative distances between the pixels 6 of a pattern 1, composed of standard pixels 6 and surrounding pixels 6, are fixed in all places within the image space. This idea forms the basis of this invention. The above will be further explained later as local addresses 103 and global addresses 104.

While the above explanation is commonly understood when handling image information, the present invention can incorporate this basic truth into hardware as a semiconductor device and proves that it can be used for pattern matching 17.

At the same time, because each pattern 1, composed of multiple pixels 6 and their positions has a certain amount of sampling points 60, there is an extremely low probability that this pattern 1 combination may exist elsewhere.

It thus follows that not all the pixels in the pattern range have to be targeted. Rather, by selecting a suitable number of pixels 6 as samples, the specified pattern 1 can be refined and detected. Furthermore, an important characteristic of this invention is that effective pattern matching 17 can be conducted by detecting the entire pattern 1 through a combination of each part of the pattern 1. If the subject image is enlarged or shrunken down, or furthermore, rotated, pattern matching 17 can be conducted with a simple coordinate transformation. When the enlargement/shrinkage rates or rotation angle are unknown, the coordinate range for matching can be enlarged as in query pattern B in order to minimize the number of times pattern matching is implemented.

It is first important to widen the range of coordinates to be checked and to grasp whether there is a possibility that the subject pattern exists in this range. If there is no possibility that the pattern exists, we can quit here.

If the refinement is insufficient and multiple patterns 1 are matched, new pixels can be added to the sample to refine the search for finding the target pattern 1. As can be understood from the above principles of memory having information refinement detection functions 51 (303) and its application, the greatest point of this invention is that it can realize extremely high-speed detection of the specified pattern 1 using only the hardware, without using the information processing methods of the CPU.

The speed comparison of pattern matching 17 by the conventional CPU/memory and hardware pattern matching are as described in the background technology and it is equivalent to pattern matching based on 7 conditions (in the case of images, 7 pixels) being realized in 34 nS. This hardware pattern matching does not enlarge its circuit composition, as is generally the case for parallel operations, and instead realizes pattern matching with a structure composed of the minimum circuit scale currently imaginable. As a result, a device with large-scale information processing capacities for performing image processing becomes realizable.

The prototype machine introduced in the background technology was for complete pattern matching, pursuing high speed. While the addition of functions slightly increased processing time and reduced information processing capacity, it allows range specifications for the pixels 6 to be pattern matched 1 as well as the detection of similar images by specifying ranges instead of simply fixed values for the detection data values.

Even if the pattern matching time per condition for a device with appropriate functions and address sizes for images were to become about 1 microsecond, image text recognition technologies would largely advance. The details follow below.

If the subject image size is greater than the image processing capacity of the memory having information refinement detection functions 51 (303), the image need only be divided into segments and pattern matched per segment. In this case, the image should be divided so that there is an overlap the size of the image for pattern matching 17 in both the X and Y axes, so that the image pattern matching 17 is not affected by the dividing interval. Pattern matching can then be conducted so that the subject image can be pattern matched within one of the image segments.

Below is an explanation on local (relative) addresses 103 and global (absolute) addresses 104.

Current digital high vision images are composed of 1920 pixels in width (X-axis)×1080 pixels in height (Y-axis) for a total of 2,073,600 pixels. Image information per pixel is recorded on absolute addresses 7 linear arrayed from 0 to 2,073,599 pixels. The relative positions of any two pixels within this image space can be expressed as the distance between the one-dimensional global addresses 104.

On the other hand, if text like subtitles exist within this image, it is more convenient to use the local address, or the text unit of the two axis (X and Y) coordinates. If the subtitle text size in a movie is 128×128 pixels, this space is expressed as local addresses.

Local addresses can be converted into global addresses once the maximum value of the image width (X-axis) (1920 in the case of digital full high vision images) is determined. For instance, the local address 103 at X=0, Y=127 based on the local address 103 at X=0, Y=0, when converted into a global address based on “any pixel” is 128*1920=the 245,760^{th} pixel address. And, local address 103 at X=127, Y=127 converted into global address based on “any pixel” is 127+128*1920=the 245,887^{th} pixel address.

The distinctive feature of this memory having information refinement detection functions 51 (303) is that, through pattern matching assigning sampling points 60 to multiple global addresses 104, the above “any pixel” can be refined and the final matched “any pixel=address” is output as the absolute address 7. This is because pattern matching (hardware pattern matching) can be conducted on all pixels in the image in parallel (simultaneously). While it would take time, this method using two-dimensional arrays is also possible using the conventional CPU and memory processing.

A technology indispensable to text pattern matching using this technology will now be introduced.

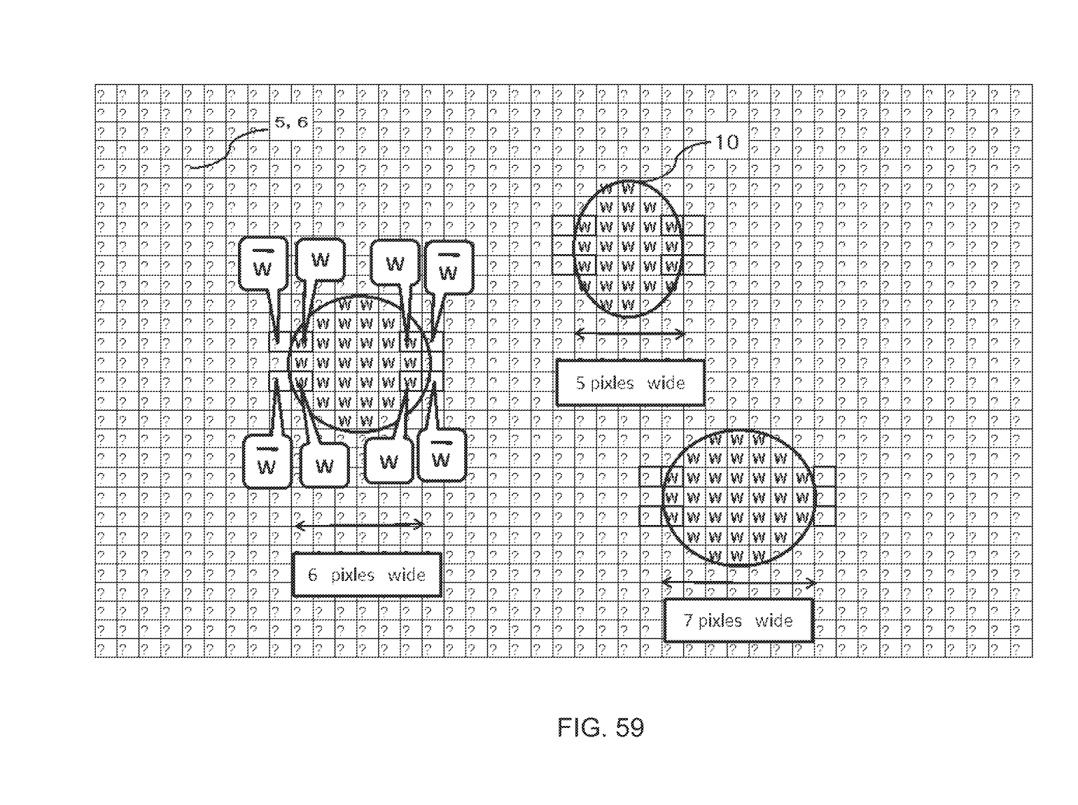

FIG. 59 is an explanation of exclusive pattern matching. It depicts an example of effectively detecting an object's 8 areas 9 and edges 10 from the pixels 6 in the subject image information 5. When searching for objects 8 with specific color 2 or brightness 3 areas, because an unlimited number of background patterns exist for the object, pattern matching 17 based on various color 2 and brightness 3 data must be repeated the necessary amount of times.

What is effective in this case is exclusive pattern matching 59.

This example shows an image with three spherical, ball-like white (W) objects 8 in the image. The edges 10 of the four balls can be detected using the four white ranges (W) of data 54 for specifying specific areas 9 of the 6-pixel wide balls 8, and the four non-white data (W(−)) 58 externally connected to it, in other words the exclusive data for white. This edge can be detected at the boundary between (W) and (W (−)).

In other words, only the white object 8 of a specific size, in this example the white objects (balls) with 6-pixel wide areas are detected. Because the white (W) width is excluded, be it 5-pixels wide or 7-pixels wide, an extremely precise object size detection becomes possible. While this example conducted exclusive pattern matching 59 for six completely neighboring pixels, by leaving a defined range gap for the ranges of (W) and (W (−)), slightly different sizes of the white object 8 can also be easily detected.

Because the exclusive data (W (−)) can be used for any background pixel 6 color other than white, if the eight or so pixels 6 can be pattern matched as in this example, the 6-pixel wide white ball can be found in an extremely simple way. This kind of exclusive data 58 for (W (−)) can be used on extremely simple principles in the case of memory having information refinement detection functions 51 (303) by once negating (inverting) the (W) output of the Content-Addressable Memory (CAM) function and rewriting this inverted result (W (−)) as CAM output (inverting the CAM output). This is extremely effective when there is a possibility that the background of the subject to be found is unspecified and possibly unlimited.

While this example depicts exclusive pattern matching 59 for the single color of white, complex images containing combinations of other colors can also be detected with an extremely small amount of pattern matching. When determining an object's shape with high precision, the number of pattern matching points and their positions simply must be appropriately selected.

Pattern matching indispensable to recognizing a moving object and tracking it will also become possible.

If an object in a video gradually changes in size and shape in each frame of the video, the form of the object per frame can simply be renewed and matched with the next frame. Tracking a moving object is a technology indispensable to video devices as well as security devices.

This technology can also be widely used for text recognition and fingerprints as well as pattern matching for one-dimensional information. This method of pattern matching is extremely powerful and will enable the heretofore-colossal process of image processing to become an extremely simple process. In general, text is formed from a certain color and its shape (area). Even if parts that are not text are a specific color, a specific design or a specific video, because the area outside can be specified by a color other than the text color, this exclusive pattern matching can be used to enable extremely simplified text recognition pattern matching.

It goes without saying that when all sampling points are taken from inside the text area, colored areas in the same color as this letter will also be pattern matched.

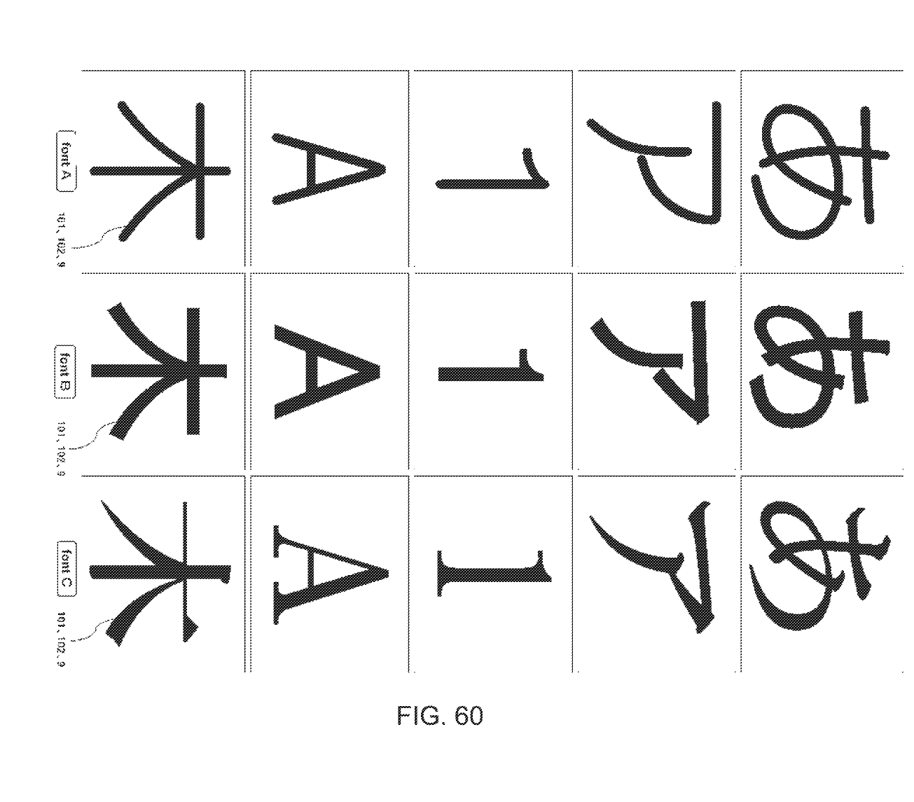

FIG. 60 is an example of text fonts.

The Japanese language, used in this example, is composed of a combination of various characters (letters). Of these, Chinese characters (kanji) that are especially large in number amount to about 2,000 letters in commonly used kanji and about 3,000 letters including complex kanji. Added to this, there are hiragana, katakana, Arabic numerals, the alphabet, and furthermore, symbols used in everyday life, amounting to a maximum of 5,000 kinds of letter symbols that must be recognized. The number of Chinese characters (kanji)—with the greatest quantity of letters possible—said to used in daily life in China are currently number around 6,000 to 7,000 letters. It thus follows that for Chinese, there is a necessity to recognize a maximum of 10,000 letters.

In order to commonly recognize all the letters in the world, there is a necessity to recognize about 20,000 letters. Furthermore, letters come in a variety of fonts 102, and this makes letter recognition even more complex.

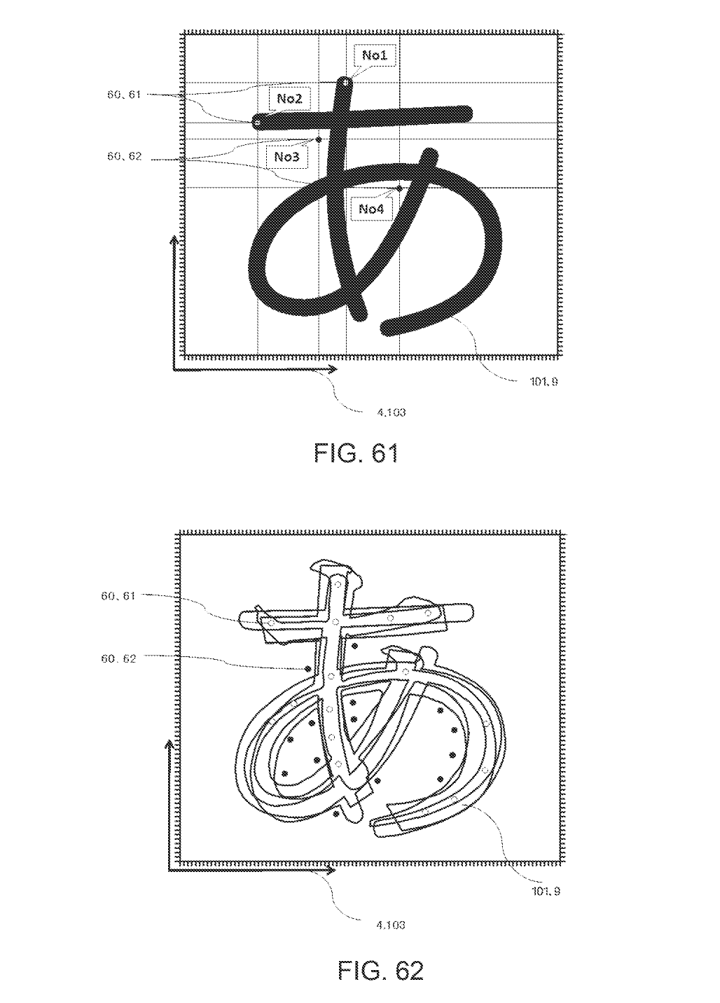

There are largely two different methods for recognizing text within an image. The first is extracting the characteristics of each of the letter fonts in the image and querying what the letter is based on these characteristics. Letter recognition using this method can be realized by the image and object recognition introduced in Patent No. 2012-101352 applied by the present inventor. The other method is to determine the multiple sampling points necessary for identifying the areas and non-areas of each letter font in advance and recognizing the images that match these sampling points as text. Because letter characteristics can be sampled ahead of time and parallel pattern matching on all text in the image is possible with this method, letters specified by the pattern matching can be recognized more effectively, faster and with greater precision than in the former method.
The present invention focuses on letter recognition using the latter method.
FIG. 61 is a diagram depicting Example A for creating letter pattern sampling points.

In order to recognize the specific Japanese letter [symbol] “a”, this example assigns four sampling points No 1, No 2, No 3 and No 4: two for sampling points that lie within the letter area (inside sampling points) 61 and two sampling points that lie outside of the letter area (outside sampling points) 62. These are assigned on the coordinates 4 of the local address 103.

Pattern matching 17 is conducted in the order of No 1, No 2, No 3 and No 4. While this order can begin anywhere, the local address coordinates specified as No 1 will be output as the absolute address 7 of the matched global address. These four sampling points 60 are assigned as shown in FIG. 58, the local addresses 103 of each of the X and Y axes are assigned as coordinates 4.

These two kinds of sampling points 60 are for specifying whether the said sampling point and its surroundings are part of the letter area or not.
For general letters, the area (dimensions) of the area within the coordinate 4 space is smaller than the area (dimensions) outside the area. While the probability that a letter area exists would fall under ½, conversely, the probably that a non-letter area exists would be over ½.
As shown above, when both the number of sampling points in the area 61 and the number of sampling points outside the area (non-area) 62 are equal for any letter, the average probability that each of the coordinates 4 for one sampling point falls within the letter or outside it would be ½. It thus follows that the probability that the above four sampling points matches would be around 1/(2*2*2*2)= 1/16.

To be more precise, the central coordinates have high probabilities of being within the letter area, while the corner coordinates have a low probability of being within the area. Making full use of this quality, the corner coordinates can be used as sampling points in the area, while the central coordinates can be used as sampling points outside of the area, thereby lowering the probability of mismatches and improving recognition probability. It goes without saying that the more sampling points there are, the higher the identification capacity becomes. However, with more sampling points, pattern matching time also increases, so it is necessary to determine an appropriate number of sampling points.

As one example, when creating a pattern with twenty sampling points, identification probability becomes one one-millionth, while creating a pattern with 30 sampling points would yield an identification capacity of one-one billionth. Even in cases where a few of the sampling points cannot be accurately read, due to blurred letters or foreign objects resulting from the quality of the printed letter or paper quality, the pattern match can be structured so that if the greater half matches, it passes.

It goes without saying that this method can be commonly used for any kind of letter. And patterns created from about 30 or so sampling points are sufficient, even for commonly recognizing letters from across the world or for calculating safe recognition rates.

FIG. 62 is a diagram explaining Example B for creating letter pattern sampling points. A number of fonts for the specific letter [symbol] “a” are layered and sampling points within the area 61 are assigned to areas that match all layers, while sampling points outside the area 62 are assigned to areas that fall out of the letter area for all fonts. A total of 30 of these sampling points are assigned to the letter.

By separating the letter into sections that match the letter areas of representative fonts 102 and those that do not belong to the area of any font, as described above, and assigning the appropriate sampling points, common pattern matching can be conducted for letters other than special fonts 102.

In the rare case that multiple letters are recognized and selected, the sampling points of this letter can be partially revised.

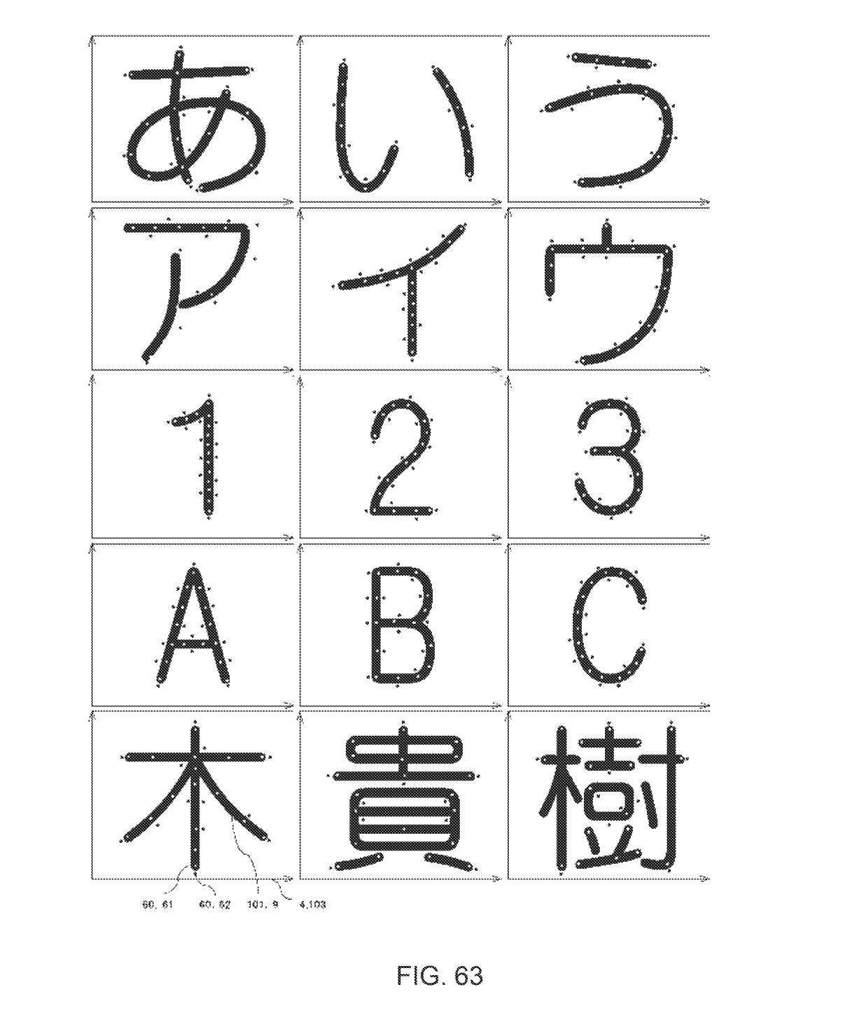

FIG. 63 depicts an example of creating letter pattern sampling points for a specific font. Thirty sampling points have been assigned to each letter based on the above explanations. Such sampling points for pattern matching need only be created for five thousand letters in Japanese and ten thousand in Chinese. Even for all the letters in the world, about twenty thousand letters are sufficient.

These sampling points are creating using fonts 102 with large letters. For small letter sizes, the coordinate 4 values can be automatically shrunken down and pattern matched. It follows that once these sampling points are created, they can be used forever and will become a common asset for mankind.

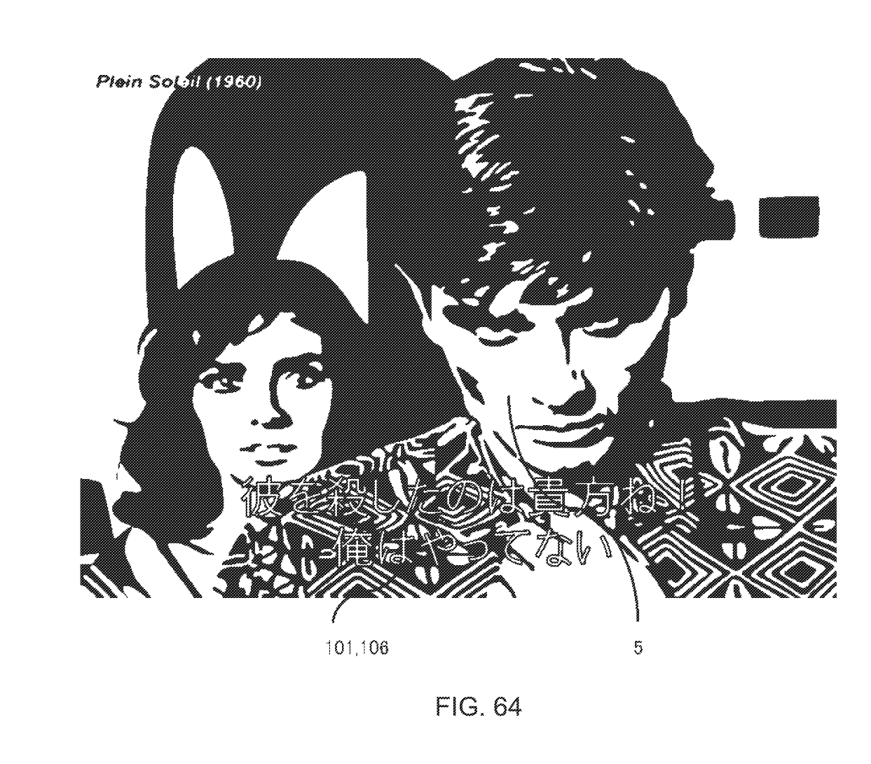

FIG. 64 is an example of letter recognition for an image with a subtitle.

Subtitles are a must for foreign films.

For movie subtitles, a maximum of two lines of subtitles appear per scene. These lines contain about forty letters and are displayed for about one to five seconds. Because the memory having information refinement detection functions 51 (303) offers complete hardware pattern matching, pattern matching can be conducted once within one microsecond. With thirty sampling points at one pattern matching per microsecond, each letter would take 30 microseconds. For Japanese, with five thousand letters, pattern matching would take 0.15 seconds and, even for the ten thousand Chinese letters, it would take 0.3 seconds to pattern match all the letters on one screen. And, for the twenty thousand letters across the world, it would only take 0.6 seconds to pattern match all the letters on one screen.

When the font size is unknown, pattern matching can be conducted by changing the sizes of the letters that appear frequently. For Japanese, the fifty frequently used hiragana letters can be pattern matched. If the subject letters can be determined as a type of text or a form like movie subtitles, pattern matching can first be conducted at the standard font size for such formats. The size at which the necessary number of absolute addresses 7 is returned would be the letter size. It is also possible to conduct letter recognition for special fonts by preparing sampling points for special fonts. For the letter color, pattern matching can be conducted, generally with black or white, then with red, blue, green or a neighboring color.

A minute would be sufficient, even for conducting all of the above pre-processing processes. For movie subtitles, the font, letter size and color generally stay the same from start to finish, and the subtitle's position is fixed. Thus a system for real-time letter recognition in any of the world's languages will be made possible.

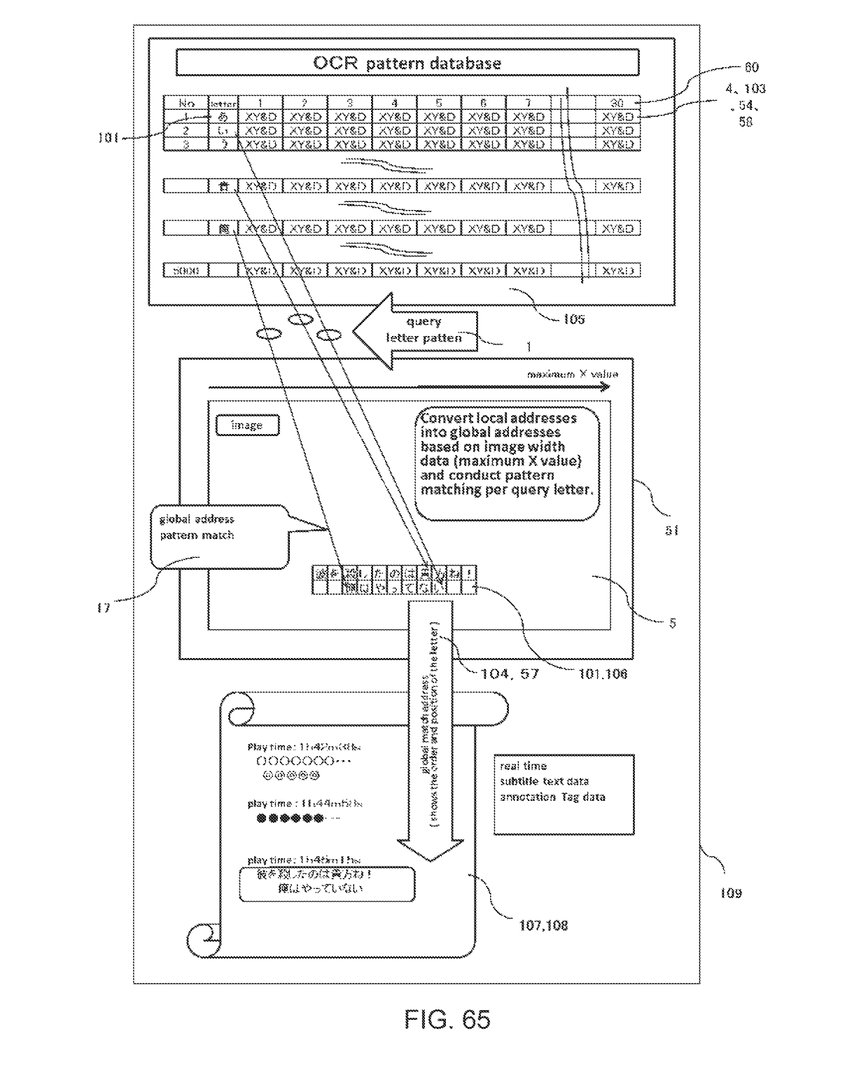

FIG. 65 is an example of an information processing device equipped with real-time OCR functions.

As shown in the figure, an OCR pattern database 105 for pattern matching 17 sampling points No 1 to No 30 for each of the five thousand letters in the Japanese language is registered. While this example is for Japanese, English, Chinese, or a collection of all the world's languages can also be registered.

The “XY” local address 103 per letter 101, the “D,” in other words data 54 for specifying the color 2 and brightness of the letter 101 area, and exclusive data 58 for specifying the color 2 and brightness of outside areas are registered for each sampling point 60. This data 54 and exclusive data 58 can be separately specified and registered collectively. The minimum requirement is to clarify whether each of the sampling points 60 are sampling points within the letter 101 area 61 or sampling points outside the area 62.

Memory having information refinement detection functions 51 (303) is further incorporated into this device, and the image information 5 subject to letter recognition are recorded on this memory 51 (303). Letters are specified one at a time from the abovementioned database and pattern matching is conducted five thousand times. At this time, the only thing necessary for pattern matching 17 is to understand the letter color and size and convert the local address 103 into a global address 104.

The high-speed, accurate specification of these processes to the memory having information refinement detection functions 51 (303) will be enabled by the CPU. If there are matching letter(s) 101 for the query pattern 1 on the screen recorded in the memory having information refinement detection functions 51 (303), the matched address(es) will be refined and the pattern matched 17 absolute address(es) 7 output. These absolute address(es) 7 would be at position No 1 of the sampling points 60 specified by the local address 103. If there are multiple letters that can be pattern matched 17, absolute addresses 7 equal to the number of letters will be output.

The absolute address(es) 7 above need only be read by the CPU and the CPU need only conduct the necessary processes.

From the above explanations, the CPU would not need to conduct any process related to letter recognition. All it would need to do is oversee the entire letter recognition process, assign pattern matching commands to the memory having information refinement detection functions 51 (303), read the pattern matched results (absolute addresses 7) and conduct the necessary processes from these results. For Japanese only, with five thousand letters, all pattern matching can be conducted in 0.15 seconds. In general, for movie subtitles, the letter color is white and the font 102 is fixed and does not change.

What must be taken into consideration is letter noise due to block noise particular to digital images. Data 54 ranges can be specified or appropriate filters used for these color or brightness noises to enable pattern matching.

If the letters recognized using the above pattern matching can be formatted into text data along with the times at which they were played, this text data can also be used as annotations for the movie scenes.

HDD (hard disk drive) recording devices now come in over several T (tera) bytes of information recording capacity and recordable time surpasses several hundred hours. If you want to see an image that you have recorded, you may find that you can't remember the program name or title most of the time. Furthermore, you may have no clue where the scene you want to see is.

For household recording devices, methods like adding chapter marks to scenes that you want to see again or making thumbnail images for later reference are common. However, adding chapter marks at the right time to fit your purposes may be complicated and difficult. In this case, you can search for the memorable scenes you desire by searching the text annotation data 108 extracted from the subtitles.

For TV images, subtitled scenes generally appear at the beginning of a program or at important movie scenes. By extracting the subtitles from these important scenes in real time and making searches of this text data possible, recording only the scene with the specified search letter information (in other words, by registering people's names, recording only the images in which the person appears) becomes possible.

If only the scenes in which your favorite singer appears in a music program can be recorded, you would be able to eliminate wasted time looking through other scenes. Another application example is the synthesizing of speech and braille through text data.

The above is the same for Internet information.

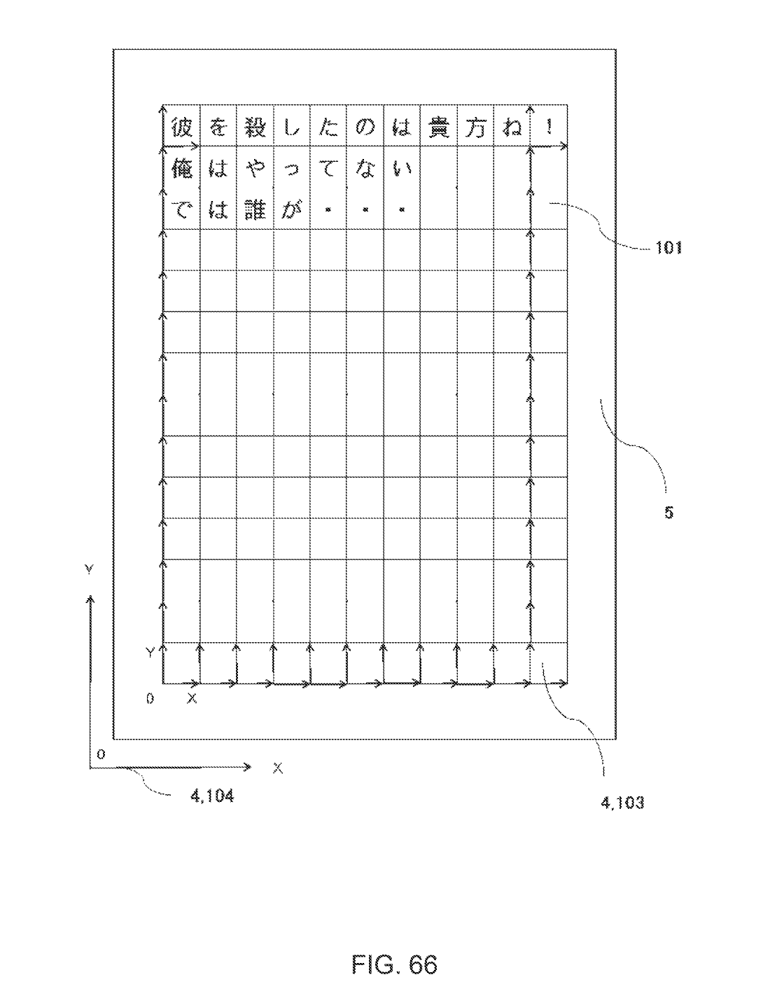

FIG. 66 is an example of letter recognition in a text image.

As shown above, if pattern matching through parallel processing on hardware, the distinctive feature of this method, is used, the time required for pattern matching would be fixed no matter how many letters are included in the image. It thus follows that, even for the aforementioned movie subtitles or for text images with several hundred letters, letter recognition per screen can be conducted in the same amount of time.

At the same time, by rotating the local address coordinates, rotated letters, upside-down letters and complex texts combining such letters can all be flexibly recognized. This letter recognition device can be composed without the use of complex software algorithms and without enlarging the size of the device.

When printed text is read using a scanner, there are cases in which a few sampling points cannot be pattern matched, due to blurred letters or foreign objects. When even one of the sampling points cannot be pattern matched, there is a possibility that the subject letter cannot be recognized.

When the subject image letter is not in good quality, it is effective to use memory having information refinement detection functions 51 (303) equipped with counter functions. Using the counter function, for instance, a match of over 25 points out of 30 points can be specified as passing, and these absolute address(es) 7 can be recognized and output.

When letter quality is not such a big problem, letter recognition can be guaranteed by changing the order of sampling points and repeating a number of times. And, while it would take time, this method using two-dimensional arrays is also realizable using conventional processes with the CPU and memory.

While the present invention has been explained focusing on complete pattern matches, by making range searches for sampling point positions possible, similar patterns can be matched and this can be applied to handwritten letter recognition as well. While there are an extremely large number of letters that humans can recognize, the number of letters that humans can recognize at once is limited. In other words, letters simply appear as image if we do not take the time to read them. It thus follows that this method has recognition capacities that far surpass letter recognition by human beings.

There are no precedent examples of letter recognition using pattern matching that actively incorporates the fact that arrays of letter areas in an image can be simply converted from local addresses to global addresses. While letter recognition with the present invention's pattern matching can fundamentally solve the problem of wasted search time by using memory having information refinement detection functions 51 (303), the process is also realizable through serial processing using conventional methods of the CPU and memory.

The present inventor has heretofore filed patents related to three important categories of recognition for human beings, using the high-speed pattern matching capacities of the memory having information refinement detection functions 51 (303). The prior applications were for image and voice recognition and the present application for letter recognition. The greatest feature of this invention is that, like video images, necessary information can be recorded each time it appears on one memory having information refinement detection functions 51 (303), the necessary letter, image and voice recognition can be conducted and, in the next moment, it can be used for the recognition of new, completely different information. This is similar to information processing in our brains. It is difficult, even for us humans, to simultaneously focus all of our five senses. We are generally focusing on either image, voice or text for our processes. From this, we can say that the memory having information refinement detection functions 51 (303) can be expressed as a general brain chip.

The memory having information refinement detection functions 51 (303) can collaborate with the CPU to transform the computer into an even smarter, more powerful device.

### (Standardizing Pattern Matching)

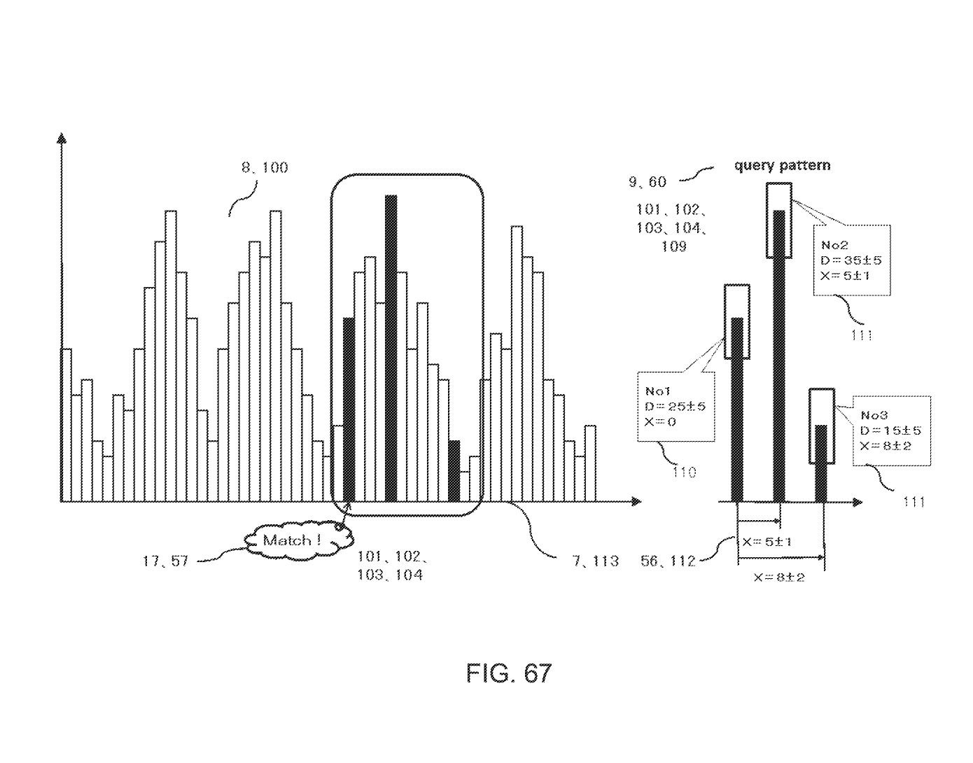

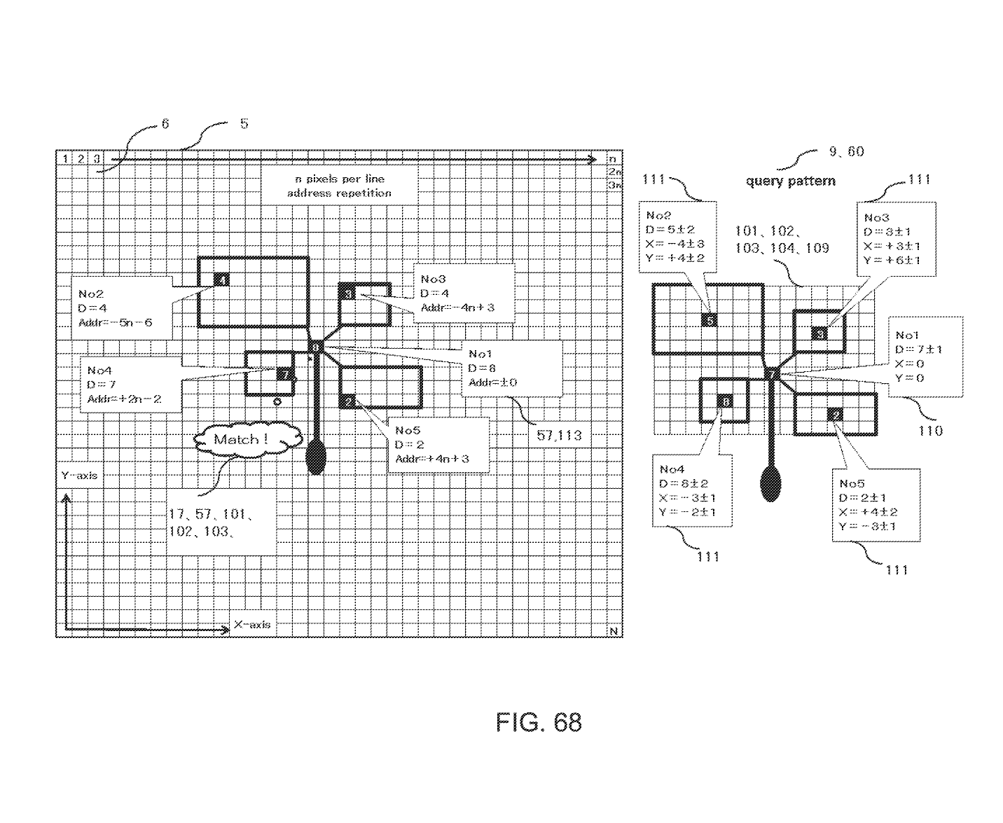

Below, the standardization of pattern matching is explained using FIGS. 67 to 72. Please also note that, in the explanation below, the reference codes are kept as is so that its relationship to the basic application's declaration of priority can be easily understood.

When thinking about the standardization of pattern matching for array information, or lumps of information, the most important and basic thing is what forms the base of the pattern matching. Roughly grouping, this refers to whether a specific data forms the base, whether the positions of the specific data form the base or both form the base. Furthermore, the definition of data position becomes especially important.

A simple match between a pair of information is relatively easy, however, even pattern matching for complex information must be simple and realizable to be useful. In this invention, when pattern matching information in the subject array information, the foundation is formed by first specifying the candidate data likely to be included in the desired pattern (that you want to find) and setting this as the base information.

At the same time, in the present invention, because it is possible to specify the relative relationship between the above candidate data and other information for matching by both coordinates and distance, it is simply expressed as position.

The following explanation describes the method of specifying information data 101 and its location 103 as local coordinates 112.

In concrete terms, one of the above candidate data with a high probability of being found is first taken as the base, and another data different from this base data forms a pair of data. The method of judging whether both these relative coordinates match is adopted, then, expanding upon this idea, the base data is placed constantly on one side of the pair of data and matching is repeated to simplify the pattern matching. Of course, if there are no candidate data that may be included in the desired pattern (that you want to find), pattern matching will not be possible, and the process can be stopped here.

The pattern matching method based on the idea of data and its position can be generically used from one-dimensional to multi-dimensional information and for any number of pattern matching samples. This forms the very basis of the present invention.

What must be focused on in this kind of perspective is that Content-Addressable Memory (CAM), is a hardware device for memory-based architecture (for finding specific information within a large amount of data). And as such, it can find (match) simple information, but cannot find complex information like patterns. Because it must constantly rely on the CPU's power, it is currently only used in special fields like the detection of IP addresses for large-scale high-speed communication devices.

Next is an investigation of ambiguous pattern matching in information processing.

Ambiguity in the current computer memory's array information can be found only in two areas—the ambiguity of information data for recording and storing on the memory and the ambiguity in the addresses at which they are recorded and stored on the memory. In other words, because patterns, which are sets of information, are recorded and stored as information arrays based on a certain definition, if these two can be ambiguously information processed, recognition that is truly close to that of a human being will become possible.

It thus follows that ambiguous pattern information in information processing assigns a width (range) to information (data values) and can be defined as information arrays in information sets that store information (data values) with widths (ranges) on the stored addresses.

However, the conventional memory, due to its nature, currently cannot make the data values themselves or the stored addresses ambiguous. If this approach is changed and the information to be recorded (data values) and addresses to be stored are fixed, ambiguous pattern matching can be realized by adding ranges (including maximum, minimum, above and below) to both the data values and their positions for the query pattern(s) 9 used for detection.

In the above way, ambiguous pattern matching handling ambiguous patterns using a generic semiconductor memory becomes possible.

Using this method, the information (data) and their locations (memory addresses) can remain as usual, and the array can also be a normal information array.

FIG. 67 shows an example of pattern matching for one-dimensional information.

Because chronological data, like stock prices and temperatures, text data and DNA data are representative types of one-dimensional data, they need only be sequentially recorded and stored as data values per address on the linear-arrayed memory, after determining the first address to be written. Of course, at this time, it is possible to store information in order for every two addresses or three addresses, leaving space between each address or two addresses. Although it is customary to write addresses starting from small values, the reverse is also possible. The only thing required is that the information storage is defined (arrays).

In this example, the information on the database 8 is explained as absolute addresses 7 and global addresses 113, while the information data 101 and its position 103 for pattern matching are explained as relative addresses 57 and local coordinates 112.

First consider an example of a chronological database containing the maximum temperatures per month for a certain city.

As mentioned above, due to the definitions defining maximum average temperature per month on the database, the chronological temperature data is recorded and stored (arrayed) without ambiguity. However, the temperatures that humans feel are ambiguous, and do not have an absolute scale. For instance, scales that represent hotness include extremely hot, hot, comfortable, cold or extremely cold—ranging from five levels to at most ten levels.

When trying to find patterns like abnormal climate from such data that contains no ambiguity, extremely hot can be set at 35° C., hot at 30° C., comfortable at 20° C., cold at 10° C. and extremely cold at 5° C., and each of these data can be assigned a ±5° C. range. At the same time, the times until they change can also be assigned a fixed range (in this case, ±1 or two months). By pattern matching this range, temperature analysis based on ambiguous pattern matching similar to human beings becomes possible.

Pattern matching 17 using this method involves selecting the base (candidate) information 110 in advance, assigning the match information 111 one by one on the subjects for pattern matching, shaking off the candidate base information 110 that do not match the match information 111, and designating the remaining address(es), left after the set number of matching is complete, as the matched address(es) 57. It thus follows that the most important point when creating the query pattern 9 is the sampling point 60 that becomes the first base. In this case, three pieces of data are set as sampling points and the base information 101, No 1, is the left sample. While there is no problem in selecting either the center or right sampling points, it must be data that can be expected to exist. It thus follows that the data with the highest probability (the middle data value) is selected in this case. By appropriately selecting the data range for No 1, the mismatch probability can also be reduced. If there is nothing corresponding to this data, pattern matching can simply be quit.

As shown above, the base information 110 for pattern matching in this example is No 1. Based on this No 1, data that matches both No 2 and No 3 is found.

Finding information No 3 does not depend on its relative position to No 2, and the fact that the matching between No 1 and No 3 is found is the starting point of this invention.

As will be described later, this principle is of the greatest importance, even when the number of sampling points increases. It thus follows that it is wiser to not set a range to the position of base sample No 1 (there is problems in setting a range to data value).

This example shows a case in which a pattern 1 that matches the query pattern 1 exists (pattern matches 17) within the database 8.

While the above example is for pattern matching 17 for three groups of information data, the combinations of information data can be as many as desired. At the same time, the data 101 values and their ranges 102 for these three information data 101 can be set voluntarily, and this data position 103 as well as its position 104 can also be set freely.

It goes without saying that either the range 102 of the data value or the range 104 of its position can be “0,” and when both are “0,” there is a complete pattern match.

FIG. 68 shows and example of pattern matching for two-dimensional information.

Image information and map information are representative types of two-dimensional information.

Generally, this kind of two-dimensional information is sequentially recorded and stored (arrayed) on the linear-arrayed memory per X-axis line by a raster scan method (wrap around) for either the X or Y axis. Just as with one-dimensional information, it does not matter whether it is recorded from the left or right on the X axis or whether it wraps around at the Y axis. The only thing necessary is that the information storage (array) definition is defined.

The figure depicts the concept of finding the specified query pattern 9 with a dragonfly-like magnifying glass. It represents the detection of the specific pattern 1 from the entire range of image information 5 recorded on the image 5 using the dragonfly-like magnifying lens.

As shown in the figure, the pattern 1 from the image 5 contains five pixels 6 from No 1 to No 5, in this case, brightness value data like 7, 5, 3, 8 or 2. The locations of these pixels 6 contain a range, and the example depicts an ambiguous pattern match 107 setting. The pixel at sampling point No 1 has a data value 7±1 at X=0, Y=0; in other words, it is the base point (origin) for the local coordinates and is the base information 110. The pixel in sampling point No 2 has data 101, 102 value D=5±2 and X=−4±3 and its position 103 is set to contain a range 104. Ambiguous pattern matching 17, 107 is conducted by detecting the address(es) and coordinate 4 position(s) at which there are relative matches to the query pattern's 9 color and brightness data from the subject image information 5.

This kind of ambiguous pattern matching for images becomes an indispensable tool for image recognition.

As shown in the figure, if the pattern matching address 57 exists and the query pattern 9 specified by the local coordinates 112 is detected as an absolute address 7 on the information arrays on the memory, the positions of each pixel 6 composing the pattern can be found—in other words, the pattern 1 can be detected as a lump of information.

As noted with one-dimensional information, what is especially important is the sampling point 60 that will form the first base information 110. In this case, five pieces of data are taken as sample points and the base information 110 No 1 is a sample from the central area of the pattern. However, any other sampling point can also be selected as the base information 110. This time, the base information 110 for pattern matching 17 is always No 1, and relevant data is found from the range between No 2 and No 5, based on this No 1. If No 2 and No 3, No 3 and No 4 are sequentially matched, the range will gradually expand and dissolve. While a range can be intentionally assigned to the position of sampling point No 1, it is wiser to generally not set a range for base sample No 1, as with one-dimensional information.

This method of pattern matching relies on sampling points 60 selected from the large number of information contained within the pattern 1 range. Supposing there were 256 kinds of information data 101 values and the data is uniformly scattered, the probability that two kinds of data are at the intended relative array is 1/256, the probability that three kinds of data are at the intended relative array is 1/(256×256), and this probability is even lower for four kinds of data. It thus follows that, by selecting a few appropriate sampling points, probabilistically, the pattern match candidates (base information 110) can be refined and the specific pattern selected (pattern matched 17).

However, for the aforementioned cases of ambiguous 5-level pattern matching for temperatures or when ranges are set for data positions, the probability of matches increases and pattern refinement becomes insufficient, with many addresses output. In such cases, it is important to increase the number of sampling points as necessary and conduct pattern matching fit to the necessary purpose.

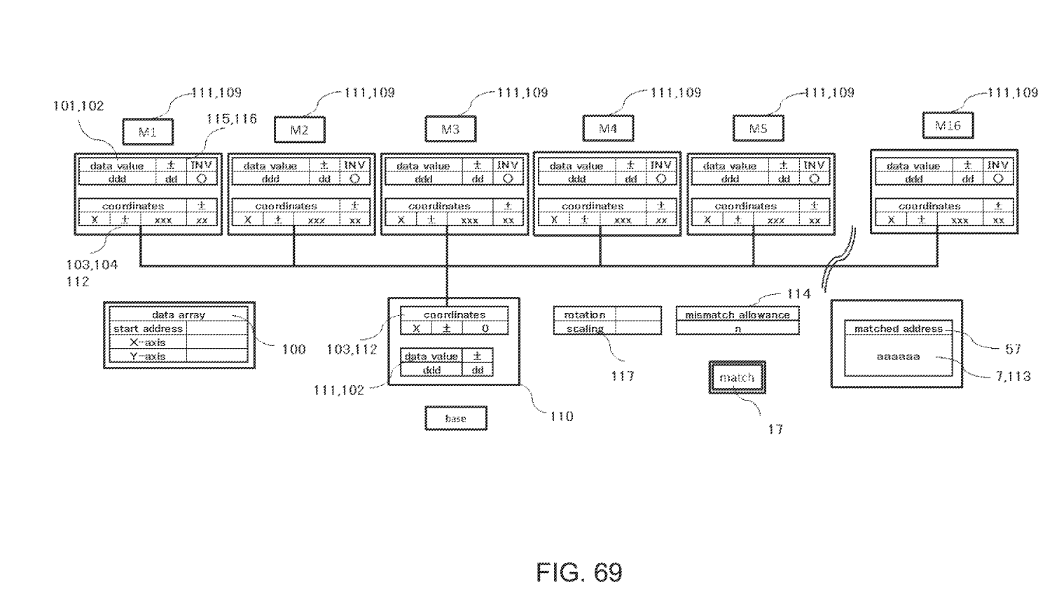

FIG. 69 is an example of a GUI for one-dimensional pattern matching.

A GUI (Graphic User Interface) for inputting query pattern 9 data is necessary for effectively and easily using the present invention. This example is a GUI for one-dimensional pattern matching.

In this example, the subject information on the data array 110, the first address in the database addresses and the X and Y axis sizes can be set. Because this example uses one-dimensional data, only the first address and X axis (data size) must be set. For two-dimensional information, simply set both the X and Y axes. In either case, matching is conducted based on the relative positions of the information specified by the local coordinates, and it is possible to find the matched address at the end.

This example shows a GUI that enables pattern matching 17 on the base information 101 in the match order M1 to M16, for one to sixteen samples of match information 111. While this example takes 16 samples of sampling points 60, this is not the only possibility and this number can be increased or reduced.

Furthermore, there is no need for data specification on all information from M1 to M16. The necessary number of samples can simply be specified and used. The data position 103 of the base information 110 is fixed at the coordinate origin (X-axis=0, Y-axis=0), and this example is structured so that there is no range 104 setting for position.

Data values 101 and ranges 102 can be input for the base information 110. The sixteen match information 111 from M1 to M16 are each structured so that the data values 101 and their ranges 102, as well as the information positions 103 and their ranges 104 can be specified as local coordinates 112.

By conducting pattern match 17 commands based on the above query pattern 9 settings, information processing 10 is implemented and its result is output as a matched address 57, in other words an absolute address 7 or global address 113. Of course, in this case, if multiple addresses are pattern matched 17, multiple addresses are output, and if none are pattern matched, none are output.

It thus follows that the crucial point is to select a suitable number of sampling points 60 for the pattern matching 17 purpose and to set ranges for the data and its positions.

The above forms the basis of this invention's standard pattern matching 17. However, as an example of optional functions, this example is structured so that exclusive pattern matching 116 can be conducted by specifying exclusive data 115 to data values from M1 to M16. Of course, it is also possible to structure it so that the base information 110 is exclusive data 115.

Furthermore, with this example's optional function, when multiple data is specified to information M1 to M16, it can allow some of them to not be able to pattern match 114.

This kind of structure enables ambiguous pattern matching to function even more effectively. And by further enriching optional functions like transforming coordinates to distances, a GUI that is even easier to use can be completed.

In the case of one-dimensional information, no special setting is necessary other than when the data array 100 is in a special kind of array different from linear arrays. Of course, by making the data 101 and the data positions 103 both at a range of “0,” complete pattern matching becomes possible, and either of the two can be set with a range to freely adjust the degree of ambiguity.

With the above structure, a common GUI can be used in pattern matching for stock price information, temperature information and one-dimensional information like text.

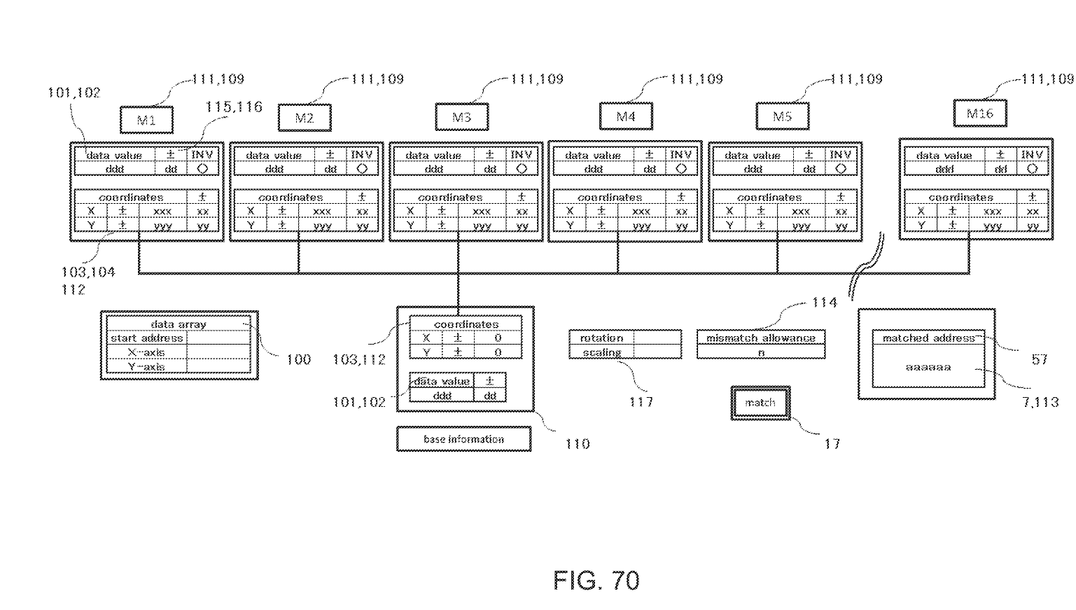

FIG. 70 is an example of a pattern match GUI for two-dimensional information.

Its basic structure is exactly the same as for one-dimensional information. However, for two-dimensional information, the positions of the base information 110 and match information 111 are in two-dimensional local coordinates 112 with an X and Y axis. At the same time, this example is structured so that the data arrays for two-dimensional information can be input both for the X- and Y-axes and global addresses 113 and absolute addresses 7 can be converted from local coordinates 112. In two-dimensional information like images, information is sometimes enlarged, shrunk or revolved. In such cases, the coordinate transformation 117 function can be used to transform a single query pattern into a variety of coordinates and conduct pattern matching.

By adopting a structure like this example, a common GUI can be used for pattern matching two-dimensional information.

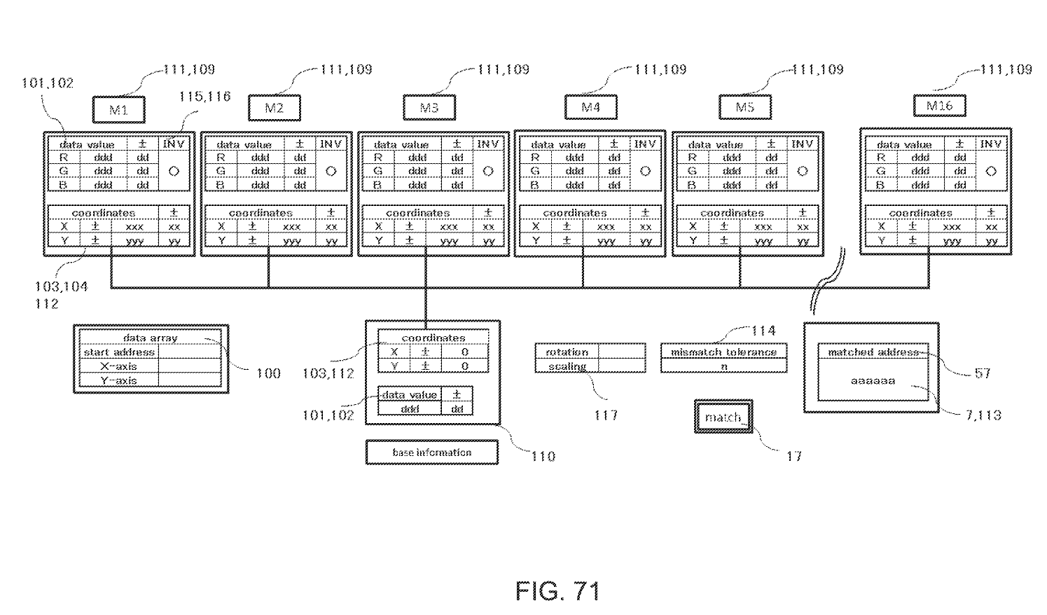

FIG. 71 is an example of a GUI for image information pattern matching.

Color 2 images contain color 2 information per pixel 6, and R, G and B are independently recorded. Thus, in order to set a pixel 6 as a global address 113, each color 2 information is able to be set at each global address 113. By using this method, pattern matching based on the unit of pixels 6 becomes possible.

Three kinds of GUIs have been introduced now based on the above definition of pattern matching. However, various applications are possible, such as integrating these GUIs into a single GUI or selecting and using the best fit GUI for the subject information.

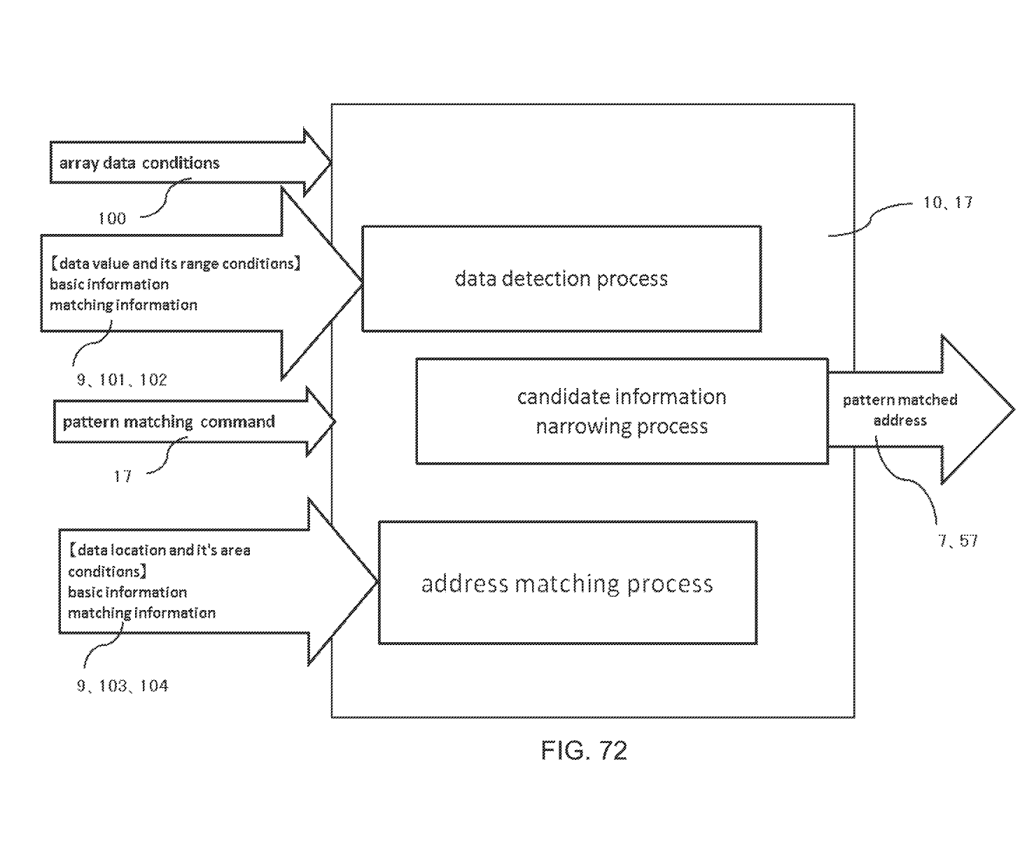

FIG. 72 is a conceptual diagram for pattern matching using this method.

Both the query pattern 9 data 101 and its range 102 as well as the query pattern 9 data's position 103 and its range 104 are set, and by running the pattern match command 17, information processing is conducted. Condition setting and information processing are free to be collectively or separately conducted.

The basis of this idea is that, through data detection processes 10 based on the query pattern(s)' 9 data 101 and their ranges 102 along with the address matching processes 10 based on the query pattern(s)' 9 data positions 103 and their ranges, the pattern match candidate(s) initially set as the base information 110 can be sequentially refined 10 and the remaining absolute address(es) 7 can be output as the pattern matched address(es) 757. Patterns are recognized by finding these absolute address(es) 7; and the position(s) of these pattern(s) are detected.

Information processing with the above structure can be conducted either through conventional information processing 10 by the CPU and memory or furthermore by dispersing and parallel processing 10 the information subject to pattern matching 17. The form of information processing can also be freely chosen. It goes without saying that it can also be realized by memory having information refinement detection functions.

Generic databases are almost always composed of one-dimensional or two-dimensional information, making this pattern matching highly applicable for general use. As long as the information data can be freely composed, by forming arrays fit to this pattern matching principle, effective and efficient pattern matching becomes possible. To give an example, even higher dimensional information can be commonly used as long as they are arrays recorded and stored by piling up two-dimensional information.

The main points of the present invention described above are as follows. First, its greatest foundation lies in information arrays. Thus, by specifying this array composition, selecting the pattern match candidate(s) (base information) included in these arrays, and specifying the mutual match(es)' (matched information 111) data value(s) and position(s), information processing for pattern matching can be standardized. Furthermore, by defining ranges for data values and their positions, ambiguous pattern matching can be realized, and all types of pattern matching can be standardized.

Information positions can be either coordinate values or distances, and either can be used. The quoted Patent No. 2005-212974 literature (which will be incorporated into this detailed description with this statement), proposes methods for defining information positions with Euclidean distance, the spatial distance of Manhattan distance, or furthermore with chronological distance, based on the information types and their purposes.

In the present invention, any space, chronological or mathematical distance, conceptual coordinate or distance can be converted and used as the present method's position.

### (Summary and History of the Present Invention)

Set operations, represented by words like search, verify and recognize by programs using the conventional CPU, involve finding specific information from a set of information recorded on the memory, and it is thus a method for serially accessing the information (elements) on the memory, reading and finding the solution to the set operation.

It thus follows that the process is slow and power consumption inevitably becomes large.

From the above reasons, as opposed to information processing on elements, a new type of processor that can collectively (“lump-sum”) set operate the entire set becomes indispensable.

Because of the fact that the physical memory itself, from which information is searched, is composed of only two elements (addresses and memory cells), if these two elements can be freely controlled, even more high-level information processing can be possible. This was something I felt, but it took a little more difficulty to replace mathematical set operations, the ultimate form of finding specific information, with the concept of set operations including information processing location.

In conventional set operations on elements, information locations (addresses) were something like an unspoken agreement that never came to the forefront. However, set operations using this method cannot be realized without locations (addresses).

It goes without saying that the idea for the above memory having set operating functions 303 was born from the fruits of the invention of memory having information refinement functions and various applications.

This invention, in a sense, simply replaces the match counter 21 in memory having information refinement detection functions 302 with a generic set operations circuit. However, a great amount of labor has been expended in generalizing the utterly complex concept of set operations that include address locations, as represented by ambiguous pattern matching and edge detection.

This is all owing to the desire to apply the memory having information refinement detection functions 302 to even more convenient, wide-ranging information processes—the idea at the starting point of this invention.

The above explains the preferable embodiment forms of the present invention. However, the present invention is not limited to such embodiment forms, and it goes without saying that various transformations are possible within the range of the invention's outline.

For instance, in one of the above embodiment forms was a GUI (graphic user interface) as displayed on computer screens. However, this is not limited to GUIs, but includes all kinds and display forms (including non-display) for user interfaces.

At the same time, the examples of image, text and voice pattern matching as described above can be implemented by fixing the state of arithmetic processing for the arithmetic circuits 224 in the memory 303 related to the present embodiment form.

What is claimed is:

1. A memory having a set operating function and capable of recoding information at each memory address and reading the information, the memory characterized by comprising:
an input section for inputting, from outside, a first input for comparing with information recorded on each memory address, a second input indicating a condition for a comparison of positions between each memory address, and a third input as a condition for performing a set operation, said third input being selectably specified as one of or a combination of two or more of set operation conditions which are (1) subset, (2) logical OR, (3) logical AND, and (4) logical negation;
a section for comparing information recorded on each memory address with the first input, determining if a result of the comparison is a match or non-matching, and generating and registering a flag indicating a match or non-matching at a respective memory address position;
a section for relatively shifting an address position where said flag is registered to another address position based on the condition indicated by the second input;
a section for performing, based on the third input, a logical set operation among flags at respective memory address positions registered based on the first input and the second input; and outputting an address position of the remaining match flags as a result of the logical set operation.

2. The memory having the set operating function according to claim 1, characterized by further comprising:
a section for repeatedly performing, with respect to the result of the set operation based on the first to third inputs, a set operation based on newly input first to third inputs.

3. The memory having the set operating function according to claim 1, characterized by further comprising:
a section for performing parallel processing of at least one of set operations on the information based on the first to third inputs.

4. The memory having the set operating function according to claim 1, characterized in that the first input includes:
a value representing information to be compared; and
a specification of one of complete match, partial match, range match and a combination thereof, as a comparison condition.

5. The memory having the set operating function according to claim 1, characterized in that determination based on the first input is performed by a content addressable memory.

6. The memory having the set operating function according to claim 1, characterized in that the second input includes:
a position of information to be compared, a certain area with reference to the position, or a combination thereof.

7. The memory having the set operating function according to claim 6, characterized in that the position of information to be compared includes:
a relative position, an absolute position, or a combination thereof.

8. The memory having the set operating function according to claim 1, characterized in that the section for determining based on the second input is performed by a section for parallel operating of the memory address.

9. The memory having the set operating function according to claim 1, characterized in that:
the input section is for further inputting a fourth input (image size and the like) for designating an array or order of information, and
determination of the information is performed based on the array or order specified by the fourth input.

10. The memory having the set operating function according to claim 1, characterized in that the first to third inputs specify a query information pattern for pattern matching with set information recorded on the memory.

11. The memory having the set operating function according to claim 10,
wherein the query information pattern is query information for edge detection.

12. The memory having the set operating function according to claim 10, characterized in that the pattern matching is performed on either one of:
one-dimensional information, an example of which is text information;
two-dimensional information, an example of which is image information;
three-dimensional information, an example of which is video information; and
N-dimensional information, in which information array is defined.

13. The memory having the set operating function according to claim 10,
wherein at least one of:
visual recognition;
auditory recognition;
gustatory recognition;
olfactory recognition; and
tactile recognition
is performed based the query information pattern for pattern matching.

14. The memory having the set operating function according to claim 1, characterized by being incorporated into another semiconductor, an example of which is a CPU.

15. A device comprising the memory having the set operating function according to claim 1.

16. An image recognition method on an image in the memory having the set operating function according to claim 1, wherein the first and second inputs specify a query information pattern for pattern matching with set information recorded on the memory, and the image is defined with a size of X-Y arrays, the method characterized by performing image processing by:
(1) a step of generating an image query pattern configured by appropriately combining image information data value of each pixel configuring the image and a position of the pixel; and
(2) a step of querying the image query pattern to an object image of image detection so as to detect pixels which pattern-match with the image query pattern from the object image.

17-21. (canceled)

22. A phoneme recognition method in the memory having the set operating function according to claim 1, wherein the first and second inputs specify a query information pattern for pattern matching with set information recorded on the memory, the method characterized in that a phoneme of a query condition is detected by:
(1) preparing a pattern of a spectrum or cepstrum obtained from each phoneme of voice as an array database, for phoneme and frequency, respectively; and
(2) querying a pattern of a spectrum or cepstrum obtained from phonemes of emitted voice to the array database so as to detect an address in the array database which pattern-matches with the condition.

23-26. (canceled)

27. A image text recognition method in the memory having the set operating function according to claim 1, wherein the first and second inputs specify a query information pattern for pattern matching with set information recorded on the memory, the method characterized by performing image text recognition processing by:
(1) a step of generating and registering an image text query pattern configured by appropriately combining image information data value of each pixel configuring a text font in an image and a position of the pixel; and
(2) a step of querying the image text query pattern to an object image of image text recognition so as to detect pixels which pattern-match the image query pattern from the object image.

28-37. (canceled)

38. A pattern matching standardization method in the memory having the set operating function according to claim 1, wherein the first and second inputs specify a query information pattern for pattern matching with set information recorded on the memory, and the information is stored while an array of information is defined, the method characterized in that information is detected by pattern matching which is performed by:
(1) a step of designating definition of an array of information as a fourth input;
(2) a step of designating a data value (the first input) of information which is a candidate of pattern matching and setting it as base information;
(3) a step of independently designating a data value of each of a plurality of match information to be matched to the base information of (2) and independently designating a position (the second input) of each information; and
(4) a step of using the base information of (1) and the plurality of match information of (2) as one query information pattern and detecting an address of base information of (2) which is matched with the query information pattern.

39-48. (canceled)

49. A user interface for pattern matching in the memory having the set operating function according to claim 1, wherein the first and second inputs specify a query information pattern for pattern matching with set information recorded on the memory, the user interface configured to specify the query information pattern, the user interface characterized in that information is detected by a pattern matching which is performed by:
(9) a function of designating an array as a fourth input;
(10) a function of setting a query information pattern, which has:
(10-1) a function of designating a data value of information which is a candidate of pattern matching and setting it as base information; and
(10-2) a function of independently designating a data value of each of a plurality of match information to be matched to the base information of (10-1) and independently designating a position of each information;
(11) a function of issuing a matching command based on the specification of (10-1) and (10-2); and
(12) a function of displaying pattern matching result of information processing based on the matching command.

50. (canceled)
